(19) United States
(12) Patent Application Publication
(10) Pub. No.: US 2002/0040352 A1
(43) Pub. Date: Apr. 4, 2002

(54) Method and system for producing an electronic business network

(76) Inventor: Eamonn J. McCormick, South Pasadena, CA (US)

Correspondence Address: FISH & NEAVE, 1251 AVENUE OF THE AMERICAS, 50TH FLOOR, NEW YORK, NY, 10020-1105, US

(21) Appl. No.: 09/895,034

(22) Filed: Jun. 29, 2001

Related U.S. Application Data
(60) Provisional application No. 60/215,124, filed on Jun. 29, 2000.

(51) Int. Cl. G06F 17/60

(52) U.S. Cl. 705/80

(57) ABSTRACT

An electronic commerce network that facilitates the exchange of goods and services is described that includes configurations for physically implementing the system and data structures for logically implementing the method. The physical components of the system include a wide area network, a message bus, data channels and system connectors. The logical components of the system include system software, client application software, databases and an event coordinator/workflow processor. Functions of the system include business network registration, user registration, definition of roles, assignment of roles to business networks and user registrants, definition of logical products, definition of physical products, identification of the goods needed by a participant, identification of the goods offered by a participant and the brokering of a solution that takes into account the needs of one participant and the offer of another participant.

### CROSS REFERENCE TO RELATED APPLICATION

This application claims the benefit of U.S. provisional application No. 60/215124, filed Jun. 29, 2000, entitled METHOD AND SYSTEM FOR PRODUCING AN ELECTRONIC MARKET by Eammon (sic) J. McCormick, which is hereby incorporated by reference in its entirety.

### BACKGROUND OF THE INVENTION

This invention relates to methods and systems for conducting commerce. More particularly, this invention relates to methods and systems for providing efficient solutions to commerce related problems by defining roles of participants in a market and, based on the relative roles of the market participants and well-defined market related tasks, facilitating communication and transactions among the participants.

In today's economy, supply chain transactions can involve hundreds of parties acting as suppliers and consumers. These multiple participant markets introduce complexities and high costs that are the result of searching, coordinating and monitoring the exchange of goods, services and information. Additional costs and inefficiencies resulting from the supply chain complexities are: the time and money spent finding service providers and comparing prices; price distortions; finding and delivering solutions that are configured to customers' individual needs; evaluating alternative solutions; and related administrative costs. The present invention renders greater efficiency by creating a single interface that consumers may use to seamlessly access multiple business networks.

The term “Solution” as used herein represents a collection point for (or “bundling” of) one or more Product “needs” of or “offers” from a network registrant, such that the products included in the solution are treated as a unit (i.e., managed together).

When we refer to business networks or inter-party applications, we assume that a party has internal, task specific applications that they would like to use for interacting with the internal applications of another party. For example, a manufacturer of goods may have an internal system that is used for tracking and ordering materials. A supplier or materials has an internal system for receiving and tracking orders. A third party providing transportation has yet another system that coordinates shipping of materials from the supplier to the manufacturer. For the manufacturer to receive materials, they must submit an order to the internal system for tracking and notify the supplier of the desired order. The supplier must in turn enter the order into their system and create a purchase order for transportation of the ordered materials. Each must access a separate system to complete their task.

In the past, business-to-business (“B2B”) technology companies attempted to solve the problems discussed above through the creation of applications targeted at facilitating market oriented processes, such as e-procurement and web-based commodity trading. Unfortunately, these efforts have been narrowly focused on a single component, aspect or task involved in supply chain commerce.

This narrow focus fails to adequately address the inefficiencies in a typical supply chain transaction that involves many different components, aspects and tasks. In addition, previous solutions have overemphasized the power of software development tools. Many of these past systems were inflexible and hardwired or only supported simplistic business models. What is needed is a way to integrate these various components, aspects and tasks into a seamless operation.

The emergence of the World Wide Web on the Internet increased the ability to integrate business applications. However, the short falls of the web-oriented approach to integration have become evident. Web servers, instead of private network servers, do not solve the fundamental issue of how to integrate networks of parties efficiently and comprehensively.

Other enterprise and supply chain software companies have moved into the B2B marketplace. However, these companies primarily have approached the problem from an enterprise-centric viewpoint and sought to “bolt on” B2B components. They also tend to take a manufacturing enterprise-centric perspective and have ignored a general multiple business network approach in the rush to create products ready for specific enterprise customers.

Standards bodies have also attempted to address these problems. However, these bodies often have a broad focus and have typically been oriented toward defining XML standards and promoting approaches that are acceptable to the status quo. For example, the UCCNET standard is an “XML” standard based on a point-to-point business model. There is no mention of the network, how it is organized or how services can be accessed. It is focused on defining a set of point-to-point XML standards that incrementally improve on the current EDI standards.

Middleware oriented technology companies such as Tibcom, IBM™ and Web Methodsm, have also sought solutions to the problems of automating complex markets. Again, these companies have focused on developing publish and subscribe and process automation technologies that are focused on enterprise application integration. They have not focused on the requirements of a integrated multiple business network environment, such as defining the roles of network participants, organizing the network and enabling such an environment.

While each of the above has provided valuable software improvements, all have failed to create a general framework for establishing and integrating multi-participant business networks. A need remains for a system that allows multiple parties in different roles to seamlessly access complementary systems.

However, a comprehensive network-oriented framework has not evolved that supports a role-based network model. The business model and the supporting software infrastructure required to support true business networks and inter-party application computing is still sorely lacking. The most common approaches are still either point-to-point, web browser-based or simply limited in scope and vision.

The present invention, the Business Value Network™ (“BVN™”) significantly reduces the costs and efficiencies discussed above for both customers and service providers participating in the BVN™ system. Indeed the BVN™ system can extend the benefits of a more efficient economy directly back to the consumer.

The BVN™ system is multi-faceted, providing a framework that covers both a general business network organizational approach and the supporting application architecture. The framework represents a breakthrough in business networking, and provides a foundation on which to build role-based business networks.

A unique and important component of the BVN™ system is the interoperation application, an interface that allows external systems to be integrated into any BVN™. The BVN™ system's interoperation application leverages advances made in middleware and other technologies to enable true business networking.

### SUMMARY OF THE INVENTION

It is an object of this invention to provide methods and systems for efficiently solving market and transaction related problems. The present invention is well suited for implementing complex supply chains, however it is apparent that the invention may be used to meet the needs of any market.

In accordance with this invention, there is provided a system that facilitates the coordination of transactions, including, but not limited to, offers, negotiations, acceptance, packing, shipping and insurance among multiple participants in a supply chain. In a preferred embodiment of the present invention, the invention is implemented using the functionality of a global network system to provide communication among multiple participants in the delivery of efficient solutions.

In addition, the invention discloses methods for using the system of the invention.

The BVN™ system implements a computer-based method for integrating business networks. It has several components: a role-based structure for organizing business and non-commercial networks; a toolset for defining and technically integrating business networks; and a flexible process for brokering business solutions using the BNV™ system. A BVNI system can contain multiple business networks.

In the BVN™ system, a business organization is defined in terms of business network roles, organization, services and structure. Participants in the network also are defined. Participants can be individuals or enterprises who, once defined, are organized into multiple business networks.

Each party in the network can play one or more predefined roles in the network. Roles are process responsibilities that the party can undertake. For example, in a real estate BVN, some roles include, but are not limited to, “mortgage provider,” “buyer,” “seller,” and “property inspector.”

The BVN™ system architecture defines a basic role structure that can be modified to meet the needs of the particular business network. Network roles define a discrete set of authorizations and process responsibilities associated with that role.

The BVN™ system also allows parties in particular roles to define their relationships to other parties in other roles. The ability to establish party role relationships enables the BVN™ system to establish relationships between Community Managers and Market Managers, between trading partners, between organizational units within enterprises, and between members of a group.

These relationships are enabled through the BVN™ system relationship data structures within the BVN™ system Registration application. This method of organizing the network can be used to define a wide variety of roles and role relationships.

The predefined roles of the BVN™ system include, but are not limited to, BVN™ Managers, Market Managers, Community Managers, Customers, Service Providers, Solution Brokers and Users.

The highest-level role is the BVN™ Manager. The BVN™ Manager role is responsible for organizing the network infrastructure, establishing the business network, identifying the BVN™ system business networks and identifying relationships with external BVNs and business networks.

The next highest-level role is the Market Manager. Market Managers are responsible for defining the products, services and roles offered in their business networks and creating communities within their business networks.

Community Managers are responsible for defining, developing and running business network communities within a specific business network. Community Managers are responsible for signing up participants into network roles.

The BVN™ Manager configures the BVN™ system using the BVN™ Interoperation application. The BVN™ Interoperation application, the core of the technology framework, allows the BVN™ Manager to organize and manage multiple business networks. The Interoperation application allows the BVN™ Manager to, among other things: create roles; identify the relationships between the roles; identify the services that correspond to roles; sign up parties into the key business network management roles; configure which services are available in which business networks; define the business events that the network supports; map the events to Event Channels; and map the Event Channels to business network services.

The BVN™ Manager also ensures that a Message Bus is established that allows messages to be passed among the parties within the business network. The Message Bus can be implemented using a commercial messaging system, such as systems based on the Java Messaging Service. The Message Bus is configured to support the Event Channels defined in the BVN™ Interoperation application. Once the BVN™ Manager has organized the network, they are responsible for the ongoing maintenance of the BVN™ system architecture from a business and technology perspective.

The Market Managers are initially responsible for ensuring that there are parties playing the Community Manager role. In addition, the Market Manager can configure the BVN™ system to the particular needs of their network.

The Market Manager has broad powers to configure the business structure to meet the needs of his network. This includes deciding what products and services will be accommodated within the market. For example, not all BVN™ system services are available within the network, or perhaps certain services are only available within a particular business network or the Market Manager may limit access to broadcast channels.

The Community Manager role exists within a particular business network. Just as there can be multiple business networks within a BVN, there can be multiple communities within a business network. A party may play multiple network management roles. For example, the same party can hold both a community management and market management role.

When a participant registers in a network participant role (vs. a network management role), they are registering within the context of a particular community. The Community Manager is responsible for managing that party's role. There is no limit to the number of roles a party may have or to the number of communities to which a party may be a member. Thus, a party may play many roles in a single business network that spans multiple communities.

When a participant signs up for the network it can be as an enterprise or as an individual. Enterprise roles are typically broken down into sub-roles. When an individual registers, they will commonly register in an employee party role and be associated with their parent enterprise via a defined relationship. The employee will be assigned an enterprise sub-role, such as buyer or trader. The employee may then interact on the network on behalf of that enterprise within the context of the sub-role's privileges. This architecture allows a business process to be broken into its component tasks and allows the assignment of those tasks to party roles.

Once participants have been registered in a community within the business network, they can begin to use the business network services. Typical large enterprises will integrate with the network via their own enterprise systems (referred to as BVN™ Client Applications), using a special application called a BVN™ Connector. Individuals and small enterprises can access the network via user interface enabled client applications. These applications integrate a user interface (for example, via the World Wide Web or a wireless device) with the BVN™ Connector.

Participants in the BVN™ system have several major types of activities they can perform, including: making direct requests for services using Elementary Business Process (“EBP”) requests, such as log-on, log-off, update network participant, submit to trading, submit offer to customer and retrieve catalog prices; retrieving personal information from their user channels; listening in and retrieving broadcast messages; participating in inter-party messaging; retrieving messages no longer available on broadcast or on the user channels; and publishing on broadcast channels (if authorized).

Each BVN™ system consists of one or more networks, with each network managed by a Market Manager. To enable inter networking, relationships between BVN™ system networks within a BVN™ system and between BVN™ system networks and external networks can be established as the network is set up. Setting up interactions between networks both in a single BVNTA system is simple, as it merely requires the appropriate relationships be set up in the BVN™ M system Registration application. Thus, within a BVN, Market Managers can establish relationships that allow their Community Managers and Network Participants to establish relationships and conduct inter-network processing and commerce.

Typically, participants in one network will request services from participants in external networks. This is handled by allowing relationships to be established between the different network participants across networks and allowing the appropriate EBP requests to be submitted by the participants to facilitate inter-networking. Not all information need be registered a priori, as long as the appropriate party and EBP registration data is transferred between the external network and the BOVN System Interoperation applications.

The BVN™ system provides general techniques for organizing business networks and the required computing applications and processing within a distributed computing environment. The basic components of the BVN™ systems can be implemented using six key elements working together to drive a real time, plug and play business network: BVN™ Connected Client Applications; BVN™ Connector; Elementary Business Process (EBP) Applications; BVN™ Interoperation Application; Message Bus; and Event Channels.

The majority of the applications in the BVN™ system business architecture are, typically, client applications. Client applications are used directly by the business network users. These applications can initiate requests for business network services that the user is authorized to use by initiating an EBP message-based request that performs a discrete task on behalf of the user and returns the result to the client application.

Once the business network participants have registered, they need a mechanism by which they can integrate their computer applications into the business network. The participants' applications must become client applications of the business network. This is achieved by connecting the client applications to the BVN™ m system network via a BVN™ Connector.

The BVN™ Connector is the mechanism through which all interactions can occur within the network. A key concept of the BVN™ System Interoperation Framework 5000 is that the BVN™ Connector will provide a single point of access for a user and the user's application to the BVN™ system network. There is no need to have multiple connection mechanisms to a BVN. In this way the user need only integrate the connector once with his applications and will have access to all the information and services of the network (and all of the other sister networks that interoperate with his network). The connector therefore brings the world of the network to the user via one seamless connection mechanism.

Elementary Business Process applications respond to requests to execute discrete commands. Elementary Business Processes are discrete units of work that have a business meaning to the participants in the business network. The EBP application essentially provides users with a mechanism to execute business-meaningful transactions on the business network by initiating an EBP request.

EBPs should correspond to discrete meaningful business actions within the network, whether these are associated with trading, delivery, settlements or information retrieval. Elementary Business Processes support a core domain command that executes a discrete unit of work like “reject counteroffer,” and supports a set of “utility” or “information retrieval” commands that are useful to the user before or after executing the domain command. For example, for an EBP “reject counteroffer,” there is an associated “retrieve counteroffers” utility command.

The BVN™ System Interoperation application provides a specific set of services that are required in order to organize, manage and control the BVN™ system network. A network of BVNs consists of multiple BVN™ System Interoperation applications, each responsible for their own BVN. The BVN™ System Interoperation application consists of three discrete EBP applications. These are the Registration application, the User Logon/Logoff application and the Message Logging application.

An important function of the BVN™ System Interoperation Framework 5000 is to align relevant data across the business network. The main actor in keeping the party data synchronized across the network is the Interoperation Registration application. The Registration application is responsible for publishing data alignment events that correspond to updates to the BVN™ system registration data. Thus, when a party's delivery address information changes, this is automatically broadcast to the relevant trading partners and EBP applications that may need this information (as defined in the BVN™ Configuration and User Registration process.)

The Message Bus and Event Channels are the communications backbone of the BVN™ System Interoperation Framework 5000. The BVN™ Connector includes a communications client for the BVN™ Message Bus. The Message Bus/Event Channel itself is typically a commercial message bus package based on the Java Messaging service or the CORBA event service or equivalent. The Message Bus/Event Channels provide the ability for all applications to communicate through a shared mechanism, thus eliminating costly point-to-point integration and shielding applications from each other's complexities.

Once participant roles are defined and the BVN™ system is configured, the BVN™ system provides component applications that provide an interface for management of the underlying data structure, as well as day-to-day transactions. The BVN™ system includes applications to support the following areas: Registration; Solution Configuration; Product and Service Trading; Solution Assembly; Solution Delivery; Settlements; Issue and Dispute Management; Marketing; and Customer Management.

The Marketing & Customer Management Applications supports customer referral management, customer management and marketing and incentive plan management.

The Registration Application supports the trading community configuration and manages trading party relationships. The modules within the application are used to manage and configure the entities participating in the BVN™ system collaborative trading community business network.

The Solution Configuration application supports direct material procurement and solution bundling. The application modules allow a logical bundle of products and services to be assembled on behalf of a participant in a customer role for trade.

Requests for quotes, negotiation, posting and replenishment are handled by the Product and Service Trading application. These modules handle the matching of customer-requested solutions with supplier-generated offers. Several models for trading interaction are supported. These include modules that coordinate trading with external markets and modules that provide internal network trading services such as negotiation and request for quotation. Replenishment is supported by direct integration with member Enterprise Resource Planning (“ERP”) systems, allowing automatic trading based on replenishment events. The BVN™ system applications can also interface with third-party trading engines, such as Trading Dynamics, where it is necessary to support complex auction trading activities.

The modules of the Solution Assembly application allow the customer (or solution broker) to tailor responses from suppliers to a specific order for delivery. This involves categorizing and selecting market trading responses so the customer can make final buying decisions.

The coordination of delivery activities, such as advance ship notification, tracking and updating of order status, returns management and parts ordering is supported by the Delivery application.

After a trade is completed, the Settlements application tracks billing and payment information on the system.

Should a dispute arise, the Issue and Dispute Management application facilitates and tracks resolutions between parties.

In addition to the above, the BVN™ system is designed to interact with third-party applications. These applications may include, but are not limited to, back office applications, such as general ledger, HR and payroll; market intelligence applications; and catalog applications.

### BRIEF DESCRIPTION OF THE DRAWINGS

The above and other objects and advantages of the present invention will be apparent upon consideration of the following detailed description, taken in conjunction with the accompanying drawings, in which:

FIG. 1 illustrates the Process Overview of the present invention;

FIG. 2 illustrates the Customer Referral Management Process Flow of the BVN™ system;

FIG. 3 illustrates the Network Participant Registration Process Flow of the BVN™ system;

FIG. 4 illustrates the Customer Credit Management Process Flow of the BVN™ system;

FIG. 5 illustrates the Customer Marketing Management Process Flow of the BVN™ system;

FIG. 6 illustrates the Solution Configuration Process Flow of the BVN™ system;

FIG. 7 illustrates the Product/Service Trading Process Flow of the BVN™ system;

FIG. 8 illustrates the Solution Assembly Process Flow of the BVN™ system;

FIG. 9 illustrates the Solution Delivery Process Flow of the BVN™ system;

FIG. 10 illustrates the Solution Settlement Process Flow of the BVN™ system;

FIG. 11 illustrates the Quality and Service Management Process Flow of the BVN™ system;

FIG. 12 illustrates the Role Hierarchy of the BVN™ system;

FIG. 13 illustrates an example of roles defined within the BVN™ system;

FIG. 14 illustrates the BVN™ System Interoperation Framework 5000 architecture;

FIG. 15 illustrates a preferred embodiment of the Interoperation Framework 5000 of the BVN™ system;

FIG. 16 illustrates the Process Responsibilities associated with components of the BVNM system Interoperation Framework 5000 architecture;

FIG. 17 illustrates the User Logon process of the BVN™ system;

FIG. 18 illustrates the Retrieve Pending User events process of the BVN™ system;

FIG. 19 illustrates the Elementary Business Process (EBP) request process of the BVN™ system;

FIG. 20 illustrates the Reference Data Maintenance process of the BVN™ system;

FIG. 21 illustrates the Business Messaging process of the BVN™ system;

FIG. 22 illustrates the Message Retrieval process of the BVN™ system;

FIG. 23 illustrates the Broadcast Event process of the BVN™ system;

FIG. 24 illustrates the EBP Role Broadcast Event process of the BVN™ system;

FIG. 25 illustrates the Inter Party Messaging process of the BVN™ system;

FIG. 26 illustrates the User Logoff process of the BVN™ system;

FIG. 27 illustrates the Network Participant Registration process invoked by the EBP Interoperation Framework 5000;

FIG. 28 illustrates the Accounts/Financial Transaction logical data model of the BVN™ system;

FIG. 29 illustrates the Agreements logical data model of the BVN™ system;

FIG. 30 illustrates the Business Value Networks logical data model of the BVN™ system;

FIG. 31 illustrates the Customer Groups logical data model of the BVN™ system;

FIG. 32 illustrates the Events logical data model of the BVN™ system;

FIG. 33 illustrates the Incentive/Marketing Programs logical data model of the BVN™ system;

FIG. 34 illustrates the Issues/Resolutions logical data model of the BVN™ system;

FIG. 35 illustrates the Locations logical data model of the BVN™ system;

FIG. 36 illustrates the Parties/Party Roles logical data model of the BVN™ system;

FIG. 37 illustrates the Processes logical data model of the BVN™ system;

FIG. 38 illustrates the Products logical data model of the BV™ system;

FIG. 39 illustrates the Roles logical data model of the BVN™ system;

FIG. 40 illustrates the Solutions logical data model of the BVN™ system;

FIG. 41 illustrates the Trading Markets logical data model of the BVN™ system;

FIG. 42 shows a table containing sample Role Definitions for a Beef Industry BVN™ system;

FIG. 43 shows a table containing sample Product Classes for a Beef Industry BVN™ system;

FIG. 44 shows a table containing sample Participant Roles for a Beef Industry BVN™ system;

FIG. 45 is a continuation of the table in FIG. 45 showing a table containing sample Participant Roles for a Beef Industry BVN™ system;

FIG. 46 shows a table containing sample Product Bundles for a Beef Industry BVN™ system; and

FIG. 47 shows a table containing sample Roles and related Product Classes for a Beef Industry BVN™ system.

### DETAILED DESCRIPTION OF THE INVENTION

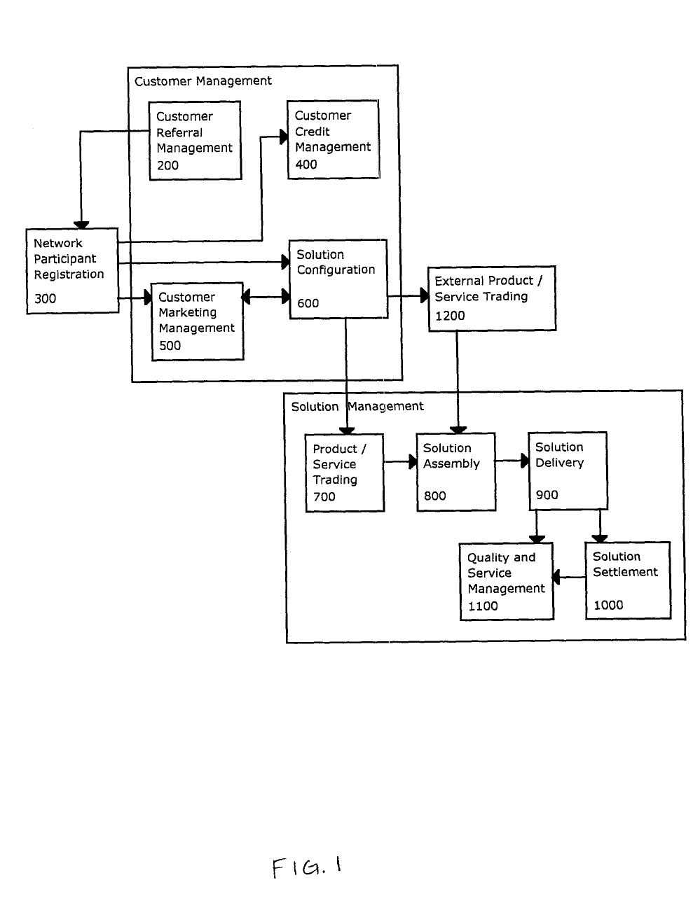

Business Value Network system for facilitating a collaborative role-based process that fosters supply chain efficiencies is shown in FIG. 1.

Role Definition

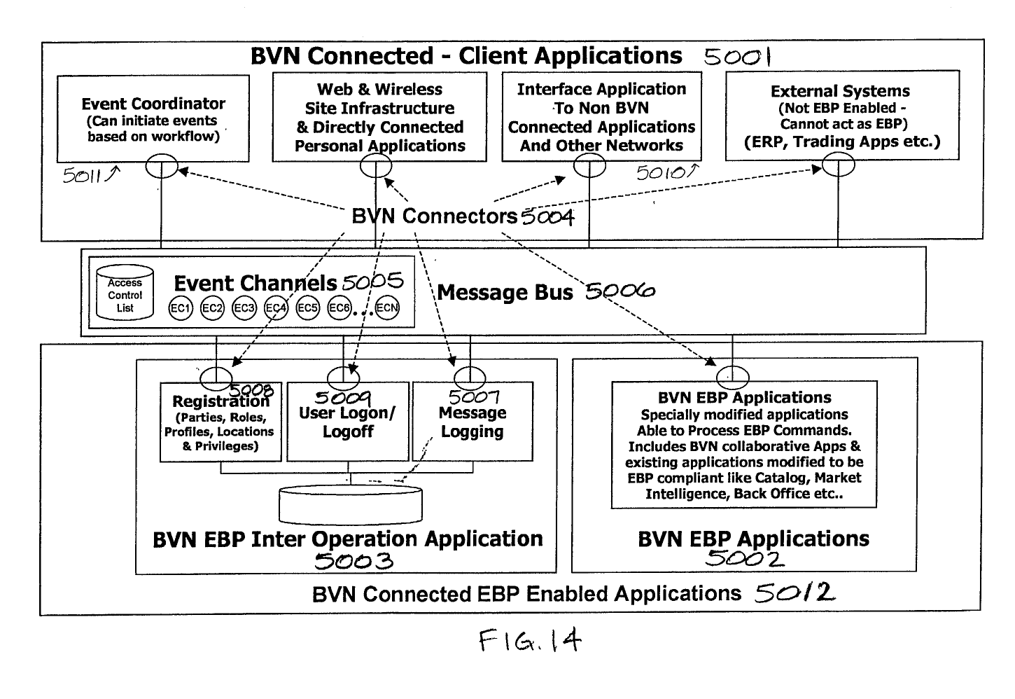

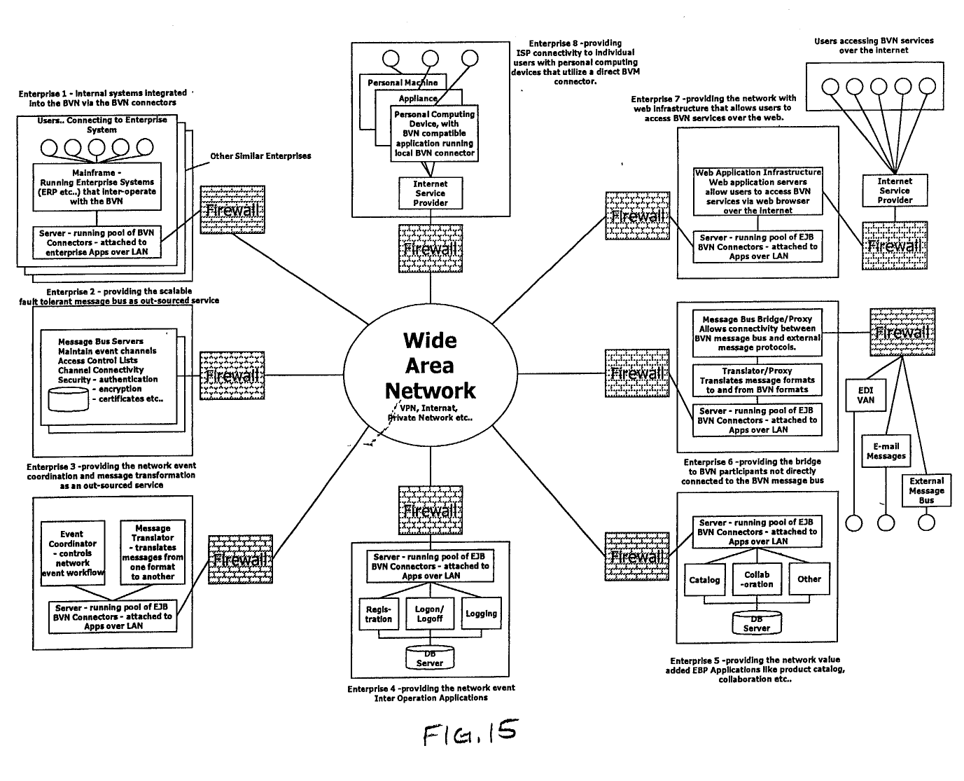

Referring to FIGS. 12 and 13, the BVN™ system framework defines a basic network role structure. As mentioned above, parties registered on the BVN™ system can be individuals or enterprises. Each party can play one or more predefined roles in the BVN™ system. Roles are process responsibilities that the party can undertake. The default configuration of the BVN™ system includes the following basic roles: BVN™ Manager 2005; Market Manager 2010; Customer Manager 2020; Service Provider Manager 2040; Customer Service Provider 2045; Solution Broker 2030; Customer Referral Provider 2035; Network Participant 2050 and User 2055; and Administrator 2060. This basic structure can be modified to meet the needs of the particular BVN™ system.

A BVN™ Manager 2005 creates and manages a BVN's highly integrated process and technology infrastructure that allows Customers 2025, Customer Referral Providers 2035, Solution Brokers 2030, Customer Managers 2020, Service Provider Managers 2040, Market Managers 2010, and Service Providers 2045 to freely interact. It is appropriate to think in terms of BVN™, Managers 2005 operating at the “BVN™ level” (i.e., industry level), although it is not impossible for more than one BVN™ Manager 2005 to operate a BVN™ system within the same industry. BVN™ Managers 2005 recruit and enroll Market Managers 2010 to operate within the BVN™ system environment they' re providing. It is also possible that BAN™ Managers 2005 may recruit large Service Providers 2045 to attract Customer Managers 2020, Service Provider Managers 2040, and/or Market Managers 2010 to their BVN™.

The BVN™ Manager 2005 is also responsible for coordinating and integrating network services across Market Managers 2010 and, if desired, for assisting in the development of Market Manager 2010 composition.

A Market Manager 2010 recruits and enrolls Customer Managers 2020 to bring Customers 2025 to their “market” (i.e., sub-network within an industry BVN™). Market Managers 2010 also recruit Service Provider Managers 2040 to bring their network of Service Providers 2045 to the “market” to entice Customer Managers 2020 to utilize their market (i.e., the Market Manager 2010 is directly responsible for their market composition).

Market Managers 2010 are responsible for various administrative aspects of their market's operation, such as Customer 2025 billing and Service Provider 2045 compensation (collectively known as the “Settlements” process), network process improvements, issue/dispute resolution, and quality control/reporting. The Market Manager 2010 can also exercise supervisory responsibility where appropriate.

A Community Manager 2015 represents a “network management” enterprise that aggregates other enterprises for participation within a BVN™. This is an “abstract” Role that is realized via the Customer Manager 2020 and Service Provider Manager 2040 Roles.

A Customer Manager 2020 recruits and enrolls Customer Referral Providers 2035 and Solution Brokers 2030 to refer and broker solutions to Customers 2025 within their sub-network (i.e., the Customer Manager 2020 is directly responsible for their sub-network composition). Customer Managers 2020 “own” the BVN™ Customers 2025 and are consequently heavily involved in customer marketing and offering incentive programs. Customer Managers 2020 enroll with Market Managers 2010.

A Customer 2025 interacts with a Solution Broker 2030 to specify their needs and purchase products and services that satisfy those needs, via a solution, from a Customer Manager 2020. Customers 2025 can also be referred to a BVN™ system via a Customer Referral Provider 2035.

Within a Customer Manager's 2020 sub-network, Customers 2025 can also be assigned to Customer Groups so that they can be marketed to.

A Solution Broker 2030 configures “logical” products and services based on customer needs, reviews customer-defined solution configurations, trades the products and services within the BVN™ system trading markets and assembles solutions from the traded products and services on the Customer's 2025 behalf. Solution Brokers 2030 also coordinate the delivery of solutions for Customers 2025 by Service Providers 2045. Solution Brokers 2030 enroll with Customer Managers 2020.

The Solution Broker 2030 is ultimately responsible for the delivery of Customer 2025 solutions. The Solution Broker 2030 can also monitor and reallocate work within the solution.

Solution Broker 2030 and Customer Manager 2020 could be one and the same or separate entities. Solution Brokers 2030 can be hierarchical, in that a “managing” Solution Broker 2030 who manages the Customer 2025 relationship may delegate responsibility for configuring specific Solutions to “Solution-level” Solution Brokers 2030.

A Customer Referral Provider 2035 refers Customers 2025 to a Customer Manager 2020. Customer Referral Providers 2035 enroll with Customer Managers 2020. The Customer Referral Provider 2035 receives a commission for the referral of Customers 2025 to the BVN.

A Service Provider Manager 2040 is an enterprise that recruits and enrolls Service Providers 2045 to provide products and services to Customer Managers' 2020 Customers 2025 within a Market Manager's 2010 “market”. Service Provider Managers 2040 own the BVMz Service Providers 2045 and are, consequently, heavily involved in the management of Service Provider 2045 performance, incentive programs, etc. Service Provider Managers 2040 enroll with Market Managers 2010.

A Service Provider 2045 delivers the products or services within solutions to Customers 2025. Service Providers 2045 enroll with Service Provider Managers 2040. The Service Provider 2045 role is decomposed into industry-specific “core competency-oriented” roles within each industry BVN. The industry-specific roles themselves may be decomposed into successive levels of granularity, which enables the capability of creating “solutions within solutions” and responsibility vs. accountability (i.e., responsible Service Providers 2045 “do the work”, but accountable Service Providers 2045, who delegated their process responsibilities, are “Tultimately responsible”). The “Service Provider 2045” Role itself can be thought of as a “meta” Role.

Network Participant 2050 is an internally used Role within the BVN™ system that permits the Enterprise to be registered to the network and have access to non-commerce related processes (e.g., update their basic information such as business address).

The User 2055 is a generic role that represents an individual that is registered to the network and can be a User 2055 for an enterprise. When industry-specific roles are not defined for the individual Users 2055 within a given BVN, the User 2055 role will be used exclusively for individuals.

An Administrator 2060 is a User 2055 that has special privileges. An Administrator 2060 can execute processes that are not available to a normal User 2055 (e.g., an Administrator 2060 can update profile information for their Enterprise.)

Role Relationship Configuration

The tables shown in FIGS. 12 and 13 illustrate the relationships between the various roles within the BVN.

Relationship Names are used to configure Role pairs within the Role Relationship entity. Relationship Names have specialized meanings within the BVN. Generally speaking, Relationship entities build a binary relationship between two things and the Relationship Name describes the relationship. Instances within a Relationship entity are to be read like a simple sentence that contains one Subject, one Verb and one Object. For example, a BVN™ Market Manager 2005 (subject) “registers” (verb) a Customer Manager 2020 (object).

When a pair of Roles is configured in this manner in the Role Relationship entity, then Parties can interact in the same manner prescribed. This behavior between actual enterprises or individuals is recorded in the Party Role Relationship entity. For example:

If a BVN™ Market Manager 2010(subject) “registers” (verb) a Customer Manager 2020 (object) (i.e., a Role Relationship), then the BVN™ system will allow ABC Company acting as a BVN™ Market Manager 2010 (subject) to “register” (verb) XYZ Company acting as a Customer Manager 2020 (object) (i.e., a Party Role Relationship).

“Can Be”: This name is used to link a “Network Execution” type of role to all of its associated “decomposed” roles (see “Decomposes Into” relationship name) regardless of the role hierarchy structure. This name links a decomposed role to its ultimate parent. For example, a Service Provider 2045 “can be” a Manufacturer. This example in the context of a specific Party Role Relationship would be ABC Company acting as a Service Provider 2045 “can be” ABC Company acting as a Manufacturer.

“Decomposes Into”: This name is used to identify an object role that is directly decomposed from a subject role. For example, a Customer 2025 “decomposes into” a Retailer. This example in the context of a Party Role Relationship would be ABC Company acting as a Customer 2025 “decomposes into” ABC Company acting as a Retailer.

“Has User”: This name is used to identify a relationship between an enterprise role and an individual role. For example, a Customer 2025 “has user” User 2055. This example in the context of a Party Role Relationship would be ABC Company acting as a Customer 2025 “has user” of Joe acting as a User 2055.

“Is Parent Of”: This name is used to signify that the object of this relationship is a subordinate (subsidiary) of the subject of the relationship. For example, a Network Participant 2050 “is parent of” a Network Participant 2050. This example in the context of a Party Role Relationship would be ABC Company acting as a Network Participant 2050 “is parent of” of XYZ Company acting as a Network Participant 2050.

“Refers”: This name is used to identify a relationship between an enterprise in the Role of Customer Referral Provider 2035 and another enterprise in the Role of Customer 2025, i.e., a Customer Referral Provider 2035 “refers” Customer 2025.

“Registers”: This name is used to identify a relationship between enterprises where a “subject” role of the BVN™ system has the responsibility to register other “roles” to the BVN™. For example, a Customer Manager 2020 “registers” Customers 2025. In the case of a Customer 2025 “self-registering,” the system requires that the registration occur within the context of a Customer Manager 2020 to satisfy the relationship.

“Routes to”: This name is used to identify a relationship between two enterprises in the Role of Market Manager 2010 to handle inter-BVN™ system trading arrangements between Market Managers 2010 within different BVN™ system implementations.

When adding roles, configuration rules must be adhered to. The following table is a list of examples to help with this process. Note, The Network Participant 2050 “is parent of” Network Participant 2050 instance is established to handle subsidiaries or divisions. An example of this implementation is ABC Company acting as a Network Participant 2050 “is parent of” XYZ Company acting as a Network Participant 2050 .

TABLE 1
Basic Role Relationship Configuration

| | Relationship | |
|---|---|---|
| Subject Role | Name | Object Role |
| BVN Manager 2005 | Registers | Market Manager 2010 |
| Market Manager 2010 | Registers | Customer Manager 2020 |
| Market Manager 2010 | Registers | Service Provider Manager 2040 |
| Customer Manager 2020 | Registers | Customer 2025 |
| Customer Manager 2020 | Registers | Solution Broker 2030 |
| Customer Manager 2020 | Registers | Customer Ref. Provider 2035 |
| Service Provider | Registers | Service Provider 2045 |
| Manager 2040 | | |
| Customer Ref. | Refers | Customer 2025 |
| Provider 2035 | | |
| Market Manager 2010 | Routes to | Market Manager 2010 |
| Market Manager 2010 | Has User | User 2055 |
| Market Manager 2010 | Has User | Administrator 2060 |
| Customer Manager 2020 | Has User | User 2055 |
| Customer Manager 2020 | Has User | Administrator 2060 |
| Service Provider | Has User | User 2055 |
| Manager 2040 | | |
| Service Provider | Has User | Administrator 2060 |
| Manager 2040 | | |
| Customer 2025 | Has User | User 2055 |
| Customer 2025 | Has User | Administrator 2060 |
| Service Provider 2045 | Has User | User 2055 |
| Service Provider 2045 | Has User | Administrator 2060 |
| Network Participant 2050 | Is Parent Of | Network Participant 2050 |

Table 2 illustrates the results when the Service Provider 2045 role is decomposed into Manufacturer and the Customer 2025 role is decomposed into Retailer. The rows shown in Italics are added to the base configuration.

TABLE 2
Creating Additional Service Provider and Customer Roles

| | Relationship | |
|---|---|---|
| Subject Role | Name | Object Role |
| BVN Manager 2005 | Registers | Market Manager 2010 |
| Market Manager 2010 | Registers | Customer Manager 2020 |
| Market Manager 2010 | Registers | Service Provider Manager 2040 |
| Customer Manager 2020 | Registers | Customer 2025 |
| Customer Manager 2020 | Registers | Solution Broker 2030 |
| Customer Manager 2020 | Registers | Customer Ref. Provider 2035 |
| Service Provider | Registers | Service Provider 2045 |
| Manager 2040 | | |
| Customer Ref. | Refers | Customer 2025 |
| Provider 2035 | | |
| Market Manager 2010 | Routes to | Market Manager 2010 |
| Market Manager 2010 | Has User | User 2055 |
| Market Manager 2010 | Has User | Administrator 2060 |
| Customer Manager 2020 | Has User | User 2055 |
| Customer Manager 2020 | Has User | Administrator 2060 |
| Service Provider | Has User | User 2055 |
| Manager 2040 | | |
| Service Provider | Has User | Administrator 2060 |
| Manager 2040 | | |
| Customer 2025 | Has User | User 2055 |
| Customer 2025 | Has User | Administrator 2060 |
| Service Provider 2045 | Has User | User 2055 |
| Service Provider 2045 | Has User | Administrator 2060 |
| Network Participant 2050 | Is Parent Of | Network Participant 2050 |
| Customer 2025 | Can Be | Retailer |
| Service Provider 2045 | Can Be | Manufacturer |
| Customer 2025 | Decomposes | Retailer |
| | Into | |
| Service Provider 2045 | Decomposes | Manufacturer |
| | Into | |
| Retailer | Has User | User 2055 |
| Retailer | Has User | Administrator 2060 |
| Manufacturer | Has User | User 2055 |
| Manufacturer | Has User | Administrator 2060 |

Table 3 shows the result when the Manufacturer role is further decomposed into Small Appliance Manufacturer and Large Appliance Manufacturer. Again, the added rows are shown Italics.

TABLE 3
Manufacture Role Decomposed into Small Appliance and
Large Appliance Manufacturer

| | Relationship | |
|---|---|---|
| Subject Role | Name | Object Role |
| BVN Manager 2005 | Registers | Market Manager 2010 |
| Market Manager 2010 | Registers | Customer Manager 2020 |
| Market Manager 2010 | Registers | Service Provider Manager 2040 |
| Customer Manager 2020 | Registers | Customer 2025 |
| Customer Manager 2020 | Registers | Solution Broker 2030 |
| Customer Manager 2020 | Registers | Customer Ref. Provider 2035 |
| Service Provider | Registers | Service Provider 2045 |
| Manager 2040 | | |
| Customer Ref. | Refers | Customer 2025 |
| Provider 2035 | | |
| Market Manager 2010 | Routes to | Market Manager 2010 |
| Market Manager 2010 | Has User | User 2055 |
| Market Manager 2010 | Has User | Administrator 2060 |
| Customer Manager 2020 | Has User | User 2055 |
| Customer Manager 2020 | Has User | Administrator 2060 |
| Service Provider | Has User | User 2055 |
| Manager 2040 | | |
| Service Provider | Has User | Administrator 2060 |
| Manager 2040 | | |
| Customer 2025 | Has User | User 2055 |
| Customer 2025 | Has User | Administrator 2060 |
| Service Provider 2045 | Has User | User 2055 |
| Service Provider 2045 | Has User | Administrator 2060 |
| Network Participant 2050 | Is Parent Of | Network Participant 2050 |
| Customer 2025 | Can Be | Retailer |
| Service Provider 2045 | Can Be | Manufacturer |
| Customer 2025 | Decomposes | Retailer |
| | Into | |
| Service Provider 2045 | Decomposes | Manufacturer |
| | Into | |
| Retailer | Has User | User 2055 |
| Retailer | Has User | Administrator 2060 |
| Manufacturer | Has User | User 2055 |
| Manufacturer | Has User | Administrator 2060 |
| Manufacturer | Decomposes | Small Appliance Manufacturer |
| | Into | |
| Manufacturer | Decomposes | Large Appliance Manufacturer |
| | Into | |
| Service Provider 2045 | Can Be | Small Appliance Manufacturer |
| Service Provider 2045 | Can Be | Large Appliance Manufacturer |
| Small Appliance | Has User | User 2055 |
| Manufacturer | | |
| Small Appliance | Has User | Administrator 2060 |
| Manufacturer | | |
| Large Appliance | Has User | User 2055 |
| Manufacturer | | |
| Large Appliance | Has User | Administrator 2060 |
| Manufacturer | | |

In Table 4, users of the Large Appliance Manufacturer will be broken out into the additional roles of Sales and Executive.

TABLE 4
Creating Additional Individual Roles

| | Relationship | |
|---|---|---|
| Subject Role | Name | Object Role |
| BVN Manager 2005 | Registers | Market Manager 2010 |
| Market Manager 2010 | Registers | Customer Manager 2020 |
| Market Manager 2010 | Registers | Service Provider Manager 2040 |
| Customer Manager 2020 | Registers | Customer 2025 |
| Customer Manager 2020 | Registers | Solution Broker 2030 |
| Customer Manager 2020 | Registers | Customer Ref. Provider 2035 |
| Service Provider | Registers | Service Provider 2045 |
| Manager 2040 | | |
| Customer Ref. | Refers | Customer 2025 |
| Provider 2035 | | |
| Market Manager 2010 | Routes to | Market Manager 2010 |
| Market Manager 2010 | Has User | User 2055 |
| Market Manager 2010 | Has User | Administrator 2060 |
| Customer Manager 2020 | Has User | User 2055 |
| Customer Manager 2020 | Has User | Administrator 2060 |
| Service Provider | Has User | User 2055 |
| Manager 2040 | | |
| Service Provider | Has User | Administrator 2060 |
| Manager 2040 | | |
| Customer 2025 | Has User | User 2055 |
| Customer 2025 | Has User | Administrator 2060 |
| Service Provider 2045 | Has User | User 2055 |
| Service Provider 2045 | Has User | Administrator 2060 |
| Network Participant 2050 | Is Parent Of | Network Participant 2050 |
| Customer 2035 | Can Be | Retailer |
| Service Provider 2045 | Can Be | Manufacturer |
| Customer 2025 | Decomposes | Retailer |
| | Into | |
| Service Provider 2045 | Decomposes | Manufacturer |
| | Into | |
| Retailer | Has User | User 2055 |
| Retailer | Has User | Administrator 2060 |
| Manufacturer | Has User | User 2055 |
| Manufacturer | Has User | Administrator 2060 |
| Manufacturer | Decomposes | Small Appliance Manufacturer |
| | Into | |
| Manufacturer | Decomposes | Large Appliance Manufacturer |
| | Into | |
| Service Provider 2045 | Can Be | Small Appliance Manufacturer |
| Service Provider 2045 | Can Be | Large Appliance Manufacturer |
| Small Appliance | Has User | User 2055 |
| Manufacturer | | |
| Small Appliance | Has User | Administrator 2060 |
| Manufacturer | | |
| Large Appliance | Has User | User 2055 |
| Manufacturer | | |
| Large Appliance | Has User | Administrator 2060 |
| Manufacturer | | |
| Large Appliance | Has User | Sales |
| Manufacturer | | |
| Large Appliance | Has User | Executive |
| Manufacturer | | |

Table 5 illustrates a case in which the individual roles are broken out, but the Manufacturer role is not decomposed into the Small and Large Appliance Manufacturer roles.

TABLE 5
Individual Roles without Decomposing Manufacturer

| | Relationship | |
|---|---|---|
| Subject Role | Name | Object Role |
| BVN Manager 2005 | Registers | Market Manager 2010 |
| Market Manager 2010 | Registers | Customer Manager 2020 |
| Market Manager 2010 | Registers | Service Provider Manager 2040 |
| Customer Manager 2020 | Registers | Customer 2025 |
| Customer Manager 2020 | Registers | Solution Broker 2030 |
| Customer Manager 2020 | Registers | Customer Ref. Provider 2035 |
| Service Provider | Registers | Service Provider 2045 |
| Manager 2040 | | |
| Customer Ref. | Refers | Customer 2025 |
| Provider 2035 | | |
| Market Manager 2010 | Routes to | Market Manager 2010 |
| Market Manager 2010 | Has User | User 2055 |
| Market Manager 2010 | Has User | Administrator 2060 |
| Customer Manager 2020 | Has User | User 2055 |
| Customer Manager 2020 | Has User | Administrator 2060 |
| Service Provider | Has User | User 2055 |
| Manager 2040 | | |
| Service Provider | Has User | Administrator 2060 |
| Manager 2040 | | |
| Customer 2025 | Has User | User 2055 |
| Customer 2025 | Has User | Administrator 2060 |
| Service Provider 2045 | Has user | User 2055 |
| Service Provider 2045 | Has User | Administrator 2060 |
| Network Participant 2050 | Is Parent Of | Network Participant 2050 |
| Customer 2025 | Can Be | Retailer |
| Service Provider 2045 | Can Be | Manufacturer |
| Customer | Decomposes | Retailer |
| | Into | |
| Service Provider 2045 | Decomposes | Manufacturer |
| | Into | |
| Retailer | Has User | User 2055 |
| Retailer | Has User | Administrator 2060 |
| Manufacturer | Has User | User 2055 |
| Manufacturer | Has User | Administrator 2060 |
| Manufacturer | Has User | Sales |
| Manufacturer | Has User | Executive |

The above tables illustrate the flexibility in configuring Roles within the BVN™ system.

Interoperation Framework

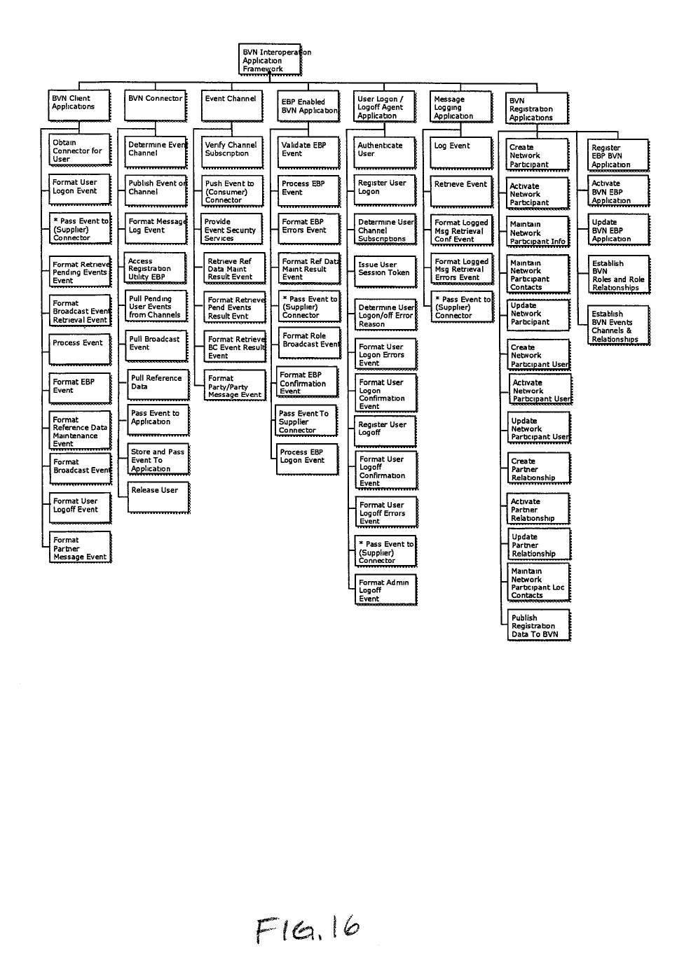

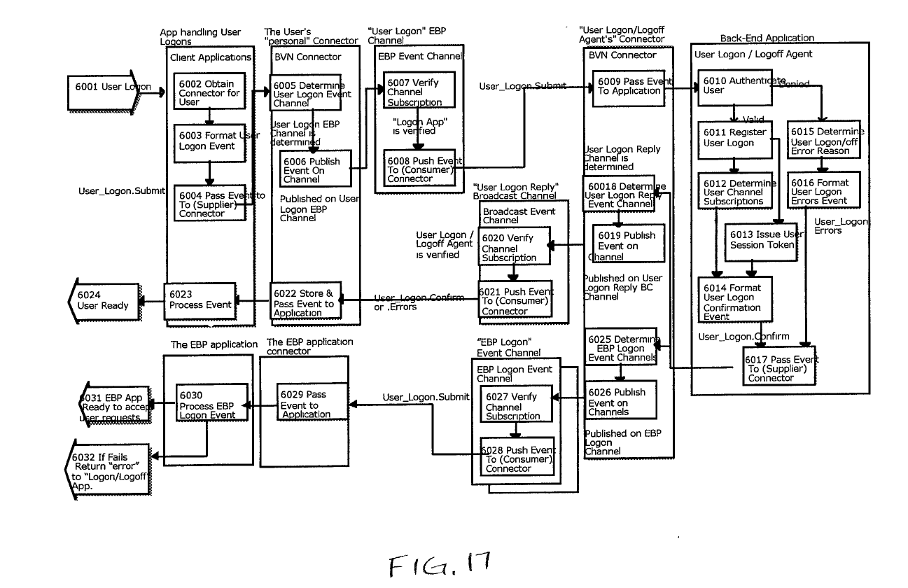

The architecture of the BVN™ System Interoperation Framework 5000 is depicted in FIGS. 14 to 16. The components are the BVN™ Connected Client applications 5001; BVN™ Elementary Business Process (EBP) applications 5002; BVN™ Interoperation application 5003; BVN™ Connector 5004; Event Channels 5005 and Message Bus 5006.

The majority of the applications in the BVN™ system business architecture are typically BVN™ Connected Client Applications 5001. Client Applications 5001 are used directly by the business network users. These applications can initiate requests for business network services that the user is authorized to use by initiating an EBP message-based request that performs a discrete task on behalf of the user and returns the result to the client application. EBP requests include such tasks as submit product to trading, submit counteroffer and check order status.

The location and implementation details of the applications that service the EBP requests are transparent to the Client application 5001. The EBP request consists primarily of a unique command name and a message body (typically XML). The Client application 5001 receives replies to the BVN™ system requests by pulling messages off special user channels that are established when the User registers with the BVN™.

The BVN™ system Connected Client Application 5001 can be of several different types. Some representative systems include, but are not limited to, Enterprise Resource Planning (“ERP”) systems, trading systems, web-oriented applications, wireless applications and agents that automate processes within the network, such as an event coordinator (which can initiate events based on a workflow).

One class of BVN™ system Client applications is Interface applications 5010. The Interface applications 5010 route messages to and from non-BVN™system applications and between business networks. In addition, these Interface applications 5010 behave as proxies for these non-BVN™ system applications and business networks. As a result, external networks and the non-connected participants appear as connected entities to the BVN™ system. The BVN™ system connected client applications interact with the BVN™ system via a pool of BVN™ system Connectors 5004 that are available to the application.

Elementary Business Process applications 5002 respond to requests to execute discrete commands. The EBP application provides users with a mechanism for executing business transactions on the business network by initiating an EBP request. Some sample EBP requests are reserve plane ticket, purchase plane ticket, update catalog, create catalog product, activate catalog product, submit product to trading, apply service provider filter and reject counteroffer.

EBP applications 5002 may be modified existing applications or specially developed applications. EBPs connect to the business network via a BVN™ system Connector 5004 that allows the EBP application 5002 to retrieve EBP event requests from users, and publish responses on the appropriate user and broadcast channels. EBP applications 5002 must register with the appropriate BVN™ System Interoperation application 5003 in order to work with the users associated with that BVN™ system. Typically, EBP applications 5002 are owned by a party assigned to the role of EBP application 5002 provider.

The EBP application 5002 is allocated the appropriate channels for both receiving EBP requests and publishing replies. EBP applications 5002 can register with multiple BVN™ System Interoperation applications 5003. The BVN™ System Interoperation applications 5003 publish to the EBP applications 5002 the user information required to process user requests.

A special class of BVN™ system Client application 5001, called Event Coordinators 5011, handles interaction between the BVN™ System 5003 and EBP applications 5002. These Event Coordinators 5011 monitor the BVN™ system EBP applications 5002 and messages to synchronize applications across the business network. Message-based process automation applications are used to accomplish this. Typical coordination tasks would include triggering additional EBPs based on an event having occurred. For example, if a trade has been finalized, the Event Coordinator 5011 will trigger the settlements EBP process.

The BVN™ system EBP application 5002 also initiates user log-ons and log-offs on behalf of the BVN™ system network User. Thus, a User does not have to log on to each EBP application individually, as this is accomplished by the BVN™ system Registration application 5008.

The BVN™ System Interoperation application 5003 provides a specific set of services that are required in order to organize, manage and control the BVN™ system network. A network of BVN™s consists of multiple BVN™ System Interoperation applications 5003, each responsible for their BVN™ system. The BVN™ System Interoperation application 5003 is designed to support a single BVN™. Multiple BVNs communicate by sharing registration data with each other, thereby allowing interoperation among their communities.

The BVN™ System Interoperation application 5003 consists of three discrete EBP applications. These are the Registration application 5008, the User Logon/Logoff application 5009 and the Message Logging application 5007.

The Registration application 5008 enables the configuration of the individual business networks within the BVN™, registration of the BVN™ system EBP applications and registration of the business network Participants and Users.

The business network configuration includes defining network roles and defining network event specifications. The configuration process also facilitates the definition of EBPs and the relationships between roles and EBPS, the definition of Event Channel specifications, and the mapping of events to roles, channels, EBP applications and event types.

The registration of BVN™ system EBP applications allows the addition of EBP application services to the network as well as the creation of network participants and users. As Participants and Users are added to the system, the Registration application 5008 allocates their user and broadcast channels, assigns their access to BVN™ system EBPs and manages the allocation of physical channels versus logical channels.

In addition, registration includes creating users and network enterprises, activating users and enterprises, maintaining contact information, setting up trading partner relationships and updating participant registration data.

The Registration application 5008 is also responsible for publishing registration data that is required by BVN™ system EBP applications, the Message Bus 5006 and Users on the network.

The Logon/Logoff application 5009 facilitates Users entering and exiting the BVN™ system. Logging onto a BVN™ system is not as straightforward as single application frameworks. As mentioned before, a User need only logon once to access all EBP applications on the system. The Logon/Logoff application 5009 provides the BVN™ system Connector 5004 with information required to allow the user to transact with the network. Similar to User logon, a BVN™ system EBP application also logs onto the BVN™ system. However, it is identified as a BVN™ system EBP application user.

The Messaging Logging application 5007 logs all events that are configured for message logging. If necessary, messages deleted from the system may be retrieved through this application.

The BVN™ system Connector 5004 is the mechanism through which applications interact with the BVN™ system network. A key concept of the BVN™ System Interoperation Framework 5000 is that the BVN™ system Connector 5004 provides a single point of access for a user and the user's application to the BVN™ system network. There is no need to have multiple connection mechanisms within a BVN™ system.

The BVN™ system Connector 5004 is a software agent that is, typically, local to the user's client application. When the User logs on, the Connector 5004 has dynamic access to all the relevant configuration data needed to support the User. This information is made available by the Logon/Logoff application 5009 based on the information captured during BVN™ system registration. The BVN™ system Connector 5004 can either store this configuration information locally in an encrypted format, or it can request the information from the Logon/Logoff application 5009, as needed.

The BVN™ system Connector 5004 incorporates the connectivity capabilities of the underlying Message Bus 5006. The Message Bus 5006/Event Channels 5005 are the communications backbone of the BVN™ System Interoperation Framework 5000. The BVN™ system Connector 5004 includes a communications client for the BVN™ Message Bus 5006.

The Message Bus 5006 is typically a commercial Message Bus 5006 package based on the Java Messaging service or the CORBA event service or equivalent. We use the term Message Bus 5006 to describe the communications and configuration aspects of the service, while Event Channels 5005 refers to the message “persistence” aspects.

The use of the description “channel” is based on the CORBA event specification, where a channel is an object that provides asynchronous publish and subscribe messaging services. The BVN™ System Interoperation Framework 5000 borrows this terminology, however any equivalent messaging scheme could be used to support the requirements of the BVN. For example the BVN™ system could use the Tibco™ software subject-based addressing approach, where high-level subject areas would correspond to Event Channels 5005.

The Message Bus 5006 and Event Channels 5005 provide a mechanism for the transfer of messages between applications in the BVN™ system. By supporting access control lists and encryption the channels provide a secure asynchronous publish and subscribe mechanism for event message transfer. The access control list is maintained by receiving updates from the Registration EBP application.

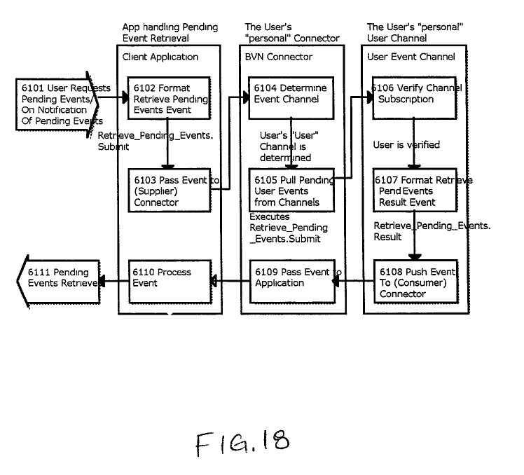

FIGS. 17 to 26 diagram the processes of the BVN™ system applications. Detailed descriptions of the applications are provided in the provisional application which is hereby included by reference in its entirety.

Referring to FIG. 17, the User Logon 6000 process is diagrammed. During the User Logon 6000 process the BVN™ system performs several tasks including, obtaining a Connector for the User 6002, Publishing the Logon Event 6006, verifying User Channel Subscriptions 6020 and other security related tasks.

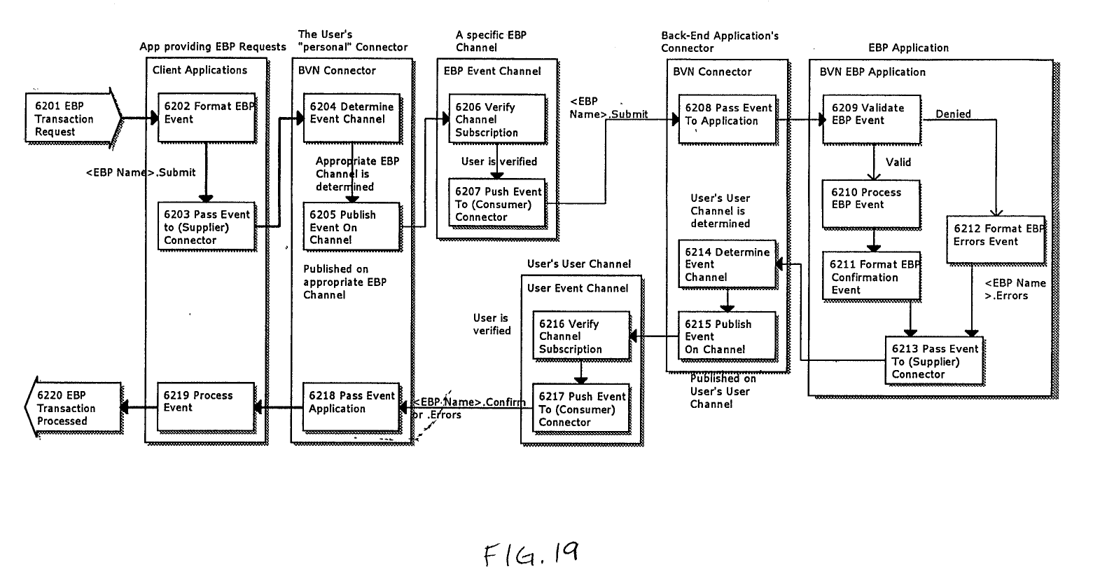

FIG. 18 details the Retrieving User Pending Events 6100 process. This process is User initiated.

User Requests Pending Events 6101 (or upon notification that pending events). The user requests the retrieval of pending user events, i.e. user events that are on the user's Event Channels 5005, but which have not yet been “consumed” or “read by the user. This event may occur as a result of a notification from the Connector 5004 that pending events are available.

Format Retrieve Pending Events Event 6102. The client application formats a retrieve pending events event. The event can specify event retrieval criteria such as “get next” or “get next EBP response”, or “Get userid XYZ inter party message” etc.

Pass Event To Connector 6103. Client application passes the retrieval event to the user BVN™ system connector.

Determine Event Channel 6104. The BVN™ M system Connector 5004 identifies the correct User Channel to retrieve from based on the event passed to the BVN™ Connector.

Pull Pending User Events from Channels 6105. The BVN™ system Connector 5004 forwards a “Retrieve_Pending_Event.Submit” to the selected user channel, which should trigger the return of the appropriate event(s).

Verify Channel Subscription 6106. The Event Channel 5005 verifies that the Connector 5004 and user have the authority to retrieve the event from the Event Channel 5005 (this may include items such as checking digital certificates, encryption keys, userid and/or passwords). If valid the event is retrieved from the channel. Otherwise it is rejected.

Format Retrieve Pending Events Result Event 6107. The channel retrieves the event(s) from the user channel, formats the reply message and marks the events as having been “read” or “consumed” by the user (note-may be a null set).

Push Event to (Consumer) Connector 6108. The Event Channel 5005 feeds the retrieval event(s) to the EBP application BVN™ Connector 5004 (can be achieved by a push onto the connector or a pull from the connector).

Pass Event To (Supplier) Connector 6109. Pass the event back to the BVN™ system Connector 5004, for transfer back to the client application and user.

Process Event 6110. The client application processes the retrieval reply. This may include storing the reply, displaying it or performing further processing on the retrieved event.

Pending Event Retrieved 6111. Indicates the user and client application successfully retrieved desired event(s) from the user channel.

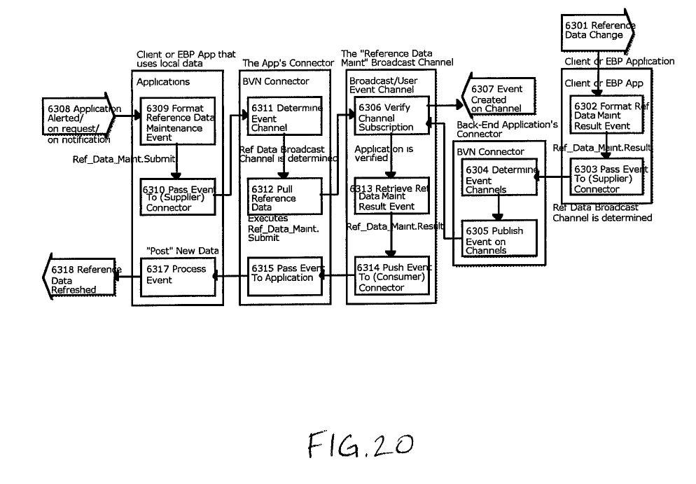

The Elementary Business Process Request 6200 process flow is detailed in FIG. 19.

EBP Transaction Request 6201. The user makes a request to use an EBP service. The EBP service request may be a “utility” (information retrieval event) EBP event or a “domain” (execute a command that changes the state of data in the EBP application) EBP event.

Format EBP Event 6202. The client application formats a valid EBP event based on the user request.

Pass Event to Connector 6203. Client application passes the EBP request event to the user BVN™ Connector.

Determine Event Channel 6204. BVN™ system Connector 5004 identifies the correct EBP channel to place the event on based on the event passed to the BVN™ system Connector 5004 and the user's authorizations. If the Connector 5004 cannot process the EBP request because the user does not have authorization to make such a request then the event is rejected.

Publish Event On Channel 6205. The BVN™ system Connector 5004 attaches to the EBP Event Channel 5005 and sends the EBP vent to the correct EBP Event Channel 5005.

Verify Channel Subscription 6206. The Event Channel 5005 verifies that the Connector 5004 and user have the authority to put an event on the EBP channel (this may include checking digital certificates, encryption keys, session ids etc). If valid the event is placed on the Event Channel 5005. Otherwise it is rejected.

Push Event to (Consumer) Connector 6207. The Event Channel 5005 feeds the EBP event to the EBP application Connector 5004 (can be achieved by a push onto the connector or a pull from the connector).

Pass Event To application 6208. The EBP application Connector 5004 passes the event to the EBP application.

Validate EBP Event 6209. The BVN™ system EBP authenticates the user, checks authorization and determines whether event is formatted correctly. The user was logged into the EBP application as a part of logon.

Process EBP Event 6210. The BVN™ system EBP application processes the event (if valid). Processing may involve retrieving information if a utility command or changing information if a domain command.

Format EBP Confirmation Event 6211. The EBP confirmation event is formatted based on the results of processing the EBP request (see 10. EBP role broadcast —processing EBP may also result in additional broadcasts)

Format EBP Errors Event 6212. If the EBP event is denied then the EBP application formats an EBP errors event for return to the user.

Pass Event To (Supplier) Connector 6213. Pass the event back to the BVN™ Connector, for transfer back to the client application and user.

Determine User Logon Reply Event Channel 6214. The BVN™ system Connector 5004 determines on which Event Channel 5005 to place the EBP reply event.

Publish Event on Channel 6215. The BVN™ system Connector 5004 attaches to the user Event Channel 5005 and sends the EBP reply event to the user Event Channel 5005.

Verify Channel Subscription 6216. The user Event Channel 5005 verifies that the Connector 5004 and EBP have the authority to put an event on the user channel (this may include checking digital certificates, encryption keys etc). If valid the event is placed on the Event Channel 5005. Otherwise it is rejected.

Push Event to (Consumer) Connector 6217. The Event Channel 5005 feeds the EBP reply event to the client application BVN™ system Connector 5004 (can be achieved by a push onto the connector or a pull from the connector).

Pass Event To application 6218. The client application Connector-5004 passes the EBP reply event to the client application.

Process Event 6219. The client application processes the EBP reply. This may include storing the reply, displaying it or performing further processing on the reply event.

EBP Transaction Processed 6220. Indicates the user and client application successfully received desired reply event from the user channel and processed it successfully.

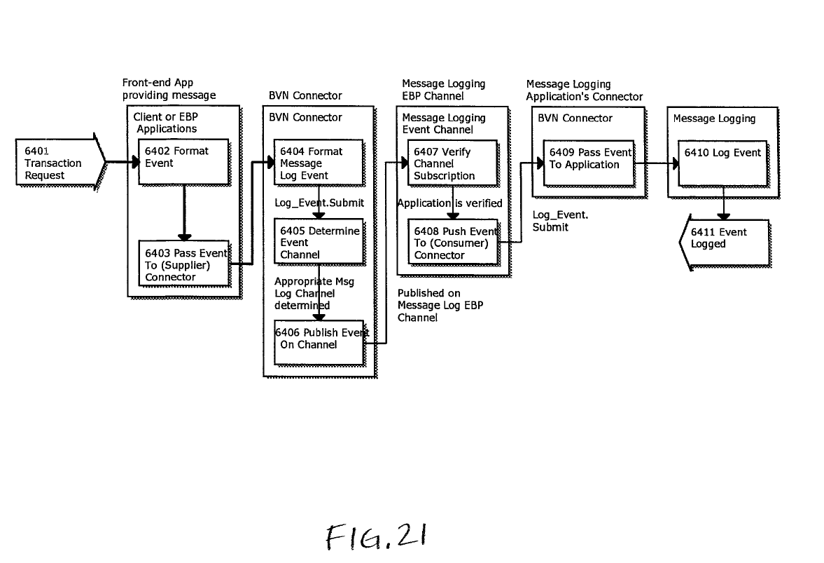

Turning to FIG. 20, a process flow for Reference Data Maintenance 6300 is shown.

Reference Data Change 6301. There is a change of state in some reference data in the application that requires publishing to the network. For example if a price changes on a catalog item, the trading partners need to be alerted.

Format Reference Data Maintenance Result Event 6302. The client or EBP application formats a Data Maintenance EBP event for publishing to the BVN™ system network.

Pass Event To (Supplier) Connector 6303. Pass the event to the BVN™ Connector, for transfer to the required broadcast and user channels.

Determine Event Channels 6304. The BONG system Connector 5004 determines on which Event Channels 5005 to place the reference data maintenance event. This is typically broadcast channels, but may include some user channels (for example wish to inform trading partners directly of the data change) Publish Event on Channels 6305. The BVN™ system Connector 5004 attaches to the appropriate broadcast and user Event Channels 5005 and sends the EBP reply event to the Event Channels 5005.

Verify Channel Subscription 6306. The user and broadcast Event Channels 5005 verify that the Connector 5004 and user have the authority to put a reference data maintenance event on the channel (this may include checking digital certificates, encryption keys etc). If valid the event is placed on the Event Channel 5005. Otherwise it is rejected.

Event Created on Channel 6307. The reference data maintenance event has been successfully put on the Event Channel(s) 5005.

Application Alerted on Request/on Notification 6308. The client or EBP application receives a user request to retrieve reference data maintenance event or the application receives an automatic notification.

Format Reference Data Maintenance Event 6309. The application formats a reference data maintenance retrieval event, based on the user request.

Pass Event to Connector 6310. Application passes the reference data maintenance retrieval request event to the user BVN™ Connector.

Determine Event Channel 6311. BVN™ system Connector 5004 identifies the correct channel to send the retrieval event on based on the event passed to the BVN™ system Connector 5004 and the user's authorizations. If the Connector 5004 cannot process the EBP request because the user does not have authorization to make such a request then the event is rejected.

Pull Reference Data 6312. The BVN™ system Connector 5004 attaches to the logon Event Channel 5005 and sends the retrieval event to the correct Event Channel 5005.

Verify Channel Subscription 6313. The user and broadcast Event Channels 5005 verify that the Connector 5004 and user have the authority to put a pull reference data maintenance event on the channel (this may include checking digital certificates, encryption keys etc). If valid the event is placed on the Event Channel 5005. Otherwise it is rejected.

Application Alerted on Request/on Notification 6314. The client or EBP application receives a user request to retrieve reference data maintenance event or the application receives an automatic notification.

Format Reference Data Maintenance Retrieval Event 6315. The application formats a reference data maintenance retrieval event, based on the user request.

Pass Event to Connector 6316. Application passes the reference data maintenance retrieval request event to the user BVN™ Connector.

Determine Event Channel 6317. BVN™ system Connector 5004 identifies the correct channel to send the retrieval event on based on the event passed to the BVN™ system Connector 5004 and the user's authorizations. If the Connector 5004 cannot process the EBP request because the user does not have authorization to make such a request then the event is rejected.

Pull Reference Data 6318. The BVN™ system Connector 5004 attaches to the logon Event Channel 5005 and sends the retrieval event to the correct Event Channel 5005.

Verify Channel Subscription 6319. The user and broadcast Event Channels 5005 verify that the Connector 5004 and user have the authority to put a pull reference data maintenance event on the channel (this may include checking digital certificates, encryption keys etc). If valid the event is placed on the Event Channel 5005. Otherwise it is rejected.

Retrieve Reference Data Maintenance Result Event 6320. The Channels retrieves the reference data maintenance event based on the reference data maintenance request.

Push Event to (Consumer) Connector 6321. The Event Channel 5005 feeds the data maintenance event to the client application BVNo system Connector 5004 (can be achieved by a push onto the connector or a pull from the connector).

Pass Event To Application 6322. The client application Connector 5004 passes the reference data maintenance event to the client application.

Process Event 6323. The client application processes the reference data maintenance event. This may include storing the reply, displaying it or performing further processing on the reply event.

Reference Data Refreshed 6324. Indicates the user and client application successfully received desired event from the channel and processed it successfully.

Retrieve Reference Data Maintenance Result Event 6325. The Channels retrieves the reference data maintenance event based on the reference data maintenance request.

Push Event to (Consumer) Connector 6326. The Event Channel 5005 feeds the data maintenance event to the client application BANS system Connector 5004 (can be achieved by a push onto the connector or a pull from the connector).

Pass Event To Application 6327. The client application Connector 5004 passes the reference data maintenance event to the client application.

Process Event 6328. The client application processes the reference data maintenance event. This may include storing the reply, displaying it or performing further processing on the reply event.

Reference Data Refreshed 6329. Indicates the user and client application successfully received desired event from the channel and processed it successfully.

FIG. 21 details the Message Logging process of the BVN™ system.

Transaction Request 6401. The user makes a transaction request (this could be an EBP application returning a confirmation, a client application making an EBP request, or an application publishing to a broadcast channel).

Format Event 6402. The application formats a valid event based on the user request.

Pass Event to Connector 6403. Client application passes the request event to the user BVN™ connector.

Format Message Log Event 6404. If the event is flagged for message logging, the BVN™ connector formats a Message Log Event using a copy of the submitted event.

Determine Event Channel 6404. BVN™ Connector identifies the correct message-logging channel to place the event on based on the event passed to the BVN™ connector and the user's authorizations.

Publish Event On Channel 6406. The BVN™ connector attaches to the appropriate logging event channel and sends the EBP event to the correct event channel.

Verify Channel Subscription 6407. The event channel verifies that the connector and user have the authority to put an event on the message-logging channel (this may include checking digital certificates, encryption keys, session ids etc). If valid the event is placed on the event channel. Otherwise it is rejected.

Push Event to (Consumer) Connector 6408. The event channel feeds the message log event to the Message Logging Application BVN™ connector (can be achieved by a push onto the connector or a pull from the connector).

Pass Event To Application 6409. The Message Logging BVN™ connector passes the event to the Message Logging application.

Log Event 6410. The message logging application authenticates the user, checks authorization and logs the event.

Event Logged 6411. The event has been successfully logged in the message log.

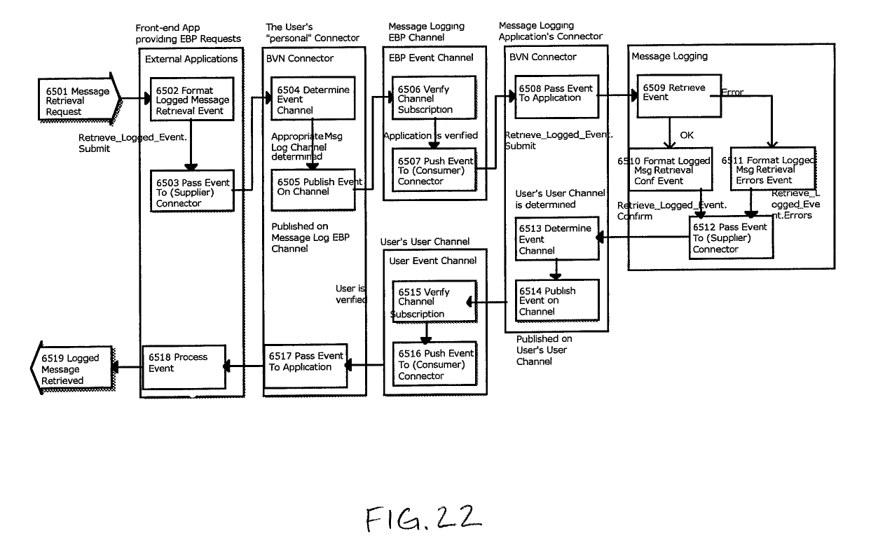

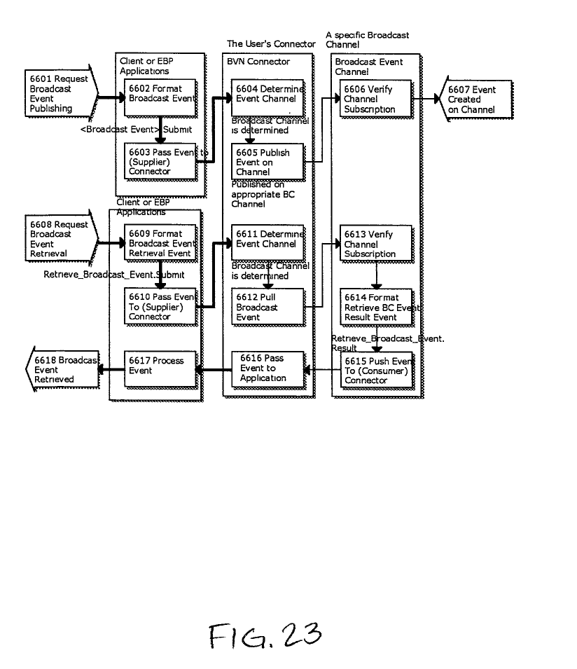

FIG. 22 details the Message Retrieval 6500 process of the BVN™ system.

Message Retrieval Request 6501. The user requests the retrieval of a message that is no longer available on the event channels and must be retrieved from the business network message logging EBP application (the event is assumed to have been logged).

Format Logged Message Retrieval Event 6502. The client application formats a valid retrieval event based on the user request.

Pass Event to Connector 6503. Client application passes the message log retrieval event to the user BVN™ connector.

Determine Event Channel 6504. BVN™ Connector identifies the correct message log retrieval channel to place the event on based on the event passed to the BVN™ connector and the user's authorizations. If the connector cannot process the request because the user does not have authorization to make such a request then the event is rejected.

Publish Event On Channel 6505. The BVN™ connector attaches to the message logging event channel and sends the message retrieval event to the correct event channel.

Verify Channel Subscription 6506. The event channel verifies that the connector and user have the authority to put an event on the EBP channel (this may include checking digital certificates, encryption keys, session ids etc). If valid the event is placed on the event channel. Otherwise it is rejected.

Push Event to (Consumer) Connector 6507. The event channel feeds the message log retrieval event to the EBP Application BVN™ connector (can be achieved by a push onto the connector or a pull from the connector).

Pass Event To Application 6508. The EBP Application BVN™ connector passes the event to the EBP application.

Retrieve Event 6509. The message logging application authenticates the user, checks authorization and determines whether the retrieval event is formatted correctly. The user was logged into the messaging logging application as a part of logon. The application processes the event (if valid). Processing involves retrieving information from the message event archive.

Format Logged Message Retrieval Confirmation Event 6510. The confirmation event is formatted based on the results of processing the retrieval request.

Format Logged Message Retrieval Errors Event 6511. If the retrieval event is denied then the EBP application formats an errors event for return to the user.

Pass Event To (Supplier) Connector 6512. Pass the event back to the BVN7M connector, for transfer back to the client application and user.

Determine Event Channel 6513. The BVN™ connector determines on which event channel to place the retrieved logged message return event.

Publish Event on Channel 6514. The BVN™ connector attaches to the user event channel and sends the message retrieval reply return event to the user event channel.

Verify Channel Subscription 6515. The user event channel verifies that the connector and message retrieval EBP have the authority to put an event on the user channel (this may include checking digital certificates, encryption keys etc). If valid the event is placed on the event channel. Otherwise it is rejected.

Push Event to (Consumer) Connector 6516. The event channel feeds the retrieved message return event to the client application BVN™ connector (can be achieved by a push onto the connector or a pull from the connector).

Pass Event To Application 6517. The client application connector passes the message retrieval return event to the client application.

Process Event 6518. The client application processes the retrieval return event. This may include storing the return event, displaying it or performing further processing on the return event.

Logged Message Retrieved 6519. Indicates the user and client application successfully received desired return event from the user channel and it contained the desired message.

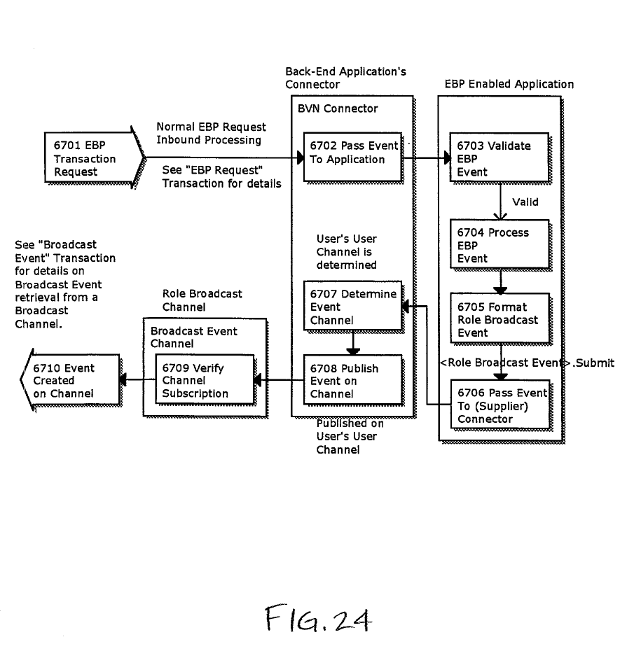

FIG. 23 details the Broadcast Event 6600 process of the BVN™ system.

Request Broadcast Event Publishing 6601. A client or EBP application receives a user request to publish a broadcast event. This trigger may occur due to an internal application event like a database update, due to receiving some external information like a report, or may occur as the result of a user request.

Format Broadcast Event 6602. The application formats a valid broadcast event based on the user request.

Pass Event to Connector 6603. Application passes the broadcast event to the user BVN™ connector.

Determine Event Channel 6604. BVN™ Connector identifies the broadcast channel to place the event on based on the event passed to the BVN™ connector and the user's authorizations. If the connector cannot process the request because the user does not have authorization to make such a request then the event is rejected.

Publish Event On Channel 6605. The BVN™ connector attaches to the broadcast event channel and sends the message retrieval event to the correct event channel.

Verify Channel Subscription 6606. The broadcast event channel verifies that the connector and user have the authority to put an event on the EBP channel (this may include checking digital certificates, encryption keys, session ids etc). If valid the event is placed on the broadcast event channel. Otherwise it is rejected.

Event Created on Channel 6607. The broadcast event has been successfully added to the event channel.

Request Broadcast Event Retrieval 6608. The client or EBP application receives a user request to retrieve a broadcast event or the application receives an automatic notification.

Format Broadcast Event Retrieval Event 6609. The application formats a broadcast retrieval event, based on the user request.

Pass Event to Connector 6610. Application passes the retrieval request event to the user BVN™ connector.

Determine Event Channel 6611. BVN™™ Connector identifies the correct channel to send the retrieval event on, based on the broadcast retrieval event passed to the BVN™™ connector and the user's authorizations. If the connector cannot process the EBP request because the user does not have authorization to make such a request then the event is rejected.

Pull Broadcast Event 6612. The BVN™ connector attaches to the logon event channel and sends the broadcast retrieval event to the correct event channel.

Verify Channel Subscription 6613. The broadcast event channel verifies that the connector and user have the authority to put a retrieve broadcast event on the channel (this may include checking digital certificates, encryption keys etc). If valid the event is placed on the event channel. Otherwise it is rejected.

Format Retrieve Broadcast Channel Results Event 6614. The Channel retrieves the broadcast event based on the reference data maintenance request.

Push Event to (Consumer) Connector 6615. The event channel feeds the broadcast return event to the client application BVN™ connector (can be achieved by a push onto the connector or a pull from the connector).

Pass Event To Application 6616. The client application connector passes the broadcast return event to the client application.

Process Event 6617. The client application processes the broadcast return event. This may include storing the return event, displaying it or performing further processing on the return event.

Broadcast Event Retrieved 6618. Indicates the user and client application successfully received desired broadcast event from the channel and processed it successfully.

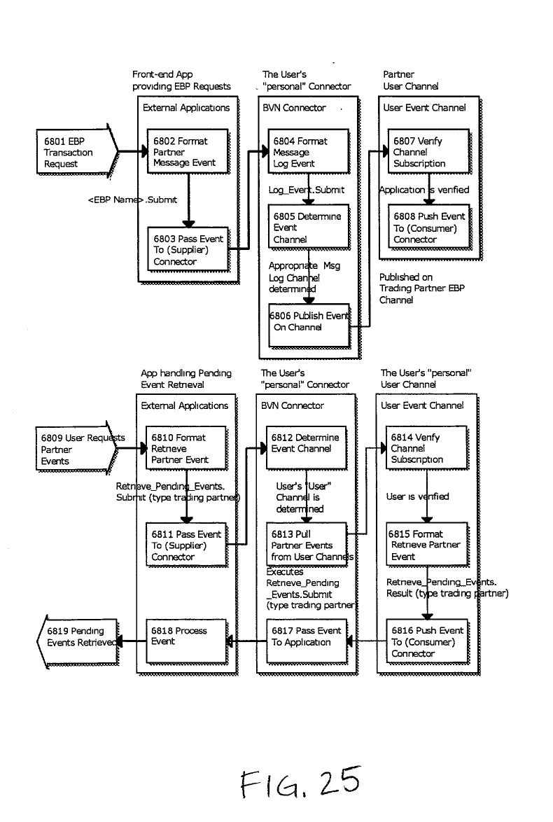

FIG. 24 details the EBP Role Broadcast Event 6700 process of the BVN™ system.

EBP Transaction Request 6701. This is the normal processing of an inbound EBP request.

Pass Event to Application 6702. The EBP request event is forwarded to the EBP enabled application via the BVN™ connector.

Validate EBP Event 6703. The EBP application authenticates the user, and validates the event.

Process EBP Event 6704. The EBP application processes the EBP event.

Format Role Broadcast Event 6705. The EBP application formats a broadcast event for publishing to a role broadcast channel. As a result of processing the EBP event, there may be a necessity to generate a broadcast event. For example if the price changes on an item in the catalog, all parties in the role retailers who subscribe to the channel “manufacturer price changes” would be notified once the price change were posted on the “manufacturer price changes channel”. Similarly new mortgage applications would be posted on the “mortgages” channel once a new mortgage was “submitted to trading”, via a trading EBP.

Determine Event Channel 6706. The BVN™ connector determines the role broadcast channel based on the event passed to it.

Publish Event on Channel 6707. The BVN™ connector sends the event to the broadcast channel for publishing.

Verify Channel Subscription 6708. The broadcast channel takes the broadcast message and if valid paces it on the role broadcast channel. All participants logged on, with that role, now have access to the event.

Event Created on Channel 6709. The event is ready to be accessed on the role broadcast channel.

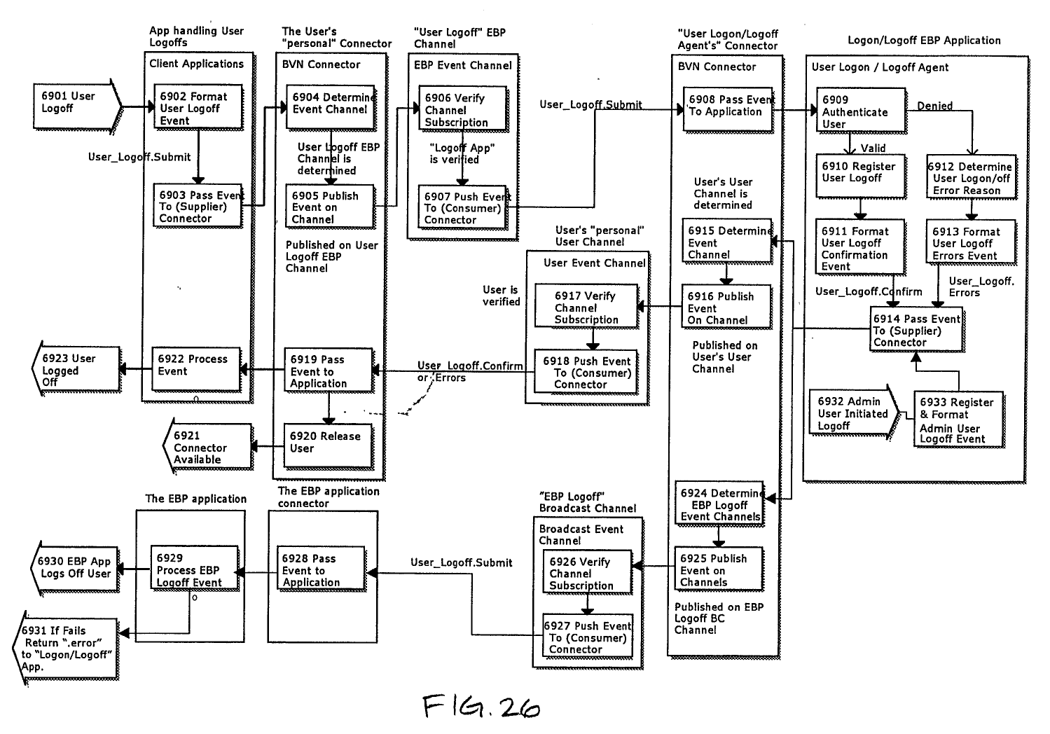

FIG. 25 details the Inter party Messaging 6800 process of the BVN™ system.

EBP Transaction Request 6801. The user makes a request to pass an inter-party message. The inter party message may be any type of event.

Format Trading Partner Message Event 6802. The client application formats a valid event based on the user request.

Pass Event to Connector 6803. Client application passes the partner message request event to the user BVN connector.

Format Message Log Event 6804. If the party wishes-all inter party messages are logged.

Determine Event Channel 6805. BVN Connector identifies the correct user channel to place the event on based on the event passed to the BVN connector and the user's authorizations. If the connector cannot process the partner message request because the user does not have authorization to make such a request then the event is rejected.

Publish Event On Channel 6806. The BVN connector attaches to the user event channel and sends the EBP event to the correct user event channel.

Verify Channel Subscription 6807. The event channel verifies that the connector and user have the authority to put an event on the user channel (this may include checking digital certificates, encryption keys, session ids etc). If valid the event is placed on the event channel. Otherwise it is rejected.

Push Event to (Consumer) Connector 6808. The event channel feeds the partner message event to the partner client Application BVN™ connector if configured to do so (can be achieved by a push onto the connector or a pull from the connector).

User Requests Partner Events 6809(or upon notification that pending events). The user requests the retrieval of pending user events that are of type “partner message”, i.e. partner events that are on the user's event channels, but which have not yet been “consumed” or “read by the user. This event may occur as a result of a notification from the connector that pending partner message events are available.

Format Retrieve Partner Event 6810. The client application formats a retrieve pending partner message events event. The event can specify event retrieval criteria such as “get next” or “get next from Joe”, or “Get userid XYZ inter party message” etc.

Pass Event To Connector 6811. Client application passes the retrieval event to the user BVN connector.

Determine Event Channel 6812. BVN Connector identifies the correct User Channel to retrieve from based on the event passed to the BVN connector.

Pull Events from Channels 6813. The BVN connector forwards a “Retrieve_Pending_Event.Submit” to the selected user channel, which should trigger the return of the appropriate event(s).

Verify Channel Subscription 6814. The event channel verifies that the connector and user have the authority to retrieve the event from the event channel (this may include checking digital certificates, encryption keys, userid, passwords etc). If valid the event is retrieved from the channel. Otherwise it is rejected.

Format Retrieve Pending Events Result Event 6815. The channel retrieves the event(s) from the user channel, formats the reply message and marks the events as having been “read” or 'consumed“by the user (note-may be a null set).

Push Event to (Consumer) Connector 6816. The event channel feeds the retrieval event(s) to the EBP application BVN connector (can be achieved by a push onto the connector or a pull from the connector).

Pass Event To (Consumer) Connector 6817. Pass the event back to the BVN connector, for transfer back to the client application and user.

Process Event 6818. The client application processes the partner message event. This may include storing the message, displaying it or performing further processing on the retrieved event.

Pending Event Retrieved 6819. Indicates the user and client application successfully retrieved desired event(s) from the user channel.

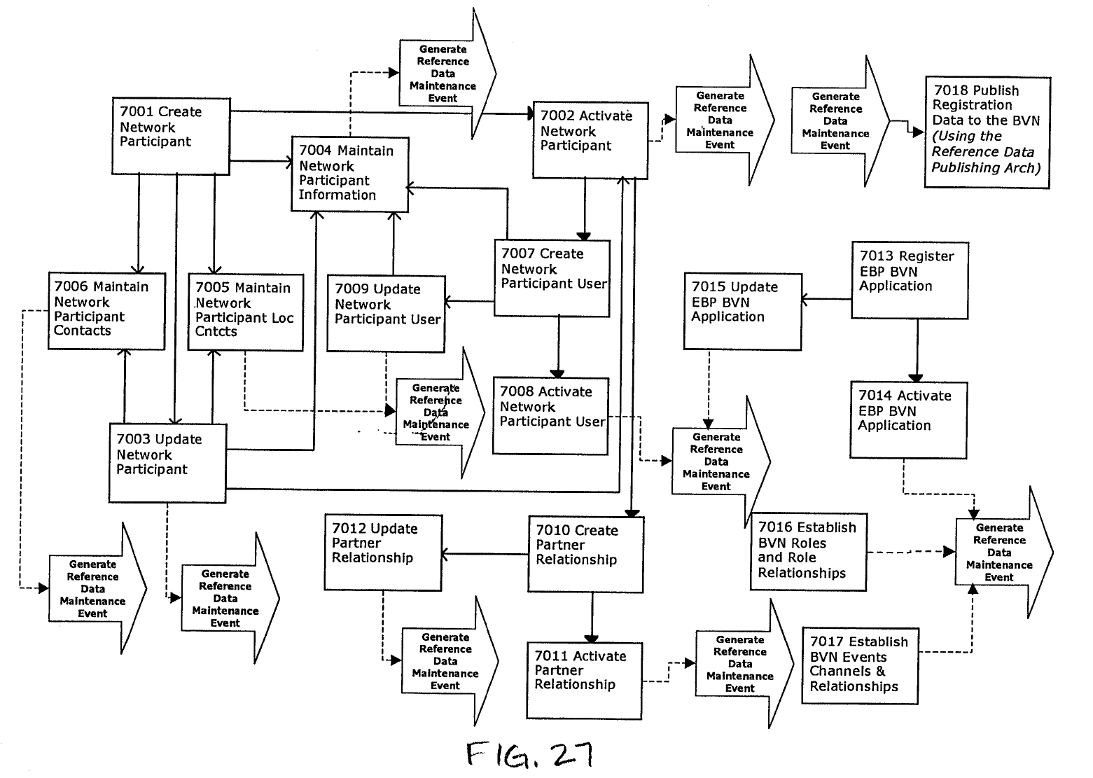

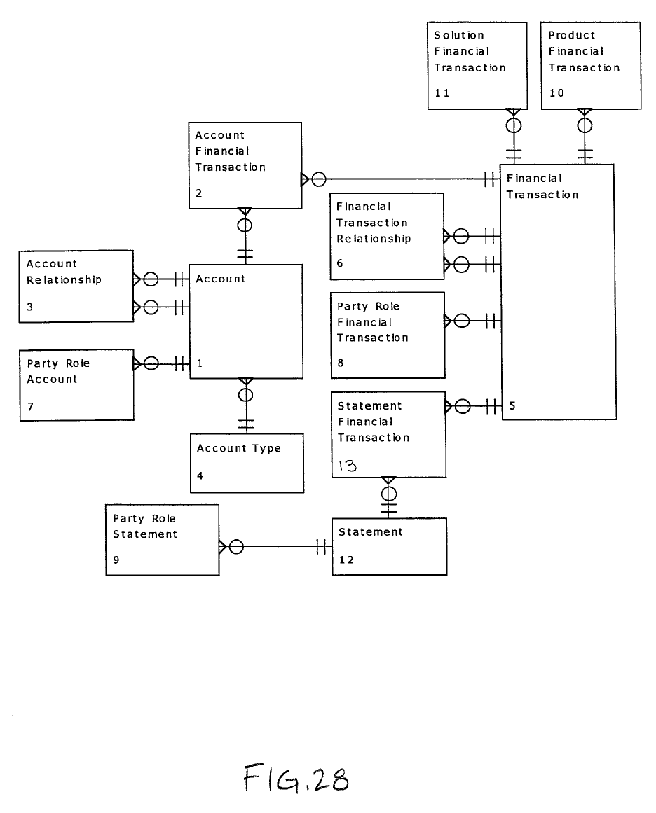

FIG. 26 details the User Logoff process of the BVN™ system.

User Logoff 6901. The user logs off the client application (user could be an automated trading agent acting on behalf of user, or human).

Format User Logoff Event 6902. Based on the userid, session id and logoff event specification, the client application formats a user logoff event.

Pass Event To Connector 6903. The client application passes the logoff event to the connector for that user.

Determine Event Channel 6904. The BVN connector determines which channel to place the user logoff request.

Publish Event On Channel 6905. The BVN connector attaches to the logoff event channel and sends the logoff event to the logoff event channel.

Verify Channel Subscription 6906. The event channel verifies that the connector and user have the authority to put an event on the user logoff channel (this may include checking digital certificates, encryption keys, userid, session id etc). If valid the event is placed on the event channel. Otherwise it is rejected.

Push Event to (Consumer) Connector 6907. The event channel feeds the logoff event to the logoff EBP BVN connector (can be achieved by a push onto the connector or a pull from the connector).

Pass Event To Application 6908. The Logoff EBP BVN connector passes the event to the Logon EBP application.

Authenticate User 6909. The Logoff EBP authenticates the user, checks authorization and determines whether user can logoff.

Register User Logoff 6910. If the authentication is valid, the user logoff is registered by the Logoff EBP application.

Format User Logoff Confirmation Event 6911. The Logoff EBP application formats the logoff conformation event.

Determine User Logon/off Error Reason 6912. If the user logoff was denied, then the logoff EBP application determines the error reason.

Format User Logoff Errors Event 6913. Once the logoff error reasons have been determined, the logoff EBP application formats a user logoff error event for passing back to the user.

Pass Event To (Supplier) Connector 6914. Pass the event back to the BVN connector, for transfer back to the client application and user.

Determine User Reply Event Channel 6915. The BVN connector determines on which event channel to place the EBP logoff reply.

Publish Event on Channel 6916. The BVN connector attaches to the user event channel and sends the logoff reply event to the user event channel.

Verify Channel Subscription 6917. The event channel verifies that the connector and user have the authority to put a logoff return event on the user channel (this may include checking digital certificates, encryption keys, userid etc). If valid the event is placed on the event channel. Otherwise it is rejected.

Push Event to (Consumer) Connector 6918. The event channel feeds the logoff reply event to the client application BVN connector (can be achieved by a push onto the connector or a pull from the connector).

Pass Event To Application 6919. The client application connector passes the relevant logoff reply event to the client application.

Release User 6920. The BVN connector releases the user, erases user temporary user data in the connector and makes connector available for other logon.

Connector Available 6921. The connector is now available for another user to logon.

Process Event 6922. The client application processes the logoff reply. The logoff reply indicates the user has been logged off successfully.

User Logged Off 6923. The user is now logged off the Business Network.

Determine User Logoff Event Channels 6924. The BVN connector determines on which event channels to place the user EBP logoff events for the EBP applications. Once the user is successfully logged off the logon/logoff application, the user must be logged off the relevant EBP applications. The user's relationship to EBP events and hence EBP applications was identified during registration. Logoff to the EBP applications is handled by the logoff application, publishing a logoff on the user's behalf to all the relevant EBP applications (otherwise the user would have to logoff individually to every EBP application).

Publish Event on Channels 6925. The BVN connector attaches to the logoff event channels for the appropriate EBP applications and sends the logoff events to the correct EBP logoff event channel.

Verify Channel Subscription 6926. The event channel verifies that the connector and user have the authority to put a logoff event on the EBP logoff channel (this may include checking digital certificates, encryption keys, userids etc). If valid the event is placed on the EBP event channel. Otherwise it is rejected.

Push Event to (Consumer) Connector 6927. The event channel feeds the logoff event to the EBP application BVN connector (can be achieved by a push onto the connector or a pull from the connector).

Pass Event To Application 6928. The EBP application connector passes the logoff event to the client application.

Process EBP Logoff Event 6929. The EBP application processes the logoff event.

EBP App Logs Off User 6930. The EBP Application has successfully logged the user off.

If Fails Return “Error” to “Logon/Logoff” Application 6931. In the event that logoff to the BVN EBP application fails, the BVN EBP application returns an “error message”.

Admin User Initiated Logoff 6932. The BVN administrator may initiate a user logoff message. This may be done to “logoff” a user that has just been de-activated. It may be initiated if the user timed out. It may also be initiated if the administrator needs to do system maintenance or indeed wishes to change channel configurations.

Register & Format Admin User Logoff Event 6933. The BVN Logoff EBP application registers a system admin user logoff and formats a user logoff event and which then gets passed to the connector and processed like a normal user logoff.

Process Flow

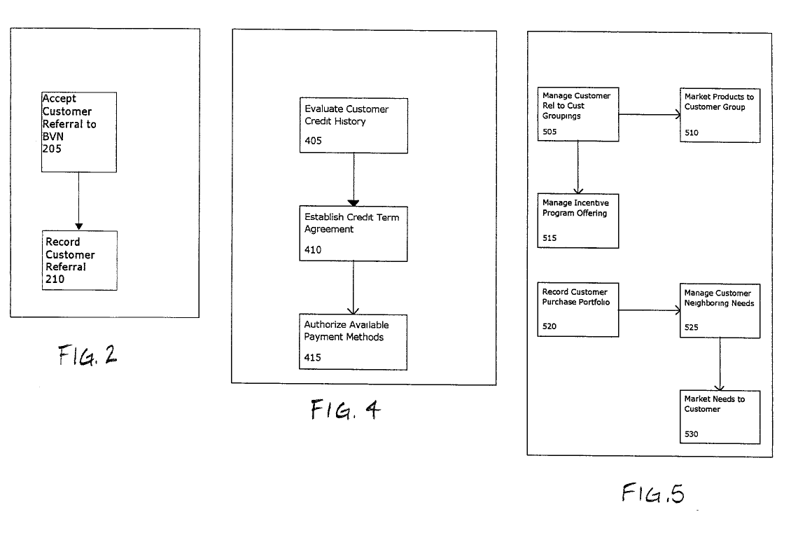

Referring to FIG. 2. the process may begin with Customer Referral Management 200 which includes the processes involved in the creation and maintenance of a link between a Customer 2025 and the Customer Referral Provider 2035 who referred them to a Customer Manager 2020 within a BVN™ system.

Initially, a Customer 2025 can be referred to a BONY system through a Customer Referral Provider 2035 (See Accept Customer Referral to BVN™ 205). This represents an indirect entry into the BVN™ system (i.e., a BVN-related web site was not directly linked to, but rather was linked to from an external site). The typical scenario of referral is through a link from the Customer Referral Provider's 2035 web site. The Customer Referral Provider 2035 is validated as being “active” within the network (via Party Role).

Record Customer Referral 210 allows a Customer 2025 to be linked to the Customer Referral Provider 2035, in a “pending” status. This facilitates the “ongoing” commission awarded to the Customer Referral Provider 2035 for bringing the first-time Customer 2025 to the BVN™ system. The establishment of a “permanent link” (updating the status to “active”) is dependent upon the Customer 2025 actually purchasing a Solution from the BVN™ system 150 during that session. The Customer Referral Provider 2035 is linked to the Customer 2025 they referred within Party Role Relationship with a “refers” relationship name. Network Participant Registration 300 includes processes involved in the creation and maintenance of required assignments that define internal or external parties' participation in the network. The primary assignments are to Roles, Locations, Service Provider Managers 2040 (for Service Providers 2045), and Customer Managers 2020 (for Customers 2025).

Also included is the capture of parent-subsidiary relationship and individual User 2055 information for a given Network Participant 2050.

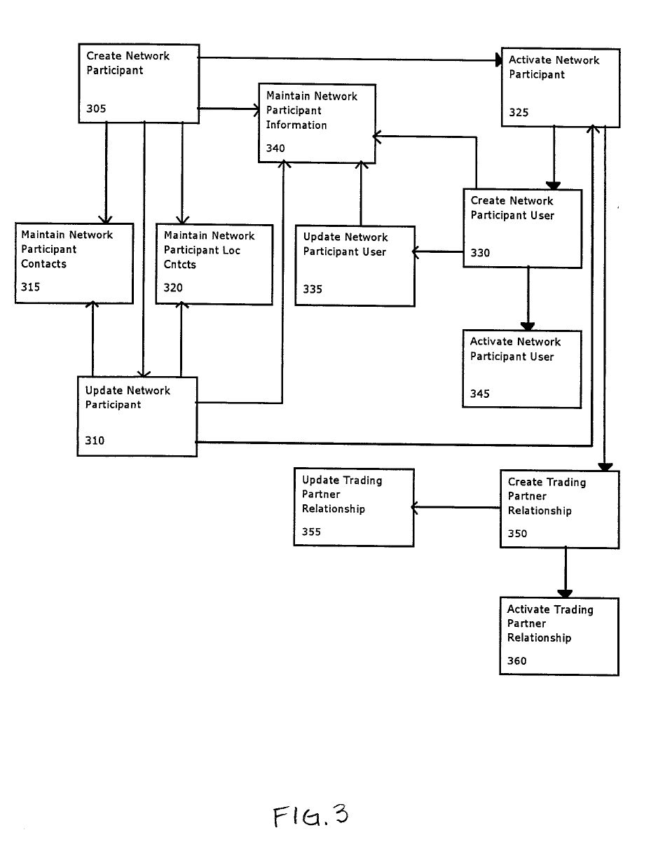

FIG. 3 includes all the components for Network Participant Registration 300. The first step is the creation of an “enterprise” party (also referred to as a Network Participant 2050), within a specific role (or roles) is a “configurable” status within a BVN™ system. The initial status of a Network Participant's 2050 roles are “configurable” to allow for an explicit Network Participant 2050 “activation” process (by a network management role), if desired.

The party being registered may play roles that are either internal (e.g., Service Provider 2045) or external (e.g., Customer 2025) to the BVN™ system. Various types of location information are also captured for the party, either “generically” (across all roles) or within their specific roles.

Based on the role a party is registering within, appropriate assignments to BVN™ system management parties are also created. For example, if a party registers within the role of Customer 2025 they will be “registered with” a Customer Manager 2020 and, if they register within a “Service Provider 2045” type of role, they will be “registered with” a Service Provider Manager 2040.

The registering party also has an individual created as an Administrator 2060 for them, which allows the Administrator 2060 to perform various administrative duties within the BVN, such as adding individual Users 2055.

An “Enterprise” Party and appropriate Party Role and Party Role Relationship instances are created based on Roles being registered within. An “Individual” Party and “Administrator” Party Role is also created with links to the Network Participant 2050 in Party Role Relationship. Various Locations are also created for the Network Participant 2050 and Administrator 2060, which are associated to them via Party Role Location.

Update Network Participant 310 maintains a previously created “enterprise” party, within a specific role (or roles), within a BVN™ system. Various types of general (e.g., name) and location information can be maintained for the party, within their specific roles.

The Network Participant 2050 being maintained can have new Roles added or existing Roles removed via Party Role instances. If new Roles are being added, then new Party Role Relationship instances also need to be created. If existing Roles are being removed, then existing Party Role Relationship instances will need to be removed. New locations may be created and linked to the Network Participant 2050, within a Role, via Party Role Location instances or existing Party Role Locations may be removed.

The initial creation and/or updating of existing “contact person” information for an (“enterprise”) Network Participant 2050 takes place within Maintain Network Participant Contacts 315. “Contact person” information includes the individual's name, job title, and location information (e.g., email address).

The process can be executed by an Administrator 2060 of a Network Participant 2050 or a User 2055 of a network management party (i.e., Customer Manager 2020, Service Provider Manager 2040, or Market Manager 2010).

Individual Party contacts are created and linked to the Network Participant 2050 via Party Relationship with relationship name contact. Party Location instances also are created for the contact to store their locations (e.g., email address).

Maintain Network Participant Location Contacts 320 creates or updates “contact person” information for a specific “postal address” location of an “enterprise” Network Participant 2050.

The process can be executed by an Administrator 2060 of a Network Participant 2050 or a User 2055 of a network management party (i.e., Customer Manager 2020, Service Provider Manager 2040, or Market Manager 2010).

An “individual” party “contact” is created and linked to one of the Network Participant's 2050 “postal address” locations, within the context of a specific role, via a Party Role Location Party instance. The contact's location information (e.g., email address) is stored within Party Location.

Once a new party is created in Create Network Participant 305, the next step is to Activate Network Participant 325 by updating their status within a particular Role to active in order to allow them to participate in the network based on the capabilities (responsibilities) assigned to that Role. This process can also be used to deactivate a previously activated Network Participant 2050.

Optionally, an internal BVN™ system settlement account can be created for the Network Participant 2050. In fact, a Network Participant 2050 must have an account to be allowed to enter into trading-related activity in the network. Only a network management User 2055 can perform this process.

The status of the appropriate “enterprise-level” Party Role and Party Role Relationship instances are set to “active” (or “inactive” for deactivation).

In addition to creating “Enterprise” parties, “Individual” Users 2055 for an “enterprise” party within a specific role may also be created using Create Network Participant User 330. Various types of general (e.g., name) and location information are captured for the User 2055, such as phone number/extension, email address, etc. When necessary, Update Network Participant User 335, allows maintenance of a previously created “individual” User 2055.

An “Individual” Party and appropriate Party Role and Party Role Relationship instances are created based on Roles being registered within. Various Locations are also created for the User 2055, which are associated to him/her via Party Role Location.

The User 2055 being maintained can have new Roles added or existing Roles removed via Party Role instances. If new Roles are being added, then new Party Role Relationship instances also need to be created. If existing Roles are being removed, then existing Party Role Relationship instances will need to be removed. New locations may be created and linked to the User 2055, within a Role, via Party Role Location instances or existing Party Role Locations may be removed.

The initial creation and/or updating of existing “characteristic” information for an (“enterprise”) Network Participant 2050 or a (“individual”) User 2055 of a Network Participant 2050 is performed in Maintain Network Participant Information 340. “Characteristic” information refers to data that is in addition to the base set of data captured for a Network Participant 2050 or User 2055. “Characteristic” information can be captured generically” or within the context of a specific Role assigned to the Network Participant 2050 or User 2055. Users 2055, Administrators 2060, or a network management party (i.e., Customer Manager 2020, Service Provider Manager 2040, or Market Manager 2010) may maintain information.

The party, within the context of a specific role, has characteristic information stored within Party Role Role Attribute Value instances. Role Attribute Value contains the “dynamic” characteristics, and their values, for the specific party within a role.

The next step in the process flow is to Activate Network Participant User 345. In this step, the “status” of a Network Participant User 2055 is updated to “active” by the parent Network Participant's Administrator 2060 to allow the User 2055 to participate in the network.

The status of the appropriate individual-level Party Role and Party Role Relationship instances are set to “active” (or “inactive” for deactivation).

As Users 2055 and Network Participants 2050 are added to the BVN™ system, trading relationships must be created using the Create Trading Partner Relationship 350 process. Trading relationships may be established to limit the usage of Service Providers 2045 by Customers 2025 and vice versa. For example, a Customer 2025 may choose to make their product needs available only to Service Providers 2045 with whom they have established a trading partner relationship. A trading partnership may include multiple “supporting” parties.

A Party Role Relationship with a “trading partnership” relationship name is created. Additional parties (enterprises or individuals within Roles) can be associated with the trading partnership via Party Role Relationship Party Role.

Update Trading Partner Relationship 355 provides a process for maintaining “supporting parties”, within specific Roles, for an existing “trading partner” relationship between Network Participants 2050. New supporting parties, within Roles, can be added and existing supporting parties can be removed. “Supporting parties”, within specific Roles (i.e., Party Roles), can be added to or removed from an existing trading partnership (i.e., Party Role Relationship) via Party Role Relationship Party Role instances.

After trading relationship are defined in Create Trading Partner Relationship 350, the newly defined relationship is activated in Activate Trading Partner Relationship 360. This process can also be used to “deactivate” previously activated trading relationships.

The appropriate Party Role Relationship with a “trading partnership” relationship name is updated to “active” status (or “inactive” status in the case of a deactivation).

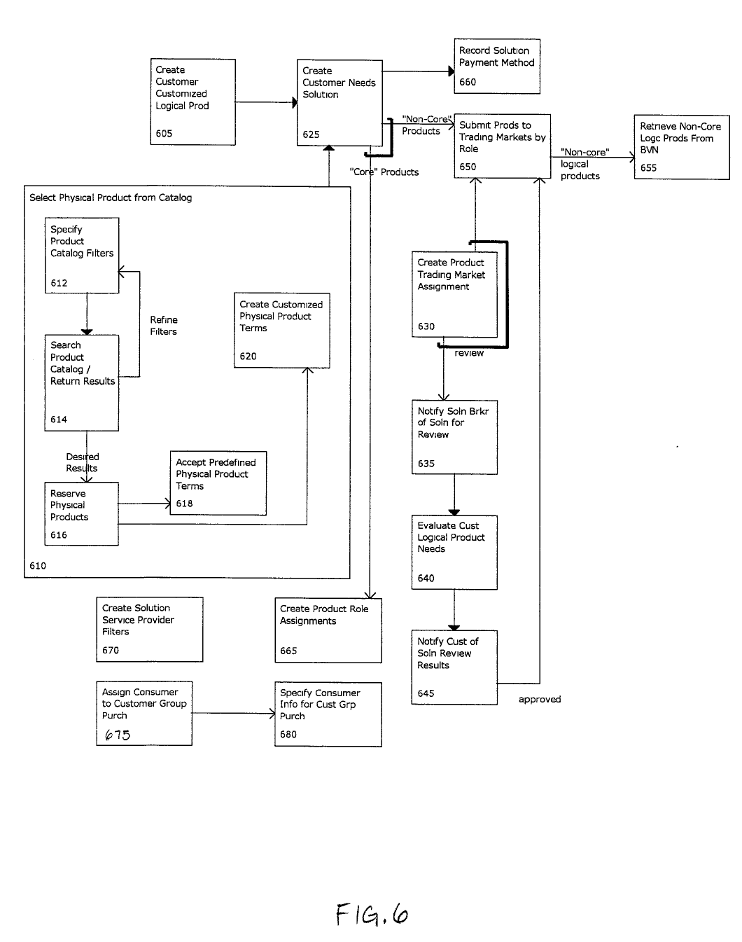

Referring to FIG. 4, Customer Credit Management 400 includes all processes involved in managing a Customer's 2025 credit with respect to the purchasing of solutions within the BVN™ system.

Before allowing entry into the BVN™ system, the credit worthiness of a prospective Customer 2025 is determined in Evaluate Customer Credit History 405. This includes recording Customer's 2025 general credit rating.

The Party Role table is read to obtain the Customer 2025. Credit rating information is then recorded for the Customer 2025 either in Party Role or Party Role Role Attribute Value (depending on amount of information to be captured).

The creation of an agreement between Customer Manager 2020 and Customer 2025 describing the credit extended to Customer 2025 when making solution purchases, is performed in Establish Credit Term Agreement 410.

The Party Role table is read to obtain the “Customer 2025” and “Customer Manager 2020”. A “customized” “Credit Term” Agreement is created from a “template” Agreement Specification and both parties are linked to the agreement via Party Role Agreement.

After reviewing a Customer's 2025 credit history, it is necessary to Authorize Available Payment Methods 415. If a Customer 2025 has a poor credit history, the payment methods available to pay for a Solution may be limited depending on the severity of the poor credit. In extreme cases, a Customer's 2025 only option may be to prepay for all Solutions.

The Party Role table is read to obtain the Customer 2025. Credit rating information is then obtained for the Customer 2025 to determine if available payment methods need to be limited (credit information may be obtained from Party Role or Party Role Role Attribute Value). If credit history is poor, certain accounts may be removed for the Customer 2025 via expirations of Party Role Account instances.

Referring to FIG. 5, Customer Marketing Management 500 includes processes that maintain information concerning the buying/paying habits for a Customer 2025, including the proactive marketing to a Customer 2025 based on the marketing information that has been developed.

The creation and maintenance of marketing data is performed by reviewing actual Customer 2025 solution configuration details, purchasing and payment data, and then applying classification, generalization and summarization schemes in order to create a marketing view of the Customer 2025. The objective of these processes is to gain an understanding about the Customer 2025 in order to market products either real time or in batch.

Using Manage Customer Relationship to Customer Groupings 505, Customers 2025 are classified into one or more predefined Customer Groups. Factors such as geography, buying history within a BVN, use of credit, knowledge of a major event, and stated buying preferences are used to make the classification.

Information pertaining to the Customer 2025 is read, such as characteristic data (e.g., via Party Role Role Attribute Value), previously purchased products (via Party Role Solution and Solution Product), or geographic location (via Party Role Location). Definitions of Customer Groups are also read to determine if the Customer 2025 “fits the profile” of any Customer Groups. If so, the Customer 2025 is assigned to the customer group(s).

Information that is gathered as part of managing the customer relationship is used to Market Products to Customer Group 510. Products are mass marketed to groups of Customers 2025 that have been assigned to Customer Groups.

Predefined products are linked to specific Customer Groups (via Customer Group Product) to make them available to Customers 2025 within the customer group (via Party Role Customer Group).

In the Manage Incentive Program Offering 515, Customers 2025 are offered the opportunity to enroll in various incentive programs that reward the Customer 2025 for usage of the BVN™ system.

Incentive programs are targeted to specific groups of Customers 2025. Some incentive programs will be of a generic nature, and thus be offered to everyone immediately upon entry into the BVN™ system. Some incentives are based on Customer Groupings associated to the Customer 2025 after sufficient profile information is recorded.

Other incentive programs may be offered either immediately or after Customer Solution purchases. For example, incentive programs based on demographic information or products selected can be offered immediately, while very focused programs may only be offered after initial Customer Solution purchases of a specific type.

The customer groups (via Party Role Customer Group), geographic locations (via Party Role Location), and/or past purchases associated with a Customer 2025 (via Party Role Solution and Solution Product) are analyzed to “intelligently” offer specific incentive programs to the Customer 2025 (via Party Role Incentive Program).

Upon completion of a Solution for a Customer 2025, Record Customer Purchase Portfolio 520, updates the Customer's 2025 portfolio with information regarding the purchased products and/or services to assist in providing future (customized) total customer management services. (Related sub-processes are Record/Update Customer Marketing Profile Info.)

The Customer 2025 is linked to “classes of products” that they've purchased products within (via Party Role Product Class).

Manage Customer Neighboring Needs 525 uses the logical needs provided by a Customer 2025 to conduct a search for related needs of the Customer 2025. This process enables proactive target marketing.

This search is facilitated by the classification of Needs (and Products/Services) into subjective “groups” that facilitate the identification of Needs with an affinity towards each other.

The Customer's 2025 portfolio of previously purchased products is read to determine the “classes of products” that they've purchased. These product classes are used to obtain related product classes (with an affinity) so product offerings within those product classes are made available to the customer.

Once identified, the system is able to Market Needs to Customer 530. This module identifies potential customer needs, cross-references those needs to potential products that the BVN™ system wants to market, packages those products into an Offering and distributes the Offering to the Customer.

The needs of the customer are based on the Customer Groups that are associated to the Customer, the Marketing Profile information collected on the Customer and the identification of major events.

Offerings are created by “bundling” predefined products within them (via Offering Product) for solicitation to appropriate Customers 2025 (via Party Role Offering).

Referring to FIG. 6, Solution Configuration 600 involves the definition of “logical” product/service “needs” by a Customer 2025, which can be “bundled” into a Solution for trading within the trading markets. These product needs can be defined without having to bundle them into a Solution for immediate trading, if desired (i.e., product needs can be defined and maintained over a period of time).

Included is describing any characteristics concerning the solution that will enhance the quality (from the Customer's 2025 perspective) of “offered” product/services by Service Providers 2045 within the trading markets. For example, service provider “filters” can be applied to limit the Service Providers 2045 available for making product “offers” to the Customer's 2025 product needs.

At Create Customer Customized Logical Product 605, the Customer 2025 (or a User 2055 acting on the customer's behalf) creates “iCustomized” T Logical Products to represent their particular product or service needs. These customized products can be created via three approaches: 1) completely “from scratch”—Product attributes are assembled by a Customer 2025 to define a product need; 2) by selecting a “predefined” product or offering-Product attributes can be left as-is or customized by the Customer 2025; or 3) by selecting a “total solution” product or offering-Product attributes must be left as is and product trading is bypassed because Service Providers 2045 are already “pre-linked” to the products that will be provided within the solution.

A Customer 2025 can mark a need (or set of needs) as “ongoing” to enable a Solution to be repetitively (and automatically) initiated based on the Customer's 2025 required frequency. This results in a Predefined Logical Product being created for the Customer. However, Customized Logical Products are created for all Solutions, even when no changes are made to a Predefined Logical Product(s).

Party Role Product Class is read to obtain the Product Classes associated with a particular Market Manager 2010. The Customer 2025 creates product needs within the context of a Market Manager's 2010 market.

Product Class Relationship is read to drill down within a hierarchy of Product Classes until the Product Class that a Customized Logical Product is to be defined within is obtained.

Product Class Product Attribute Value is read to obtain the Product Attributes, and their values, associated with a “leaf level” Product Class.

Product is created from a “leaf level” Product Class and/or a Predefined Logical Product (within the product class) to represent the Customer's 2025 need.

Product Class Role is read to obtain the primary “Accountable” Role for the Product Class to associate to the product via Role Product.

Party Role Product is created to link the Customer 2025 and their “Pending” Customized Logical Product. Also, a link is created between a User 2055 (acting on behalf of the Customer) and the “Pending” Customized Logical Product.

Product Product Attribute Value instances are created to link “dynamic” attribute value pairs to the Customer's 2025 “Pending” Customized Logical Product. Product Relationship is created, if applicable, to link the Customer's 2025 “Pending” Customized Logical Product and the Predefined Logical Product it was created from.

At Select Physical Product from Catalog 610 a “physical” product (SKU) is selected from a product catalog, based on search results.

Product is created as a “stub” product within the BVN™ system that represents the physical product selected from a product catalog. An internal Product ID is assigned to the physical product with a cross-reference to the external Product ID.

Party Role Product is created to link the Customer's 2025 Party Role ID to the (physical) Product.

At Specify Product Catalog Filters 612 search criteria are entered to retrieve products that meet desired criteria.

Product Attribute and Product Attribute Value instances are read for a given Product Class so that search criteria can be constructed.

At Search Product Catalog/Return Results 614 product catalog search results are reviewed to determine desirability.

Product Catalog items are read so that they can be reviewed.

At Reserve Physical Products 616 products are selected from a product catalog.

Creates “customized” versions of selected catalog products and links them to the customer, via Party Role Product.

At Accept Predefined Physical Product Terms 618 acceptance of the off-the-shelf terms associated with the purchase of a product from a catalog as-is.

Agreement Specification for the product terms is linked to the specific product to represent term acceptance.

Create Customized Physical Product Terms 620 solution-specific product terms are created to override standard product terms for a catalog product.

Agreement Specification is read to obtain the template terms to create a specific “custom” agreement to link to the product.

At Create Customer Needs Solution 625, the creation of a Solution which serves the purpose of “bundling” the Customer's Customized Logical Products and/or physical products (selected from a product catalog) that can be traded within the Trading Markets. Also, all appropriate Parties (within their respective Roles) are linked to the Solution, for example, the Customer 2025, Solution Broker 2030, Customer Manager 2020, and Customer Referral Provider 2035 (if applicable).

The logical Solution must take all aspects of the Customer's 2025 needs into account including product-related location information (e.g., “bill to” and “ship to” address); time, cost, and quality requirements; and compatibility issues (i.e., making sure the components of a Solution work together).

Party Role Product is read to obtain Customized Logical Products previously created by the Customer 2025 so they can be bundled into a Solution.

A “Customer Needs” Solution is created to serve as the collection vehicle for all the Customer's 2025 selected Customized Logical Products.

Party Role Solution is created to link the Customer 2025 and Customer Manager 2020 to the Solution. Also, links the Customer Referral Provider 2035, if necessary.

Solution Product is created to link the Solution to the Customer's Customized Logical Products (that were created based on the Customer's 2025 needs).

Product Location is created to link a product to a location—e.g., to indicate “bill to” and “ship to” address for the product, if required.

At Create Product Trading Market Assignment 630, the Customer 2025 determines the specific market within which their product need(s) is to be traded. A product need can be placed in more than one market. The Customer 2025 specifies which of the Trading markets he/she would like to utilize in obtaining Solutions to their needs. The types of trading markets are posting, searching, and negotiation.

Using Posting, a Customer 2025 can have a Solution Broker 2030 “post'their needs to the general Service Provider 2045 population within the BVN, with or without the price that they are willing to pay for the meeting of those needs. If the Customer 2025 posts needs with a price, any Service Provider 2045 can accept the Customer's 2025 offer. It is also at the Customer's 2025 discretion as to whether they want the ability to choose amongst Service Providers 2045 who have accepted the offer or have the deal automatically ” bound” with the first Service Provider 2045 to accept the offer. If the Customer 2025 posts needs without a price, any Service Provider 2045 can respond with their offer, which the Customer 2025 can accept or reject.

Using Searching, a Customer 2025 can request the Solution Broker 2030 to scan the Service Providers 2045′ posted “current market” prices for their needs, which the Customer 2025 can then accept or reject, in part or in total (if multiple needs were identified). This “searching” may also be done automatically by “intelligent agents” which scan the Service Provider Trading Commodity “Postings”, or specific web-sites, for current prices.

Using Negotiation, a Customer 2025 can bid on products or services offered by Service Providers 2045 or can request bids on their needs from the Solution Broker's 2030 specific network of Service Providers 2045 (as opposed to open posting for any Service Providers 2045 to bid).

Each Trading Market to be used for the trading of a Logical Product can have special parameters set to expedite the Trading and Solution Assembly processes.

Solution Product is read to identify the Customized Logical Products that are associated to a Solution.

Role Product is read to obtain the Role ID for a Customized Logical Product as a initial step to Identifying Trading Markets for these instances.

Role Product Trading Market has instances created, in “not submitted” status, that identify the assigned Trading Markets within which a Role Product pair is to be traded. Products are updated to “ready to be traded” status.

At Notify Solution Broker of Solution for Review/Approval 635, a Customer, after configuring the solution and selecting the trading markets, can request that a Solution Broker 2030 review the Solution prior to submitting it to trading. A Solution Broker 2030 is notified that a Solution is ready for review. This is an optional activity, since the Customer 2025 may choose to submit the Solution directly to the Trading Markets.

A “Solution Review/Approval Notification” Communication Item is created and linked to the Solution Broker 2030 (receiver) and the Customer Manager 2020 (sender), via Party Role Communication Item.

Role Product Trading Market is updated to indicate that a Customer 2025 has submitted this instance to a Solution Broker 2030 for Review & Approval, via setting the status to “Submitted for Review/Approval”.

At Evaluate Customer Logical Product Needs 640, the Solution Broker 2030 reviews the Solution submitted by the Customer 2025 for review. The Customer 2025 has decided to take advantage of the expertise of the Solution Broker 2030. There is likely a fee associated with the review. The manner in which the fee is assessed is determined within the BVN, by the Customer Manager 2020. The Solution Broker 2030 commits to a service level agreement. The Solution Broker 2030 can approve and send the Solution off to the trading markets or the Solution Broker 2030 can provide suggestions back to the Customer 2025 for consideration. If approved the Customer 2025 is notified of the results.

When the Solution Broker 2030 reviews the submitted Solution, he or she may find a ‘problem’ and the Solution Broker 2030 must inform the Customer 2025 of a foreseen difficulty before proceeding.

Product and Product Product Attribute Value are read to read to obtain Product information that expresses the Customer's 2025 needs.

Role Product Trading Market is updated to indicate that a Solution Broker 2030 has reviewed this instance and either approved the instance or returned it to the Customer 2025 for reconsideration. The status is set to Approved, if the solution passes the Solution Broker's review, or Returned, if the solution does not pass the Solution Broker's review and improvement suggestions are provided to the Customer.

At Notify Customer of Solution Review/Approval Results 645, the Customer 2025 is notified of the results of a review of their “Customer Needs” Solution. The results may be Approved, Provide Alternatives to Customer or Error.

A “Solution Review/Approval Results Notification” Communication Item is created and linked to the Customer 2025 (receiver) and the Customer Manager 2020 (sender), via Party Role Communication Item.

At Submit Products to Trading Markets by Role 650, the Customer 2025 releases their “bundled” product needs to the Trading Markets for trading, which causes appropriate state changes to relevant solution/product data.

Solution is updated to “Submitted for trading” status.

Solution Product is read to obtain the products bundled within the Solution that is to be traded so that their status can be updated to “Ready to be traded”.

Role Product Trading Market instances have their status updated to “Submitted for Trading”.

At Retrieve Non-Core Logical Products From Business Value Network 655, Logical Products that are non-core to the BVN™ system, or core to the BVN™ system, but are also configured to be traded externally within another network are forwarded to a Market Manager 2010 within the appropriate external BVN™ system or to an external network (non-BVN) for trading.

Product Class Product is read to obtain the “non-core” or externally traded “core” product's product class.

BVN™ system Product Class is read to obtain the BVN™ system within which the product class of the non-core product is “core”.

Party Role Product Class Party Role BVN™ is read to determine if the Market Manager 2010 has a pre-established relationship with a Market Manager 2010 from the external B N system for the routing of non-core products within a specific product class.

Party Role Business Value Network is read to obtain a marketing network from the external BVN™ system to route the non-core product to when a pre-established relationship between marketing networks within the different BVNs does not exist.

Party Role Product is created to link the external BVN's market manager's Party Role instance to the non-core logical product to indicate the external BVN™ system within which it is being externally traded.

At Record Solution Payment Method 660, the Customer 2025 selects the desired method of payment for the Solution (which may or may not be their previously selected “default” l payment method). If no selection is made, the Customer's 2025 default payment method (indicated when the Customer 2025 initially provided basic information to the Marketing Network) will be used automatically.

If the Customer's 2025 payment method options were limited when selecting a default method (due to poor credit history) those same restrictions apply when selecting a Solution payment method.

Depending on the payment method that was selected, associated fees may apply.

Party Role Solution is read to obtain the Customer's 2025 target Solution.

Party Role Account is read to obtain the Accounts available for usage by a Customer 2025 to pay for Solutions.

Solution Account is created to link a Customer's Solution and the Account to be used to pay for the Solution.

Creates a link between the Solution and an actual solution payment method selection Event instance.

At Create Product Role Assignments 665, if some Roles associated with the delivery of a Product will be “kept” (self-performed), rather than traded within the trading markets, then those Roles must be “selected” so they are not forwarded to the trading markets (coupled with their corresponding Products). Those Roles that are not kept by the Customer 2025 are linked to their respective (Customized Logical) Products for submission to the trading markets. This process may include the decomposing of Roles into lower-level Roles that can be traded or selected (kept).

Standard Solution-level Roles are also created-i.e., Customer Manager 2020, Solution Broker 2030 (can be the party acting as the Customer 2025 if they so choose), and BVN™ Manager 2005-by linking them to the Solution.

Party Role Solution is created to link the Customer 2025 to the Solution in any solution-level Roles they will be fulfilling (primarily, and possibly only, Solution Broker 2030). If the Customer 2025 does not opt to serve as their own Solution Broker 2030, then a Solution Broker 2030 from the Customer Manager 2020 is assigned/selected.

Product Class Role is read to obtain the Roles associated with a Product Class so the required Roles can be displayed to the Customer 2025 to let them make their “keep vs. trade” decision.

Party Role Product is created to link the Customer 2025 to any Products they will be acting within a specific “Service Provider 2045” Role for.

Role Product is created, if applicable, to link the “decomposed” Roles that are to be fulfilled through the Trading Markets (i.e., not kept by the Customer) to the Customer's Customized Logical Products.

Product has its (their) status updated to “Kept by Customer” (if assigned a Role via Role Product). Note: If a Customer's Customized Logical Product is “Kept by Customer” the product will NOT be traded within the Trading Markets.

At Create Solution Service Provider Filters 670, the creation of criteria that limits the availability of Customer Logical Product needs to Service Providers 2045 within the Trading Markets for a solution.

Role Attribute and Role Attribute Value are read to obtain Attributes and their Values that can be applied against a Role Product instance to limit trading availability to Service Providers 2045.

Role Product is read to obtain the Role (Customized Logical) Product instance that will be linked to Role Attribute Values to limit trading availability to Service Providers 2045.

Role Product Role Attribute Value is created to represent service provider filters to be applied to a role product pair.

Party Role Product can be created to represent a filter of a specific Service Provider(s) to have the product need offered to.

At Assign Consumer to Customer Group Purchase 675, BVN™ system Customers 2025 are assigned to Customer Group “group” purchases (in the Role of “Consumer”) to facilitate the trading of a bulk Logical Product. It is anticipated that Customers 2025 will receive better pricing when they participate in group purchasing due to the potential for volume discounts from Service Providers 2045.

Solution Product is read to obtain the Solution that was previously linked to the Customized Logical Product being offered to Customers 2025 within a Customer Group.

Party Role Solution is created to link the individual Customer 2025 to the (Customer Group) Solution in the Role of “Consumer”.

Product is updated to increment the “quantity” each time a consumer agrees to participate in the group purchase.

At Specify Consumer Information for Customer Group Purchase 680, the specification of additional information by Consumers (individual participants in a Customer Group purchase) required for the Customer Group purchase.

Role Product is read to obtain the target product.

Additional product information is captured, such as Product Location to link a Customer Group's Customized Logical Product and the individual Consumer Locations that the product needs to be delivered to/provided for.

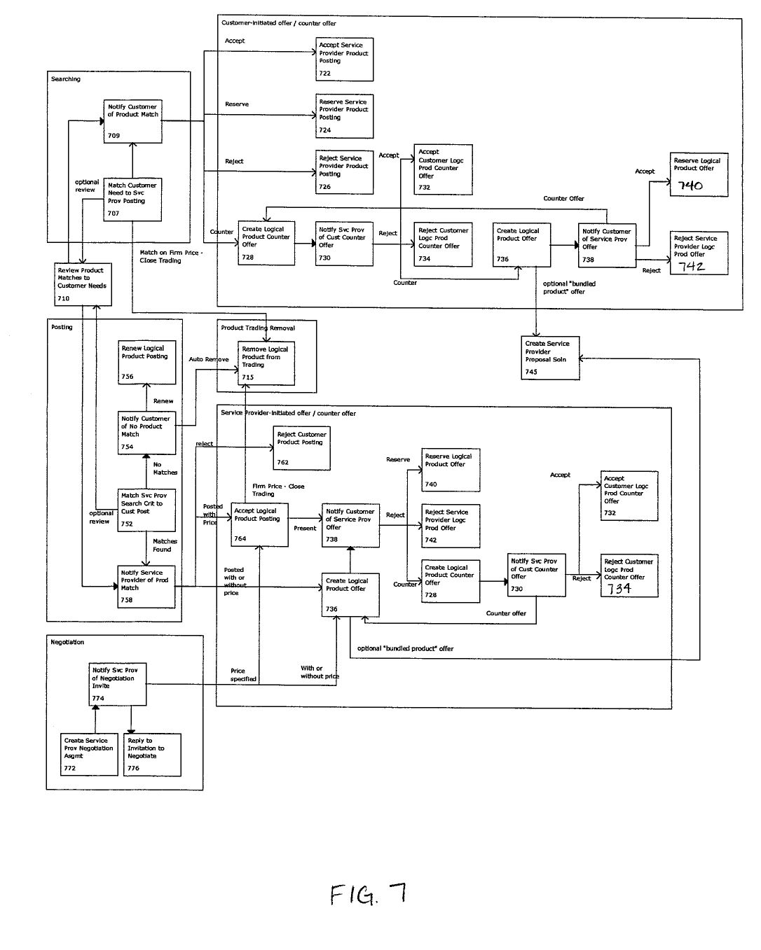

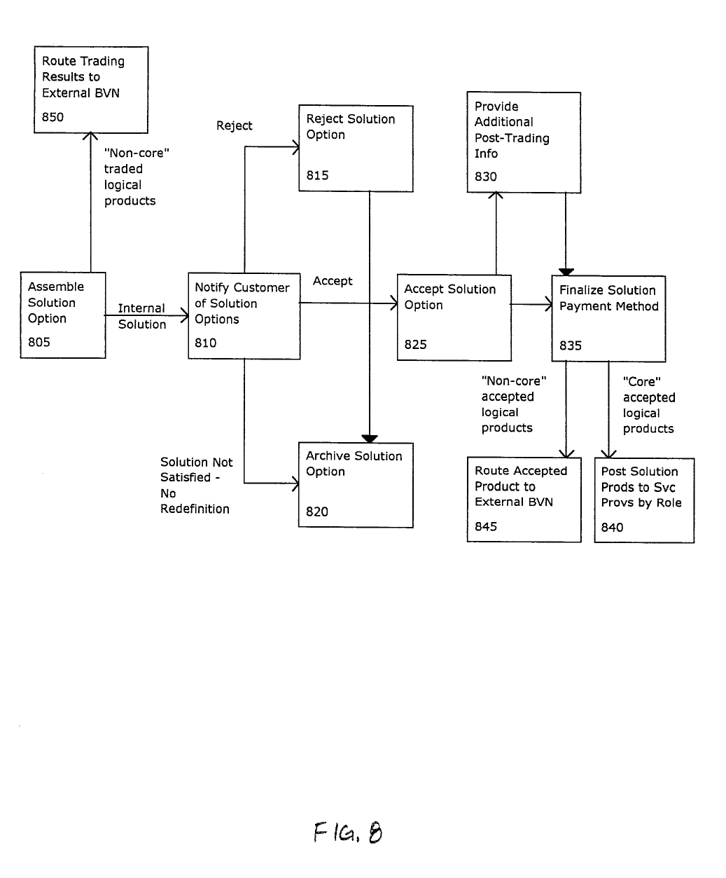

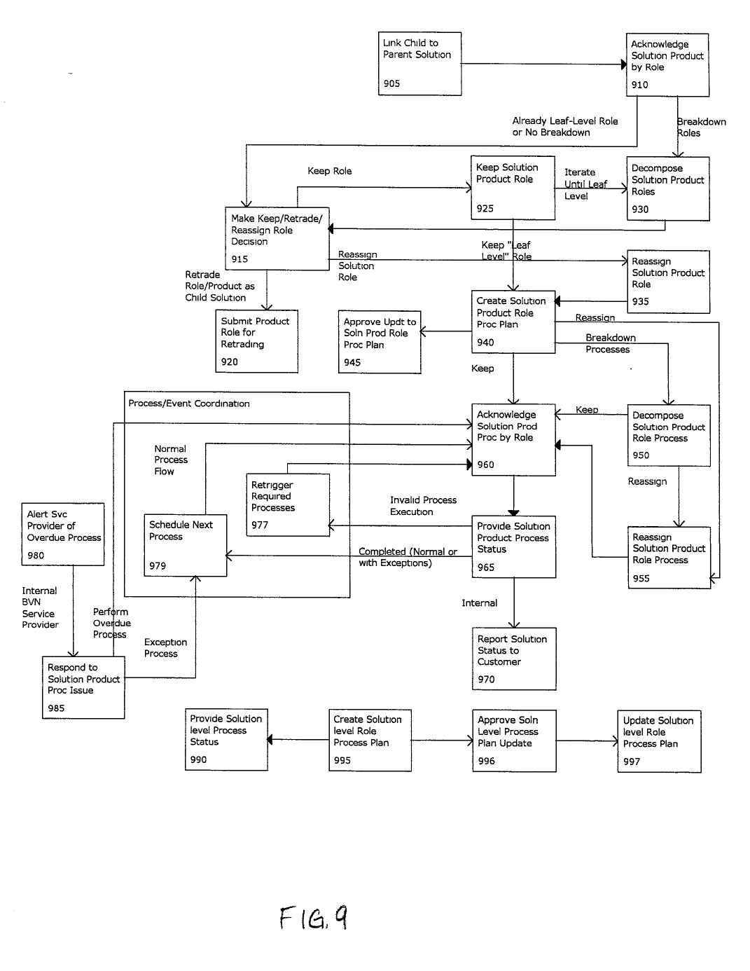

Referring to FIG. 7, Product/Service Trading 700 includes the processes required to offer, negotiate, and reach (or reserve for later) acceptance of the Products/Services to be delivered as part of a Solution for a Customer 2025 based on their “logical” needs.

A unique feature of the BVN™ system Trading Markets is that all trading is based on the Roles that Service Providers 2045 can play within an industry-specific BVN™ system. Specifically, when a product/service is “submitted” for trading, it is actually submitted as a Role/Product pair. Depending on the sophistication of the Customer 2025 and/or industry, the Customer 2025 may or may not even be aware that they are involved in Role-based trading.

The three types of “Trading Markets” available within a BVN™ system are noted above.

Regardless of the Trading Market(s) used by a Customer 2025, the Customer 2025 can enter into individual trading sessions with multiple Service Providers 2045. These trading sessions provide for an unlimited number of offers/counter offers between Customer 2025 and Service Provider 2045 in trying to agree on the terms surrounding the inclusion of a product within the Customer's 2025 final Solution.

Another unique feature of the BVN™ system Trading Markets is the spectrum of variables available to Customers 2025 and Service Providers 2045 in configuring offers/counter offers within a trading session.

At Match Customer Need to Service Provider Posting 707, the creation of associations (matches) between a Service Provider's 2045 posted “Predefined” Logical Product offers and a Customer's “Customized” Logical Product needs, based on the matching of criteria such as roles, product classes, product characteristics, price, delivery timeframes, etc. These product matches take place within the “Searching” Trading Market.

Customers 2025 are informed of '“matches” between their product needs and Service Provider 2045 product postings. Thus, it is the Customers 2025 who initiate contact with Service Providers 2045, via an offer, within the “Searching” Trading Market.

Solution Product is read to obtain the Customer's Customized Logical Products linked to the Solution.

Role Product is read to obtain the Role that was linked to the Customer's Customized Logical Products to for trading. This Role will be used to match against the Roles associated used with Service Provider Product Postings. This is the first pass of narrowing potential matches between Customer 2025 and Service Provider 2045 products.

Creates a Service Provider's Customized Logical Product to be matched against the Customer's 2025 product need. The Customer's Customized Logical Product is set to matched status.

Product Relationship is created to link the Customer's Customized Logical Products to the offered Service Provider Customized Logical Products so that they may be presented to the Customer and link the Service Provider's Predefined Logical Product (posting) and their customized version.

At Notify Customer of Product Match 709, the Solution Broker 2030 presents the closest matches to a Customer's 2025 requested (unfirm) price or the best postings available, based on the Customer's 2025 logical needs, if no price was specified.

Creates a “Product Match Notification” Communication Item and a link between the Customer 2025 (receiver) and the Customer Manager 2020 (sender) to the Communication Item, via Party Role Communication Item.

At Review Product Matches to Customer Needs 710, the review of product “matches” subsequent to the matching of Service Provider 2045 product search criteria to a Customer's 2025 logical product needs (postings). The “best candidates” can be flagged for presentation to the Customer, while the less attractive matches can be discarded.

Appropriate Product Relationship instances are updated to expire product matches that are not to be presented to the Customer.

At Remove Logical Product from Trading 715, a Customer's Logical Product is removed from the required Trading Market after a specified amount of time, the Customer 2025 “accepts” a Service Provider's product offer (which means that offer will be part of the Customer's final Solution), an “auto close” deal has occurred in another Trading Market, the Customer 2025 “accepts” a Solution Option, which includes the product (which means that product will be part of the Customer's final Solution), or manual initiation by the Customer 2025 at any time prior to accepting a solution option.

The status of the applicable Customer 2025 product need is set to “removed”.

All Role Product Trading Sessions related to the applicable Customer 2025 product need, which is obtained via Product Relationship, are set to “closed” status.

At Accept Service Provider Product Posting 722, the Customer 2025 accepts a Service Provider's Logical Product posting as is. This accepting of a Service Provider 2045 offer means the Customer 2025 formally agrees to include this product offer in their final Solution.

This process also stops trading of the Customer's product need within the trading markets.

Product Relationship is read to obtain the Service Provider's product offer on the Customer's product need.

The Service Provider's product offer is updated to “accepted” status.

At Reserve Service Provider Product Posting 724, the Customer 2025 reserves a Service Provider's Logical Product posting presented by the Solution Broker 2030. This process occurs when the Customer's logical needs do not specify a “firm” (non-negotiable) price that they are willing to pay.

This process is performed after the Customer 2025 has an opportunity to view the Service Provider's 2045 product offer (either an initial posting or after a counter offer). This process will not stop trading of the same logical need in this or other markets.

Product Relationship is read to obtain the Service Provider's “offered” Customized Logical Product(s) linked to the Customer's Customized Logical Product.

The Service Provider's Customized Logical Product is updated to set the status to “reserved”.

At Reject Service Provider Product Posting 726, a Service Provider's Logical Product, which represents one of the closest available matches to the Customer's Logical Product need, is rejected. This implies that a counter offer will not be made.

This process is performed after the Customer 2025 has an opportunity to view the Service Provider's product offer (either an initial posting or after a counter offer). This process will not stop trading of the same logical need in this or other markets.

Product Relationship is read to obtain Service Provider 2045 customized products offers to the Customer's product need (i.e., two Customized Logical Products linked to each other with an “offers on” Relationship Name attribute value).

Updates the Service Provider's customized product offer to “rejected”.

When in the “Negotiation” or “Posting” Trading Markets, after receiving a Service Provider Product offer for a given product need, t Create Logical Product Counter Offer 728 the Customer 2025 creates a counter offer to that specific Service Provider 2045 offer.

If in the “Searching” Trading Market, after receiving “matching” product offers from Service Providers 2045 for a given product need, the Customer 2025 creates a counter offer to a specific Service Provider 2045 offer.

Creates a new Role Product Trading Session for the “Searching” trading market, when the Customer 2025 counter offer is on an initial Service Provider 2045 “predefined” offer.

Otherwise, Reads a previously created Role Product Trading Session for the “Negotiation”, “Posting” or “Searching” trading market.

If not previously created, creates a link of the Customer 2025 and Service Provider 2045 to the Role Product Trading Session, via Party Role Role Product Trading Session, to establish the facility for creation of counter offers.

Product Relationship is read to obtain the Service Provider 2045 product offers on a Customer 2025 product need.

Product Relationship with a relationship name of “counter offer on” is created between the Customer's 2025 product counter offer and either the Service Provider's predefined or customized product offer (depending on the circumstance).

At Notify Service Provider of Customer Counter Offer 730, the Service Provider 2045 is informed of a Customer's 2025 counter offer to their previous logical product offer within one of the Trading Markets.

Creates a (Customer) “Product Counter Offer Notification” Communication Item and a link between the Service Provider 2045 (receiver) and the Customer Manager 2020 (sender) to the Communication Item, via Party Role Communication Item.

At Accept Customer Logical Product Counter Offer 732, a Service Provider 2045 accepts a Customer's 2025 counter offer on the Service Provider's original offer on the Customer's “Customized” Logical Product posting. This process automatically “reserves” the Service Provider's product offer for the Customer 2025 for later review.

Product Relationship is read to obtain the Customer's Product “Counter Offer” on the Service Provider's Product “Offer”.

The applicable Role Product Trading Session, obtained via Party Role Role Product Trading Session, is set to “closed” status.

A “clone” of the Customer's “accepted” product counter offer is created for the Service Provider 2045 and set to “reserved” status.

The Customer's 2025 product counter offer is set to “matched” status.

At Reject Customer Logical Product Counter Offer 734, a Service Provider 2045 can reject a Customer's 2025 counter offer on the Service Provider's original offer on a Customer 2025 posting. This “closes” the specific Trading Session between the Customer 2025 and Service Provider 2045.

The Customer's 2025 product counter offer is set to “rejected” status, which is obtained via the Product Relationship linked to the appropriate Role Product Trading Session.

The applicable Role Product Trading Session is set to “Closed”-no more trading within this session.

At Create Logical Product Offer 736, the creation of a logical product offer or counter offer by a Service Provider 2045 to a Customer's 2025 original logical product need or a Customer's 2025 counter offer to a Service Provider's product offer.

Read to obtain the Service Provider's Predefined Logical Product that was matched to a Customer's Customized Logical Product posting (in Product Relationship).

Creates a Service Provider's Customized Logical Product in “offered” status, so an offer can be made to the Customer 2025 (based on the Service Provider 2045 providing an offer on the Customer's 2025 product).

Updates the Customer's Customized Logical Product to “matched” Status.

Role Product is read to obtain the Role assigned to the Customer 2025 Customized Logical Product for trading purposes, so that the appropriate trading session can be created or retrieved.

If required, creates a Role Product Trading Session based on the Service Provider's creation of a product counter offer to the Customer's 2025 product need.

Otherwise, Reads a previously created Role Product Trading Session for the “Posting” or “Searching” trading market.

Product Relationship is read to obtain the link between the Service Provider's Predefined Logical Product and the Customer's 2025 “Matched” Customized Logical Product.

Product Relationships are created to link the Service Provider's newly created “offered” Customized Logical Product and the Customer's 2025 “matched” Customized Logical Product (“counter offer on” relationship name), the Service Provider's newly created “offered” Customized Logical Product and the original “Customer Needs” Customized Logical Product (“current offer for” relationship name), and the Service Provider's newly created “offered” Customized Logical Product and their Predefined Logical Product from which it was created (“created from” relationship name).

Creates a link between the Service Provider 2045 and Customer 2025 to the Role Product Trading Session, if required, via Party Role Role Product Trading Session.

Otherwise (if necessary), Reads previously created Party Role Role Product Trading Session instances to verify that the Customer 2025 and Service Provider 2045 are linked to the trading session.

At Notify Customer of Service Provider Offer 738, the Customer 2025 is notified that a logical product offer against one of their product needs has been created by a Service Provider 2045. The offer could have been generated from any of the three Trading markets: Posting, Searching, or Negotiation.

Creates a “Product Offer Notification” Communication Item and a link between the Customer 2025 (receiver) and the Customer Manager 2020 (sender) to the Communication Item, via Party Role Communication Item.

At Reserve Logical Product Offer 740, the Customer 2025 reserves one of the Service Provider 2045 offers (or counter offers) on one of their “Logical Product” needs within one of the Trading Markets for later review.

Product Relationship is read to obtain Service Provider 2045 product “offers” linked to a Customer's 2025 product “need”.

The statuses of the Customer's 2025 Product “need” and Service Provider's Product “offer” are updated based on the “reservation” of the offer. The Service Provider's product status is set to “reserved”, and the Customer's 2025 product status is set to “matched”.

At Reject Service Provider Logical Product Offer 742, the Customer 2025 rejects a Service Provider 2045 offer on one of their “Logical Product” needs within one of the Trading Markets. This “closes” the specific Trading Session between the Customer 2025 and Service Provider 2045.

Solution Product is read to obtain Products within a selected Solution for the Customer.

Product Relationship is read to obtain Service Provider 2045 product “offers” linked to a Customer's 2025 product “need”.

The Service Provider's product “offer” is set to “rejected” status, which is obtained via the Product Relationship linked to the appropriate Role Product Trading Session

The applicable Role Product Trading Session is set to “closed”, if the last or only offer within the trading session has been “rejected”.

At Create Service Provider Proposal Solution 745, a “Service Provider Proposal” type of Solution is created to provide a “bundled” offer on two or more of a Customer's 2025 logical product needs as a unit. The proposal offer is only valid if all the products within the proposal are accepted by the Customer 2025. The Service Provider's Proposal Solution may encompass products for a Customer 2025 that span multiple Customer Needs Solutions for that Customer 2025.

Solution Product is read to obtain the Customer's 2025 products linked to their “Customer Needs” type of Solution.

Creates a “Service Provider Proposal” type of Solution for the Service Provider 2045.

Solution Product instances are created to link between the Service Provider's Customized Logical Products, that were previously linked to the Customer's 2025 product needs (via Product Relationship, in the “Create Logical Product Offer” Process), and their “Service Provider Proposal” type of Solution.

At Match Service Provider Search Criteria to Customer Posting 752, the creation of associations (matches) between a Customer's 2025 posted “Customized” Logical Product needs and Service Providers 2045'“Predefined” Logical Product search criteria, based on the matching of criteria such as roles, product classes, product characteristics, price, delivery timeframes, etc. These product matches take place within the “Posting” Trading Market.

Service Providers 2045 are informed of “matches” between their product search criteria and Customer 2025 product postings. Thus, it is the Service Providers 2045 who initiate contact with Customers 2025, via an offer, within the “Posting” Trading Market.

Solution Product is read to obtain the Customer's Customized Logical Products linked to their Solution.

Role Product is read to obtain the Role that was linked to the Customer's Customized Logical Products to for trading. This Role will be used to match against the Roles associated used with Service Provider Product Search Criteria. This is the 1st pass of narrowing potential “matches” between Customer 2025 and Service Provider 2045 products.

Creates a Service Provider's Customized Logical Product to be matched against the Customer's 2025 (if an “Auto Close” or “Auto Reserve” match was found for the product).

The Customer 2025 products are set to “matched” in “Auto Close” or “Auto Reserve” scenarios.

Product Relationship is created to link the Customer's Customized Logical Products to the “matching” (or nearly matching) Service Provider Logical Products so that they may be presented to the Service Provider 2045.

At Notify Customer of No Product Match/Inform Customer of No Service Provider Response 754, the Solution Broker 2030 informs the Customer 2025 that no Service Providers 2045 have responded to the Customer's 2025 posting after a specified amount of time.

This process also applies to a “Negotiation” trade where the Customer 2025 provides a firm price that is not accepted by any Service Providers 2045.

Creates a “No Product Match Notification” Communication Item and a link between the Customer 2025 (receiver) and the Customer Manager 2020 (sender) to the Communication Item, via Party Role Communication Item.

At Renew Logical Product Posting 756, the Customer 2025 can “renew” the posting to the network for a fee if an initial posting has no responses from a Service Provider 2045 within a specified amount of time.

The Role Product Trading Market instance for the applicable Customer 2025 product need in the “Posting” Trading Market has its Trading End Date updated to increase the “Posting” time.

At Notify Service Provider of Product Match 758, a Service Provider 2045 is informed when their product selection criteria matches product needs posted by Customers 2025.

Creates a “Product Match Notification” Communication Item and a link between the Service Provider 2045 (receiver) and the Customer Manager 2020 (sender) to the Communication Item, via Party Role Communication Item.

At Reject Customer Product Posting 762, the Service Provider 2045 declines to make an offer to a Customer 2025 based on a match between the Customer's 2025 product need and the Service Provider's product search criteria.

This process actually deletes the relationship between the Customer's 2025 product need and Service Provider's search criteria that was created during the “Posting” trading market's product matching process.

The Product Relationship between the Customer's Customized Logical Product need and the Service Provider's Predefined Logical Product (search criteria) is deleted.

At Accept Logical Product Posting 764, a Service Provider 2045 accepts the Customer's 2025 desired price for a Logical Product (trading commodity) as-is. This price may have been specified as firm or negotiable.

If the price was specified as firm, a Service Provider's acceptance of the Logical Product will automatically “legally bind” the deal.

If the price was specified as negotiable, the Customer 2025 will have the right to choose amongst other Service Providers 2045 who accepted the Customer's 2025 offer or to refuse the offer(s).

This process occurs within both the Posting and Negotiation trading markets.

The Service Provider's Predefined Logical Product that was matched to a Customer's Customized Logical Product posting (in Product Relationship) is obtained.

A Customized Logical Product is created for the Service Provider 2045 in “offered” status, so an offer can be made to the Customer 2025 (based on the Service Provider 2045 accepting the Customer's 2025 product's price as-is).

The Customer's 2025 product is set to “matched” status.

Product Relationship instances are created to link the Service Provider's newly created “offered” Customized Logical Product and the Customer's 2025 “matched” Customized Logical Product and the Service Provider's newly created “offered” Customized Logical Product and their Predefined Logical Product from which it was created.

At Create Service Provider Negotiation Assignment 772, the selection of a Service Provider 2045 to participate in a Negotiation Session with a Customer 2025 for one of their logical product needs.

Party Role Product is created, in “invited” status, when a Solution Broker 2030 invites a Service Provider 2045 to participate in a product negotiation.

Notify Service Provider of Negotiation Invite 774 is an invitation to a Service Provider 2045 to participate in a “Negotiation” trading market session with a Customer 2025 for one of their “logical” product needs.

Creates a “Product Negotiation Notification” Communication Item and a link between the Service Provider 2045 (receiver) and the Customer Manager 2020 (sender) to the Communication Item, via Party Role Communication Item.

At Reply to Invitation to Negotiate 776, a Service Provider 2045 replies to an invitation to negotiate with a Customer 2025 for one of their product needs.

The Party Role Product for the Service Provider 2045 linked to a Customer 2025 product need, which they are responding to an invitation for, has its status set to either ‘accepted’or ‘declined’(depending on whether the Service Provider 2045 wishes to negotiate or not).

FIG. 8 provides an overview of Solution Assembly 800. BVN™ system Solution Assembly involves those processes required to accumulate the results of the Trading Markets for a given Customer's Solution's Product needs, including ensuring compatibility of the assembled Service Provider 2045 product offers. Solution Assembly 800 also includes processes to obtain acceptance of the proposed Solution or selection of the desired Solution (if options were provided) from the Customer and to inform the Service Providers 2045 who accepted responsibility for delivery of a trading commodity within the Trading Markets of the final status for the Solution.

At Assemble Solution Option 805, the Logical Products from the Trading Markets, accepted or selected for further consideration by the Customer 2025, are analyzed for compatibility and packaged into feasible Solution options for presentation and evaluation by the Customer 2025. The defined solutions await approval by the Customer 2025. This process can be invoked repeatedly until the Customer 2025 accepts a Solution Option.

The products that are traded for a Solution may have inherent requirements for “fitting together”. Therefore, it is imperative that the traded products be bundled into valid combinations before being presented to the Customer.

Assembly includes checking the status on the Logical Products to ensure they are to be presented to the Customer 2025 as valid options within a solution.

The configuration of the Solution to the Customer 2025 includes adding in the Solution Broker's 2030 commission and BVN™ system administrative fees (e.g., billing, etc.) so that the “total cost” of the Solution is known to the Customer.

Customers 2025 can specify that one solution be created or that alternatives are prepared for presentation (these are “solution option” types of solutions).

Party Role Solution is read to obtain the Customer's 2025 “Customer Needs” Solution.

“Solution Option” Solution instances may be created, in “assembled” status, that package the product trading results into viable Solution alternatives.

Party Role Solution is created to link the Solution Broker 2030 to the “Solution Option” Solutions with a relationship of “presents”.

Solution Product is read to obtain the Customer's 2025 “Customer Needs” Solution's associated Customized Logical Products.

Solution Product instances are created to link the alternative “Solution Option” Solutions to the accepted Products.

Solution Relationship instances, with relationship name of “option-need”, are created to link the Customer's 2025 original “Customer Needs” Solution to the Solution Broker's 2030 “Solution Option” Solution(s)

At Notify Customer of Solution Options 810, the Customer 2025 is informed of the Solution options that are available as a result of the trading of their Logical Products within the Trading markets and is requested to take action.

If the Customer 2025 did not make any up front purchase commitments and all the Solution's Logical Products were accepted by Service Providers 2045, the Customer 2025 will have the choice of whether or not to accept the Solution and proceed with the 25 Solution delivery phase. Partial Solutions can be presented if not all of the Customer's 2025 product needs were satisfied during trading.

If the Customer 2025 decides not to accept any Solution, they will be archived and the Solution delivery phase will not commence.

If archived, the Solution will be retrievable by the Customer 2025 for a specified amount of time before being purged. The presentation of the Solution to the Customer 2025 includes adding in the Solution Broker's 2030 commission and BVN™ system administrative fees so the Customer 2025 knows the total cost of the Solution.

Creates a “Solution Option Notification” Communication Item (to be sent to the Customer), which is linked to the Customer 2025 (receiver) and the Customer Manager 2020 (sender), via Party Role Communication Item.

At Reject Solution Option 815, the Customer 2025 rejects a configured “Solution Option” type of Solution. Several solution options may have been pre-configured and made available to the Customer 2025, of which only one can be accepted, to proceed to solution delivery.

A given “Solution Option” type of Solution, linked to the Customer 2025 via Party Role Solution, is updated to set the status to “rejected”.

At Archive Solution Option 820, all “Solution Options” that are not “accepted” by a Customer 2025 are “archived” for a specified amount of time before being purged. During this time, the Solution will be retrievable by the Customer.

The Solution is updated to set the status to “archived”.

At Accept Solution Option 825, the Customer 2025 accepts the configured Solution “option”, based on assembly of the Trading market results, so the Solution Delivery phase can commence.

If an automatic closing of the deal occurred (due to a Customer's 2025 firm price being accepted by a Service Provider 2045), the solution is automatically set to “accepted”.

If the Customer 2025 did not make any up front purchase commitments (i.e., via firm price option) and all the Solution's Products were NOT accepted by Service Providers 2045, the Customer 2025 can accept the partial Solution (if feasible).

This triggers the removal of all of the Customer's 2025 product needs from trading via the “Remove Customer Logical Product from Trading” EBP.

Party Role Solution instances are created to link the Customer 2025 to the applicable “Solution Option” Solution with a relationship of “accepted”.

The applicable “Solution Option” Solution is updated to set status to “accepted”.

Solution Product is read to obtain all Customized Logical Products linked to the Solution so their status can be updated (set) to “accepted”.

Provide Additional Post-Trading Information 830 captures information required for Solution Delivery. Additional detailed information may need to be provided to enable Solution delivery after the desired “Solution Option” Solution has been accepted.

Solution Product is read to obtain the products within the Customer's 2025 “Solution Option” Solution so that additional characteristics can be provided, if desired, via Product Product Attribute Value. In addition, “delivery” Locations may be created and linked to appropriate Products within the Solution via Product Location.

At Finalize Solution Payment Method 83S, the Customer 2025 finalizes the desired method of payment for the Solution (which may or may not be their previously selected, or “default”, payment method for this solution).

If the Customer's 2025 payment method options were limited when selecting a default method (due to poor credit history) those same restrictions apply when selecting a Solution payment method. If the Customer 2025 changes the payment method, default credits or fees will apply.

The Customer's 2025 desired Account to use for payment is obtained and linked to the Solution via Solution Account. A previously created Solution Account instance may be expired.

At Post Solution Products to Service Providers by Role 840, the Solution Products are formally “posted” to the Service Providers 2045 within their respective Roles as dictated by the Products and/or Services encompassed within the Customer's 2025 “accepted” “Solution Option” Solution. This signifies that Solution delivery, by the assigned Service Providers 2045, can begin.

The Process/Event Coordinator 5011 application is responsible for tracking the occurrence of Events within the Solution delivery life cycle and the subsequent initiation of dependent Processes.

Solution Product is read to obtain the Service Provider Customized Logical Products linked to the “accepted” “Solution Option” Solution so that the Solution's and Products' status can be updated to “posted”, signifying that solution delivery can commence.

If non-core Products (i.e., products provided by Service Providers 2045 within another BVN™ system or external network) exist in the accepted “Solution Option,” Route Accepted Product to External BVN 845 posts the Solution to external Service Providers 2045 by Role so that solution delivery can commence.

The non-core Products within the Solution are obtained so that they can be routed to the external BVN™ system or network.

At Route Trading Results to External BVN 850, the trading results for “non-core” logical products within a Solution configured in an external BVN™ system are forwarded from the BVN™ system within which the products are part of the “core” product set.

The trading results for non-core Products are obtained from Product Relationship instances, potentially within Role Product Trading Sessions, so they can be routed to the external BVN™ system or network.

Referring to FIG. 9, the process for Solution Delivery 900 is shown. Solution Delivery Management involves the coordination of the Events and Processes (human and automated) required to deliver specific Customer Solutions. Team members, resources, and technology components must all be coordinated in order to deliver the Solution to the Customer.

The Solution Broker 2030 has overall accountability for overseeing the delivery of the Customer's 2025 Solution and keeping the Customer 2025 informed as required. It is also critical that each Service Provider 2045 inform the network of the completion (or current status) of their service execution, via the Business Value Network's 150 web-based work coordination software. This ensures as efficient a Solution delivery process as possible.

At Link Child to Parent Solution 905, a “child” Solution is linked to its “parent” Solution so that Solution delivery coordination can occur across the Solutions as required.

This situation occurs when a Service Provider 2045 simultaneously traded their potential Role/Product assignment within a “parent” Solution as a “child” Solution (to determine the offer they could make for the Role/Product within the “parent” Solution). If the “parent” Solution is accepted by the Customer, the Service Provider 2045, acting as the Customer 2025 in the “child” Solution, accepts the “child” Solution. Within this process, the parent and child Solution are linked to ensure appropriate Solution delivery.

Party Role Product is read to obtain the Service Provider's “common” product linked to the “parent” Solution (as Service Provider's Customized Logical Product).

Solution Product is read to obtain the “child” Solution linked to the “common” product (as the Customer's Customized Logical Product (i.e., the Service Provider 2045 playing the Customer 2025 in the child Solution)). Also, read to obtain the “parent” Solution linked to the “common” product (as the Service Provider's Customized Logical Product).

A Solution Relationship instance is created to link the parent and child Solutions, with a relationship name of “parent-child”.

Acknowledgement of a Role to be fulfilled in relation to the delivery of a specific Product within a “posted” “Solution Option” Solution occurs at Acknowledge Solution Product by Role 910.

Specifically, a Service Provider 2045 acknowledges receipt of the assignment to deliver a Customer's 2025 product(s) that has been awarded to them through trading and solution assembly.

The status of the Product is set to “Acknowledged”, which indicates that tracking of the time required to deliver the product should commence.

Party Role Product is read to obtain the Service Provider's Product assignments that are currently in “posted” status so that they can be updated to “acknowledged” status.

At Make Keep/Retrade/Reassign Role Decision 915, a choice must be made whether a given Role associated with a Product within a given “Solution Option” Solution will be Kept, Retraded (the Role/Product is offered to the Trading Markets), or Reassigned.

Party Role Product is read to obtain the Service Provider's product: to be delivered within a Solution to facilitate the decision making process.

At Submit Product Role for Retrading 920, a Product/Role combination is submitted back to the Solution Configuration process to be retraded within the Trading Markets.

Solution Product is read to obtain the Service Provider's Customized Logical Product that is being retraded.

Party Role Product is read to obtain the Role associated with the Service Provider's Customized Logical Product so that the Role can be linked to the Customized Logical Product for retrading. The Party Role Product instance is also updated to indicate the Service Provider 2045 as the “retrader” of their Customized Logical Product (by setting the relationship name to “retrades”).

Role Product is created to link the appropriate Role to the Service Provider's Customized Logical Product for retrading.

The product being retraded has its status updated to “submitted for retrading”.

At Keep Solution Product Role 925, the Service Provider 2045 decides to keep responsibility for the Role associated with one of their products to be delivered as part of a Customer's 2025 chosen “Solution Option” Solution.

Solution Product is read to obtain the Products within the target “Solution Option” Solution.

Party Role Product is read to obtain the Products within the target Solution that are assigned to the Service Provider 2045. The applicable Product is set to “kept” status.

At Decompose Solution Product Roles 930, the decomposition of a Role, associated with a Product to be delivered as part of an “acknowledged” “Solution Option” Solution, into lower-level Roles.

Parties assigned to “high-level” Roles remain ultimately “accountable” for delivery of the Product associated with their Role. The “low-level” Roles are responsible for Process “execution.”

Also, a Service Provider's “Execution” Role(s) and process responsibilities may be decomposed into lower-level Execution Roles and process responsibilities.

Service Providers 2045 have the option of keeping responsibility for all of their accepted Roles (and corresponding processes), retrading all or a subset of their accepted Roles within the Trading markets, or reassigning all or a subset of their accepted Roles directly to another qualified Service Provider 2045.

Solution Product is read to obtain the Products within the target “Solution Option” Solution.

Party Role Product is read to obtain the Products within the target Solution that are assigned to the Service Provider 2045.

BVN Role Relationship is read to obtain the Role decompositions for the high-level Role within the context of the particular BVN.

Party Role Product instances are created to link the Service Provider 2045 (Party), within their “low-level” (execution) Roles, to their Customized Logical Products.

At Reassign Solution Product Role 935, a Product/Role combination within a Solution is directly reassigned to another qualified Service Provider 2045 without retrading the Product/Role within the Trading Markets.

The Service Provider 2045 that does the reassignment maintains ultimate accountability for the successful completion of the Role's responsibilities.

Party Role Product is read to obtain the Product being reassigned by the Service Provider 2045 so that it can be updated to indicate the original Service Provider 2045 as the “reassigner” of the product. The status of the product is also updated to “reassigned”.

A Party Role Product instance is created to link the (re)assigned Service Provider 2045 to the Product (as “accountable” or “executor”).

At Create Solution Product Role Process Plan 940, the creation of a Solution-specific Product Role Process Plan. The plan is developed by obtaining template Process responsibilities based on a Product delivery-related Role being fulfilled within a Solution. Additional processes can be added, if desired, based on the requirements of the Service Provider 2045.

There are several levels of Product Role Process Plan templates. The BVN™ system and/or Market Manager 2010 can create the highest-level template. Certain Processes may be indicated as “mandatory”, meaning they are present in any level of template created. Alternatively, Service Provider 2045 can create their own templates. As stated above, certain Processes may be deemed “mandatory” by BVN™ system management. A Service Provider 2045 may also mandate that certain of their Processes must be included in any Process Plans created within their organization.

The processes are defined in terms of dependencies and the actual resources that will be performing the processes (i.e., Parties fulfilling Roles).

Party Role Product is read to obtain the Service Provider's Customized Logical Product.

Party Role Role Process Specification is read to obtain the appropriate Process Specification Plan, for the Role to be performed, for the Market Manager 2010 or the Service Provider 2045, if available. Certain Process Specifications within the plan may be mandatory, while others may be optional.

Process Specification Relationship is read to obtain the “child” Process Specifications related to a “Plan level” Process Specification. The “initial” process specification is also determined so its corresponding (actual) Process can be set to “ready” status.

Actual Process instances are created based on the Process Specification Plan and the “initial” Process is set to “ready” status. All other Processes within the Plan are set to “pending” status.

Product Process instances are created to link all Processes to the Service Provider's Customized Logical Product they're going to be performed for.

Location and Process Location instances are created to link a Process to the Location it is to be performed at, if applicable.

At Approve Update to Solution Level Process Plan 945, a proposed change to the Solution Level Role Process Plan is approved or disapproved.

The Market Manager 2010 will determine the authority levels required to make a change in the Plan. For example, in order to change the due date for a Solution (e.g., plot survey), approval from the Customer 2025 must be obtained.

It is possible that the plan update proposal to be reviewed could be negotiated.

Party Role Solution Process is read to obtain the “pending” Process awaiting approval so that its status can be updated to “ready”, indicating that the process can now be performed.

At Decompose Solution Product Role Process 950, processes associated with a Product delivery-related Role into lower level Processes are decomposed.

This allows Solution delivery responsibilities to be tracked at a more granular level.

Product Process is read to obtain a high-level Process associated with the Product.

Process Specification Relationship is read to obtain the “child” template processes associated with the high-level template process, including identification of the “initial” process.

Process instances are created, in “pending” status, representing the “child” Processes. The “Initial” “child” Process is set to “ready” status.

Product Process instances are created to link the lower-level Processes to the Product.

Process Relationship instances are created to link the parent and child Processes.

At Reassign Solution Product Role Process 955, a Process, to be performed by a Party within a Role as part of delivering a Product within a Solution, to another qualified Service Provider 2045 is directly reassigned.

The Service Provider 2045 that does the reassignment maintains ultimate “accountability” for the successful completion of the Process.

Party Role Product is read to obtain the Product within which a Process is being reassigned by the Service Provider 2045.

Product Process is read to obtain the Process, to be performed as part of delivering a Product, that it is to be reassigned.

A Party Role Product Process instance is created, with a relationship name of “reassigned to”, to link the “reassigned” Service Provider 2045 to the Process being reassigned for a Product.

At Acknowledge Solution Product Process by Role 960, the intent to begin performance of a specific task (Process) associated with a Role in the delivery of a Product within a “posted” “Solution Option” Solution is acknowledged. The completion of this process updates the status of a “Ready” Process to “Acknowledged”.

Party Role Product is read to obtain the Service Provider's Customized Logical Product that work is to be performed for.

Product Process is read to obtain the Processes to be performed for the Service Provider's Customized Logical Product so that the “initial” process can be updated from “ready” to “acknowledged” status. Subsequent Processes will be updated from “Pending” status to “Ready” through Event coordination functionality.

965 Provide Solution Product Process Status

The declaration of information that describes the progress of the execution of a Process, by a Party fulfilling a Role, in the delivery of a Customer's 2025 Product. The level of information that is recorded is dependent on the relevant Parties that are involved with a Solution (from BVN™ system through the Service Provider 2045). Information such as amount of time spent on a Product Process by Role, issues, notes, reminders, and percentage completed can be provided. The status of the Product Process by Role can also be provided.

The Solution Broker 2030 is informed when a Process has been successfully completed or when a problem that impacts the ability to complete the Process arises.

This process includes the triggering of Events as the result of Process execution.

Party Role Product is read to obtain the Service Provider's Customized Logical Product within which Processes are being performed so that the status of a specific Process can be updated.

If a process is completed and it's the last process in a value chain to deliver a customized logical product, the Product's status is set to “delivered”.

The associated Solution, obtained through Solution Product, has its status updated to “delivered” if the last product has been “delivered” (i.e., solution delivery is done). Otherwise, set to status to “in progress”.

Event and Process Event instances are also created based on a Process Specification Event Specification dependency, if applicable.

At Report Solution Status to Customer 970, the status for a given Solution, including Products within the Solution, to the Customer is posted.

As status is received by a Solution Broker 2030 on the delivery of a given Product within a Solution, the Solution Broker 2030 can post this information (at some predefined level of detail) to the Customer 2025 involved in the Solution via the Solution Tracking mechanism.

The applicable Party Role Solution Process and/or Product Process, obtained through Solution Product, instances are retrieved for reporting to the Customer.

When an exception Event occurs, Retrigger Required Processes 977 re-queues previously “Completed” Processes for execution so that they can be performed again in the appropriate sequence. In other words, exception Events “undo” the delivery of a Solution back to a predetermined point in the process.

Product Process is read to obtain the last executed Process.

Product Process instances are created to link the new instances of the Processes that must be redone to their associated Product.

Process Event is read to obtain the Event triggered by the last executed Process.

Event Specification Group Event Spec is read to determine Events to be created to cause “retriggering” of appropriate processes.

Process Specification Event Spec is read to obtain the process(es) to be (re)triggered.

Schedule Next Process 979 coordinates Events required to determine the next Process to be performed with respect to a Product within a Solution.

The execution of a Process causes Event(s) to be initiated. Those Events are analyzed in light of other Events that may have occurred within the Solution to identify Event patterns that require certain subsequent Events to be initiated. These Events cause subsequent Processes to be triggered.

Product Process is read to obtain the Processes that have been pre-linked to the Customized Logical Product based on the Process Plan being used.

Party Role Solution Process is read to obtain existing Solution-level Processes scheduled for the specific Solution based on the Solution-level Process Plan being used.

Process Event is read to obtain the previously created Events that have been “triggered by” a Process.

Event Specification Group Event Spec is read to obtain the Event Specification Group(s) a given Event (through its associated Event Specification) is a member of so the subsequent Events required to be initiated can be determined and created.

Event Relationship instances are created to link actual Events (which may represent an Event Group or an atomic Event) and the subsequent Events they caused to be triggered through Event Specification Group Event Specification relationships.

Process is read to obtain the previously created (during Process Plan creation) Process for the Product or Solution (in “Pending” status).

The next Process to be executed has its status updated to “ready”, as determined by reading Process Specification Event Spec.

At Alert Service Provider of Overdue Process 980, Service Providers 2045 are notified when one of their Solution delivery processes becomes overdue or is planned to be overdue.

The Service Provider 2045 may have taken corrective action prior to being notified, but if the Service Provider 2045 does not report this change and, in some cases have this change approved, they will be notified. In addition, only those Service Providers 2045 that require this information for the successful completion of their Solution components will be notified.

A Process is overdue when the Process is still in progress and has past its completion date.

Party Role Product is read to obtain the product linked to the Service Provider 2045 that has an “overdue” process.

Product Process is read to obtain the applicable process so that its status can be updated to “overdue”.

At Respond to Outstanding Solution Product Process Issues 985, a Service Provider 2045 corrects, resolves or proposes resolutions to issues that are obstacles to a successful Solution Process completion.

The Service Provider 2045 may attempt to correct the problem when they have the authority. In other cases a proposal has to be made to the Solution Broker 2030 or Customer 2025 in order to gain approval.

The Service Provider 2045 must correct or resolve problems with processes that are in progress, or running late prior to or after the completion date of the process. Resolutions to an issue can vary such as reassigning the process to another Service Provider 2045, adding resources, negotiating a revised completion date for the process, or re-sequencing of processes in the Process Plan. The “exception” processing may trigger “exception” Events that cause the assessment of Real-Time Market adjustments to the Solution charges.

A Service Provider 2045 with an overdue Process can either commit to completing the Process within a specified timeframe and incur a “late penalty” or default on the Process so that it can be reassigned through the Trading markets.

Product Process is read to obtain the Product with a Process-related Issue.

If applicable, a new Process and Product Process instance may be created to link a new Process to its related Product.

The existing Process's status may be updated or its due date increased, if applicable.

The status related to a Solution-level Process within a Solution is provided at 990.

Party Role Solution Process is read to obtain a Process assigned to the Solution Broker 2030 within a Solution so that the status of Process can be updated as appropriate.

At 995 a Solution-Level Process Plan by Role for a specific Solution is created.

A Solution-level Plan initially contains Solution Broker 2030 tasks. If the Products within a Solution have delivery dependencies between them (i.e., one product must be delivered before another) then the Solution-level Plan will also eventually contain this high-level Product dependency-related information so it can be proactively managed at the “solution” level.

Party Role Solution is read to obtain the Solution Broker 2030 assigned to a Solution.

Party Role Role Process Specification is to obtain the appropriate Process Specification Plan.

Role Process Specification is read to obtain the “template” Processes associated with the “Solution Broker 2030” Role.

Processes are created for assignment to the Solution-level Party Role (i.e., Solution Broker 2030), via Party Role Solution Process.

At Approve Update to Solution Product Role Process Plan 996, proposed changes to the Product Role Process Plan for a Solution are approved or rejected.

The authority levels required to make a change in the Product Role Process Plan will be determined by the Market Manager 2010. For example, changing the due date for a product needs the approval of the Customer 2025. In this case it is likely that the Solution Broker 2030 will act on behalf of the Customer 2025. Other changes, such as the addition of resources to a task that is running late may need the approval of the Service Provider 2045. In this case the party approving the changes is likely a delegated role that acts for the Service Provider 2045.

It is possible that the proposal to be reviewed could be negotiated.

Party Role Product is read to obtain the product linked to the Service Provider 2045 that has a “pending” process awaiting approval.

Product Process is read to obtain the “pending” Process awaiting approval so that its status can be updated to “ready”, indicating that the process can now be performed.

The maintenance of a Solution-Level Process Plan by Role for a specific Solution is performed at Update Solution level Role Process Plan 997.

A Solution-level Plan initially contains Solution Broker 2030 tasks. If the Products within a Solution have delivery dependencies between them (i.e., one product must be delivered before another) then the Solution-level Plan is updated with this high-level Product dependency-related information so it can be proactively managed at the “solution” level.

The Solution Broker maintains this plan. Some changes may need approval by others (e.g., Customer Manager 2020 or Customer 2025).

Solution Product is read to obtain the Product's associated with a Solution so it can be determined if any Product delivery dependencies exist.

Product Class Relationship is read to determine if delivery dependencies exist for the Product Classes represented by Products within a Solution.

Product Relationship instances are created to link Products with delivery dependencies between each other, with a relationship name of “is prerequisite of”.

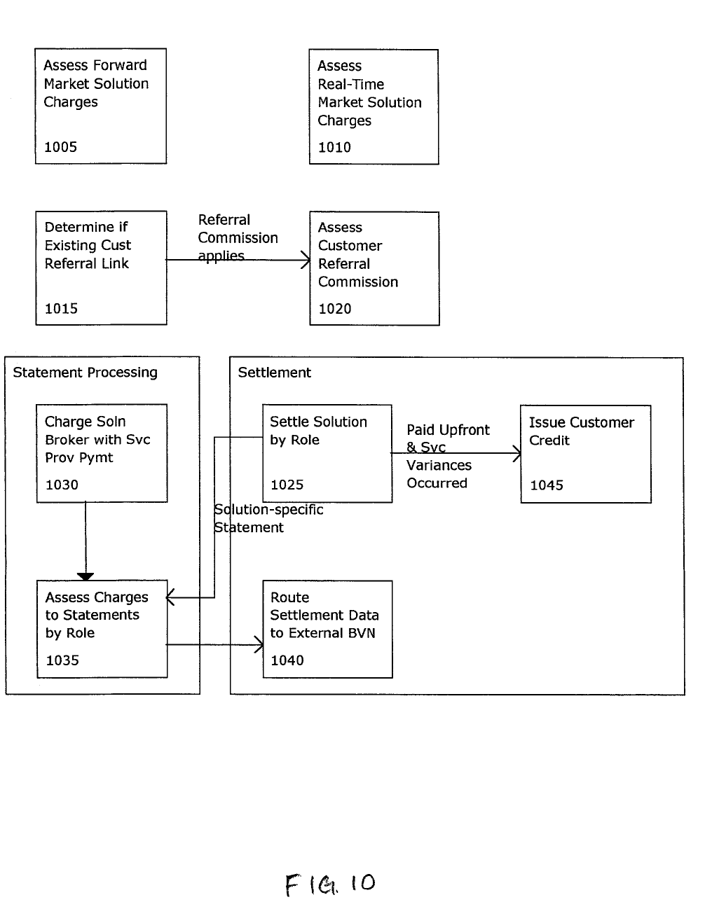

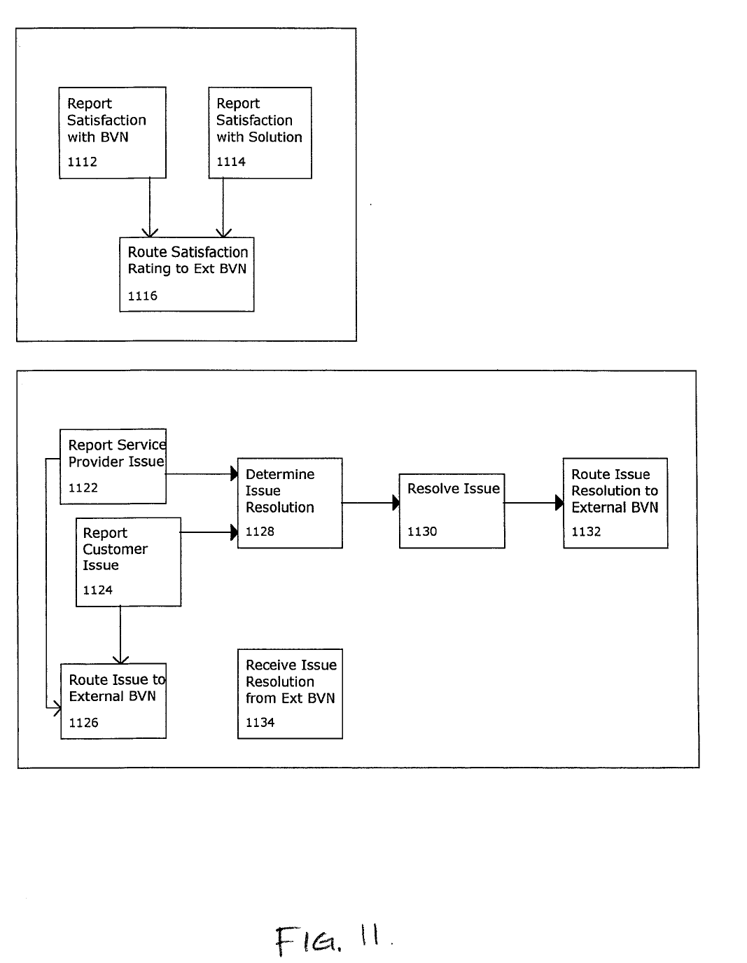

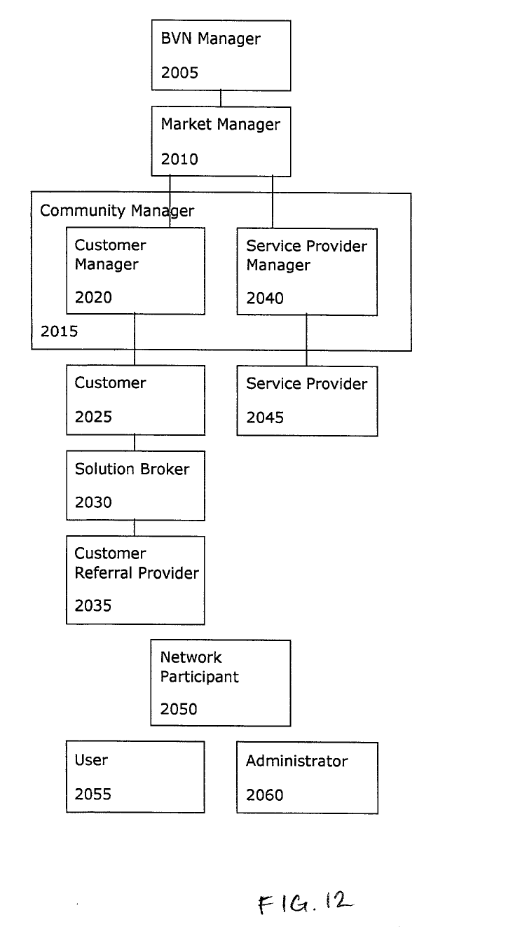

The process for Solution Settlement 1000 is shown at FIG. 10. Solution Settlement involves the management of accounts payable and accounts receivable resulting from the delivery of Customer Solutions within a BVN™ system. This process includes Customer 2025 billing and collection and the financial reconciliation of monetary amounts such as Customer 2025 payments, Service Provider 2045 compensation, and BVN™ system participation fees. Each Network Participant 2050 is assigned an internal BVN™ system settlement account to collect and manage these financial transactions.

Once the desired “Solution Option” Solution has been accepted by the Customer, the various charges associated with delivery of the Solution are assessed at Assess Forward Market Solution Charges 1005. Charges include commissions, administrative fees, and delivery charges.

Also, the charges are associated with the Customer's 2025 internal BVN™ system account.

Party Role Solution is read to obtain the Customer's 2025 Solution (i.e., “Solution Option” type of Solution) and the Solution Broker 2030, Customer Manager 2020, Service Provider Manager 2040, and Market Manager 2010 associated with the Solution to allow assessment of their solution-level commissions.

A Party Role Solution instance is created to link the Customer Referral Provider 2035 to the Solution, if applicable, so the referral commission can be assessed within the context of the Solution.

Solution Product is read to obtain the Service Providers' 2045 Customized Logical Products associated with the Solution so that product-level “forward market” charges can be assessed.

Party Role Product is read to obtain the Service Providers 2045 with Customized Logical Products associated with the Solution to allow “forward market” Financial Transactions to be created for them.

Party Role Role is read to obtain the solution-level Roles linked to a Market Manager 2010 to determine commission rates to be applied.

Financial Transaction instances are created for Customer Referral Provider 2035 (if applicable), Solution Broker 2030, Customer Manager 2020, Service Provider Manager 2040, and Market Manager 2010 solution-level commissions.

Product Financial Transaction instances are created to link the Services Providers' Customized Logical Products to their generated Financial Transactions.

Solution Financial Transaction and Party Role Financial Transaction instances are created to link the solution-level commissions (through Financial Transaction) to the appropriate Party Role within the Solution-Solution Broker 2030, Customer Manager 2020, Service Provider Manager 2040, Market Manager 2010, and Customer Referral Provider 2035.

Party Role Account is read to obtain the Customer's 2025 Account to associate financial transactions to the Customer's 2025 Account, via Account Financial Transaction instances.

At Assess Real-time Market Solution Charges 1010, an assessment is made of an adjustment to the “forward market” (up front) charges associated with a Solution based on the occurrence of some type of “exception” event during the life of the Solution.

For example, if a (Solution Delivery) Process becomes overdue, a “late penalty” is assessed which is passed on to the Customer 2025 as a discount (or allowance) due to failure to meet the original service commitment.

The Solution's “Forward Market” charges are later reconciled with “Real Time Market” charges, such as a late fee.

Party Role Product is read to obtain the Service Provider's Customized Logical Product for which an “exception” event has occurred (such as a Process being late).

Product Event is read to obtain any Events associated with a Service Provider's Customized Logical Product that require a Real-time Market adjustment to be assessed to the Solution charges.

Product Process is read to obtain the last Process associated with the Customized Logical Product when it was delivered late (i.e., Late Delivery Indicator was set to “Y”) so the amount of time delinquent can be determined.

Party Role Product Class Role is read to obtain the Real-time Market adjustment amount (e.g., late charge), assigned by a Market Manager 2010 (Party Role), due to an “exception” event (e.g., late delivery) associated with a specific Product Class, assigned to a specific Role (Role Product Class).

A Financial Transaction is created for the Real-time Market adjustment (e.g., “late fee”) owed by a Service Provider 2045 and linked to the Product, via Product Financial Transaction.

Determine if Existing Customer Referral Link 1015 checks whether a customer referral commission applies to the Solution.

Party Role Relationship is read to obtain the Customer Referral Provider 2035 linked to the Customer.

The customer referral commission to the Customer Referral Provider 2035 associated with a Solution is assesses at 1020.

Party Role Solution is read to obtain the Customer Referral Provider 2035 associated with the Solution.

A Solution Financial Transaction and Party Role Financial Transaction instance is created to link the Customer Referral Provider 2035 to their commission.

The amount owed to or from parties involved in the Solution, by Role is determined at Settle Solution by Role 1025.

The “Forward Market” charges, such as late fees that may occur during Solution delivery, are reconciled.

It is important that reconciliation occur prior to Customer Statement processing so that any applicable discounts (due to variances in actual service delivery) are accounted for.

The Solution is also updated to “Settled” status at this point.

Party Role Financial Transaction is read to check if any real-time market adjustments exist due to process exceptions during Solution delivery or if any previously issued customer credits exist.

Party Role Financial Transaction is created to link the Party Roles and the Real-time Market adjustment Payment Items created during this process.

Solution Product is read to obtain the Service Provider's Customized Logical Products associated with the Solution (i.e., “Solution Option Solution” subtype of Solution).

Solution Financial Transaction and Party Role Financial Transaction are read to obtain “forward market assessed” Solution-level commissions.

Product Financial Transaction is read to obtain the Service Providers' Product-level financial transactions.

Product Financial Transaction is created to link the real-time market Payment Item to the Product.

Financial Transaction Relationship is created to link customer discounts (real-time Payment Items from late fees) to forward market and real-time market Bill Items, if applicable.

The Solution is updated to a status of “settled”.

At Charge Solution Broker with Service Provider Payment 1030, the Solution Broker 2030 is held accountable for amounts owed to Service Providers 2045 if a Customer 2025 is delinquent in paying for a delivered Solution.

Solution Product is read to obtain the Service Providers' Customized Logical Products associated with the Solution to obtain their associated Financial Transactions.

Product Financial Transaction is read to obtain the Financial Transactions associated with the Service Providers' Customized Logical Products within the Solution.

Party Role Statement is read to obtain the Solution Broker's 2030 Statement so the Financial Transaction Amounts owed to the Service Providers 2045 can be debited to the Solution Broker 2030 and the Customer's 2025 Statement so the Financial Transaction Amounts can be removed.

Statement Financial Transaction is created to link the Financial Transaction Amounts owed to Service Providers 2045 to the Solution Broker's 2030 Statement; updated to link the Financial Transaction Amounts owed to Service Providers 2045 and the Customer's 2025 Statement to cancel them.

Charges to the Statements of the parties involved in the Solution by Role are assessed at 1035.

Solution Product is read to obtain the Service Provider's Logical Products associated with the Solution so the financial transaction amounts associated with them can be determined.

Party Role Solution, Solution Financial Transaction, and Party Role Financial Transaction are read to obtain the solution-level commission amounts.

Product Financial Transaction is read to obtain the Service Providers' product-level financial transactions.

A Statement and Party Role Statement instance is created to link a newly created Statement (1st time) and a Party within a Role or a Party's existing Role-specific Statement is obtained.

Statement Financial Transaction instances are created to link Financial Transactions from the Solution to a Party Role's (who participated in the Solution) Statement.

Settlement-related data to the appropriate Market Manager 2010 within the External BVN™ system for a Solution that included “non-core” Products that were delivered by external BVN™ Service Providers 2045 is forwarded at Route Settlement Data to External Business Value Network 1040.

Solution Financial Transaction and Party Role Financial Transaction are read to obtain solution-level commission amounts.

Solution Product is read to obtain the Service Provider's Customized Logical Products associated with the Solution.

Product Financial Transaction is read to obtain the Solution's product-level financial transactions.

At Issue Customer Credit 1045, the Customer 2025 receives credits towards the future purchase of products and services if they prepaid for a Solution and service commitments were not met during Solution delivery.

Solution Product is read to obtain the Service Provider's Customized Logical Products associated with the Solution.

Product Financial Transaction is read to check for payment items hooked to the Solution's Products.

Party Role Financial Transaction is created to link the Real-time Market adjustment (e.g., “late fee”) payment item to the Customer, independent of any Solution.

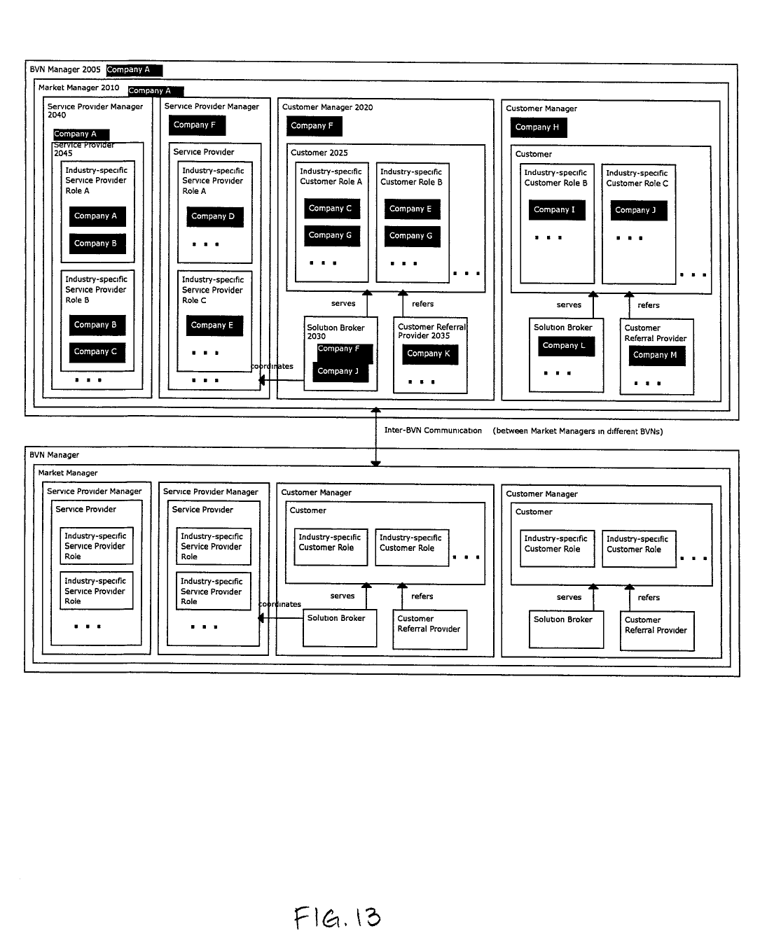

The Quality and Service Management 1100 is shown at FIG. 11. Business Value Network Quality and Service Management involves the collection and resolution of Customer 2025 and Service Provider Solution-related issues and the collection and reporting of Customer 2025 and Service Provider Solution satisfaction ratings.

At Report Satisfaction with Business Value Network 1112, upon completion of Solution delivery, the Solution Broker 2030 and Service Providers 2045 provide feedback on their satisfaction with the other Service Providers 2045 involved in the solution and the operation of the BVN™ system.

A Party Role Party Role Solution instance is created to provide satisfaction reporting (i.e., a party within a role reports satisfaction with another party within a role in the context of a solution).

At Report Satisfaction with Solution 1114, upon completion of Solution delivery, the Customer 2025 reports his/her satisfaction with the Solution Broker 2030, the Service Providers 2045, and the overall process.

A Party Role Party Role Solution instance is created to provide satisfaction reporting (i.e., a party within the “Customer” Role reports satisfaction with another party within a role in the context of one of their solutions).

The Satisfaction Rating to an External Business Value Network for a Solution that included “non-core” Products that were delivered by external BVN™ Service Providers 2045 is forwarded at Route Satisfaction Rating to External Business Value Network 1116.

A Party Role Party Role Solution instance is created (i.e., a party within a role reporting satisfaction with another party within a role in the context of a specific solution) for forwarding to an external BVN.

At Report Service Provider Issue 1122, a Service Provider 2045 may report Solution-specific or general (independent of any Solution) issues to the Solution Broker 2030.

An Issue is created and linked to the Service Provider 2045, via Party Role Solution Issue (solution-specific issue) or Party Role Issue (solution-independent issue).

At Report Customer Issue 1124, a Customer 2025 may report Solution-specific or general (independent of any Solution) issues to the Solution Broker 2030.

An Issue is created in “open” status and linked to either a Solution via Party Role Solution Issue or a Party within a Role (i.e., independent of a solution), via Party Role Issue.

An Issue or Dispute is forwarded to an External Business Value Network for a Solution that included “non-core” Products that were delivered by external BVN™ Service Providers 2045 at Route Issue to External Business Value Network 1126.

An Issue relating to an existing solution is created. The applicable party, within a role, and solution are obtained. A Party Role Solution Issue instance will be created in the external BVN.

The Solution Broker 2030 is responsible for determining front-line Customer 2025 and Service Provider 2045 issue resolution at Determine Issue Resolution 1128.

If the Solution Broker 2030 can not determine a resolution, the issue will be escalated to the Customer Manager 2020 and/or Service Provider Manager 2040.

If the Customer Manager 2020 can not determine a resolution, the issue will be escalated to the Market Manager 2010.

Party Role Solution Issue is read to obtain the party that reported the issue and the party that was reported in the issue, if applicable.

Party Role Solution Issue is created to link the party, within a role, assigned to resolve the issue.

The status of the Issue is updated to “assigned”.

Resolution of a solution-independent issue is performed at 1130. If the Customer 2025 raised the issue, the Service Provider 2045 will resolve the issue. If the Service Provider 2045 raised the issue, the Solution Broker 2030 will resolve the issue on behalf of the Customer.

The Issue is updated to set the status to “resolved” and, if a standard Resolution is provided, then a Party Role Issue Resolution instance is created.

A Resolution to an Issue/Dispute is forwarded to an External Business Value Network for a Solution that included “non-core” Products that were delivered by external BVN# Service Providers 2045 at Route Issue Resolution to External Business Value Network 1132

A Resolution is to an existing solution-specific issue is created. The applicable party, within a role, and solution are obtained. A Party Role Solution Issue Resolution instance will be created in the external BVN.

The resolution to an issue reported to an external BVN™ (Service Provider 2045) that provided a “non-core” Product within a Solution is received at Receive Issue Resolution from External Business Value Network 1134.

A Resolution is created and linked to the Issue via Party Role Solution Issue Resolution.

Referring to FIG. 1, External Product/Service Trading 1200 pertains to the use of external trading networks by a BVN™ system. The communication between networks is done via the creation of standardized interfaces to/from BVN™ system XML.

Preferred Embodiment

The BVN™ system technology architecture is the technology core of the Business Value Network. In a preferred embodiment, the BVN# system applications act as a hub by providing the key value-added technology and business services necessary for integration of the business network participants and their applications.

The underlying technology of the BVN™ system architecture is a distributed architecture that is designed to support very large networks with hundreds of thousands of concurrent users (including external systems and on-line users) and millions of customers with the required performance, fault tolerance, security, and reliability.

The preferred BVN™ system technology architecture is message-based and allows business functionality to be implemented in a standardized manner without having to be aware of all the technical details embedded within the technical infrastructure, and without dictating the nature of the applications being integrated. BVN system business applications can be developed independently of the architecture and, as long as some basic interface requirements are met, can be “plugged in” to the overall architecture. The infrastructure is also specifically designed to support the scalability and reliability required for large business networks and communities.

Because the architecture is implemented in several industries, with varying requirements, the basic BVN™ system architecture consists of the core technology framework, a set of template Elementary Business Process applications and a workflow and Event Coordinator 5011 or process automation application that enable the BVN™ system business processes. These template applications are customized to each industry, adding industry-specific validations and functionality. Thus, the core BVN™ system architecture is the template from which multiple industry-specific instances can be constructed.

In order to make the external client applications efficient, the network differentiates between “presentation/formatting/interface” processing versus “business layer” processing. All business layer processing occurs in the core BVN™ system back-end applications. These business services are accessible via the message-based “BVN# system API”. The message-based architecture allows very large numbers of client external applications to submit requests to the back-end business layer.

The message-based architecture also allows the efficient publication of processing results to one or many clients. The message-based architecture is the key to enabling efficient data publishing and message processing within the architecture. The message API also shields the external client applications from the complexities of the internal BVN™ system application.

The “presentation/formatting/interface” processing performed for the external client applications can be very processing intensive. In addition, improperly formatted messages add unnecessary inefficiency both from a computer resources perspective and from a business perspective. As a result, the network can publish the relatively static XML data required to support “presentation/formatting/interface” processing. Alternatively client applications can populate GUI displays, messages, or other outputs by invoking the BVN™ system API directly using an extensive array of on-demand utility commands, or by accessing local copies of the data required to construct messages.

The external client applications (such as an ERP system or the BVN™ system user interface) can also do some basic format validations that will reduce the number of errors encountered in the back-end BVN. The back-end BVN™ system applications, however, make no assumptions as to the valid formatting of incoming messages, and any error in formatting messages will cause a functional error to occur. As changes occur to the BVN™ system reference data (and can also request updates in real time), external and internal clients receive updates, which can be applied to the local XML data store and cached data, and then to corresponding outputs.

The Business Value Network's community members can connect to the BVN™ system back-end systems that facilitate their transactions using a versatile array of technology options. The technologies employed by these network parties in the BVN's external environment range from telephony devices and web-based thin clients to full-strength external applications. Standard web browsers and related browser applications such as palm-top or set-top browsers serve as the most basic means of interfacing with the BVN. When required, community participants who are “away from the web” can use telephony technologies such as telephones, fax, pagers, voice mail (or internet phones on the web) to communicate with the BVN# system using the BVN™ system message API. Larger entities can interact directly with the network by integrating their applications into the BVN™ system via the XML enabled “BVN™ Connector” interface. In cases where there is an overriding need to integrate either a pre-existing or industry standard external application protocol such as EDI, the BVN# system can accommodate non-standard interfaces.

The BVN™ system architecture was specifically designed to accommodate a wide range of external interfaces. Typical stovepipe architectures can only support a graphical user interface (GUI). By developing a generic distributed technology architecture the BVN# system can integrate multiple external environments. The web interface allows network participants to initiate BVN™ system functions via any web-enabled device. Different web presentations may be required based on the nature of the device.

The customer web interface is built upon the standard BVN™ system message API interface. Essentially, a user logs on to the BVN™ system using his web browser. The customer web interface supports the subset of the BVN# system functionality that is amenable to web interaction. The user selects the functions he is interested in from a list on the web. The web interface translates this request into a BVN™ system message and submits this via the BVN™ system message API. When the BVN™ system responds, the web interface processes the message and produces a web presentation output, using web translation technologies. If the user logs off, the web interface can deliver the message when the user logs back on, page the customer or leave a voicemail (or all three). The interface may also initiate an e-mail.

The key to the power of the web interface is that it provides value-added user interface functionality on top of the pre-existing BVN# system functionality. In this way, the back-end applications are not impacted by the addition of the new or upgraded web or user interface functionality. The web interface is customizable for each BVN. It is likely that industry specific network managers will heavily modify the web interface to be consistent with the needs of their business network. The BVN™ system provides basic web interfaces that can be enhanced, modified, and customized. If so desired, network managers can develop their own web interfaces for their own business networks. In addition, Community Managers may integrate value-added web content and features in order to enhance the functionality offered by the BVN™ system web interface.

The BVN™ system architecture provides a standard BVN# system Connector that can be used by any external entity to connect directly into the BVN™ system infrastructure. Many external applications will connect to the network directly via the standard BVN™ Connector. These will typically be large network service providers and customers, who do automated network trading and coordinate in real-time with the network when it comes to service delivery, settlements, disputes, etc. Entities that take advantage of connecting directly to the network will gain tremendous benefits as a result of efficient interaction with the BVN™ system as a whole.

The BVN™ system Connector is a modified version of a standard Software Connector. The BVN™ system Connector is preferably Java messaging service enabled and supports XML over HTTP, thus conforming to emerging industry standards and reducing the technical and functional integration requirements for network participants. The Connector can also support direct integration of a MOM (message only middleware) agent into the connector, allowing the direct integration of products such as Tib Rendezvous, BEA, Biz Talk and MQ series. The Connector is also used to connect to products like GE's GXS product suite. This product provides “any to any” connectivity and protocol translation to the electronic community, thus allowing the integration of EDI, XML and flat files.

The BVN# system Message Bus, provided by a third party, provides a central mechanism in the BVN# system architecture for inter-application message routing and control, as well as shielding the external applications from the complexities of the BVN's back-end applications and vice versa. The Message Bus is connected to the BVN# system Connector and to external applications. The Message Bus routes messages based on event type to the appropriate internal or external destination(s).

It is essential -that the BVN# system perform as an efficient data hub for the entire network. Rather than having all the “users” constantly retrieve data out from the central BVN# system applications, the BVN# system architecture can utilize a “publish and subscribe” methodology to disseminate information throughout the network. Network participants subscribe to certain types of messages based on their BVN# system roles, and these are published on the BVN™ system network and automatically received by the correct subscribers. In addition, the BVN™ system Message Bus supports communication that allows users to invoke specific BVN™ system services in a secure and dedicated manner.

In contrast to traditional client server computing, the role of client and server are dynamically interchangeable, i.e., the BVN# system Message Bus allows an application to work as client and/or server.

The Message Bus automatically routes every message that it receives to the Message Log application on the back-end, which maintains an archive of all messages flowing through the BVN.

In addition to the responsibility for message routing, the Message Bus handles Message Bus logon, user authentication, and Message Bus logoff.

The preferred BVN™ Message Buses are Tibco™ “Tibco Active Enterprise” product, IBM™'s MQ toolset or BEA™ e-collaborate or the GXS™ interlinx suite of products.

The BVN# system back-end environment hosts the applications that provide the information processing services of the BVN. As mentioned above, the major back-end application and application groups are the Interoperation Framework 5000 applications (Registration, User Logon/Logoff and Message Logging) and the BVN# system EBP business applications (Solution Configuration, Product/Service Trading, Solution Assembly, Solution Delivery, Dispute Management and Solution Settlement).

The preferred implementation uses Enterprise Java Beans or an equivalent and a relational database to implement these applications. In the BVN™ system architecture a separation is made between logical units of work (EBPs) implemented within business-oriented components and control-oriented processes that govern the interaction between the business Components as they execute in support of the operation of a BVN.

The control processes utilize an “event-based”, flexible approach to the logic and process automation required for controlling the business applications. Experience has shown that most rapid change is required in the area of application control and process automation. As a result, by isolating this layer, the BVN# system can achieve very high levels of flexibility, without sacrificing performance, scalability or maintainability.

All the back-end BV system applications are connected to the external applications via the BVN™ system message API. Messages are received by the API and passed to the back-end application. Typical back-end applications are “server applications” that are waiting for client requests from other (external or internal) applications. Each back-end application has a business layer that performs all the business processing and a data layer that handles all the data requests to and from the database. The data layer typically consists of a set of shared data access objects that are accessible by the applications and are managed by a transaction manager. The backend applications are Java based applications built on top of a relational database.

The BVN™ system back-end data environment can contains multiple databases (one per community if required), a single Network Party database, a Message Log, a Financial package database and the Data Warehouse. To achieve unlimited BVN™ system scalability, databases can be partitioned into multiple physical databases. In addition, back-end applications provide the functionality required to manage customers across multiple BVNs.

A key component of the BVN# system is the Workflow/Event Coordinator 5011. The Event Coordinator 5011 is an intelligent application that listens to relevant network events and triggers new events based on appropriate business rules. A third-party product is used to implement event coordination in the BVN™ system architecture. This event coordination/process automation, is model-based and can be changed based on the business requirements.

The Event Coordinator 5011 enables the implementation of distributed transaction logic similar to a transaction manager in a traditional system. This allows the network to manage events across the whole business network. The Event Coordinator 5011 also enables the implementation of flexible business rules that control the network in real-time. There are several commercially available applications that can handle the BVN™ system workflow and event coordination, including BEA e-collaborate and products from IBM™, Tibco™ and Microsoft™.

The BVN# system preferred embodiment allows for inclusion of third-party value added applications that may be required by the collaborative e-business community. These third-party applications may include among other things, catalog applications for BVNs that require digital catalogs and back office applications to support HR and general ledger functionality.

Table XXX summarizes desirable platforms for the preferred embodiments.

TABLE XXX

| | | | | | | | Web | Message |
|---|---|---|---|---|---|---|---|---|
| | Client | BVN ™ | Message | Event | Interoperation | EBP | Infra- | Bus Bridge & |
| | Application | Connector | Bus | coordinator | Applications | Applications | structure | Translator |
| Tools | A | | | | | | | |
| Java 2 Platform Enterprise Edition | N | P | | | P | P | P | |
| (J2EE) | Y | S | | | S | S | S | |
| Microsoft .NET Platform | | | | | | | | |
| Application Server | A | | | | | | | |
| BEA Weblogic Server | N | P | | | P | P | P | |
| Microsoft Transaction Server | Y | S | | | S | S | S | |
| (MTS) | | | | | | | | |
| Operating System | A | | | | | | | |
| Unix (Sun & HP) | N | P | P | P | P | P | P | P |
| Windows NT/2000 | Y | S | S | S | S | S | S | S |
| Database | A | | | | | | | |
| Oracle | N | | | | P | P | P | |
| SQL Server | Y | | | | S | S | S | |
| Services | | | | | | | | |
| BEA Collaborate | | | P | | | | | |
| BEA Process Integrator | | | | P | | | | |
| Microsoft BizTalk | | | S | S | | | | |
| GXS InterLinx | | | | | | | | P |

P = Primary
S = Secondary

BVN™ System Logical Data Model

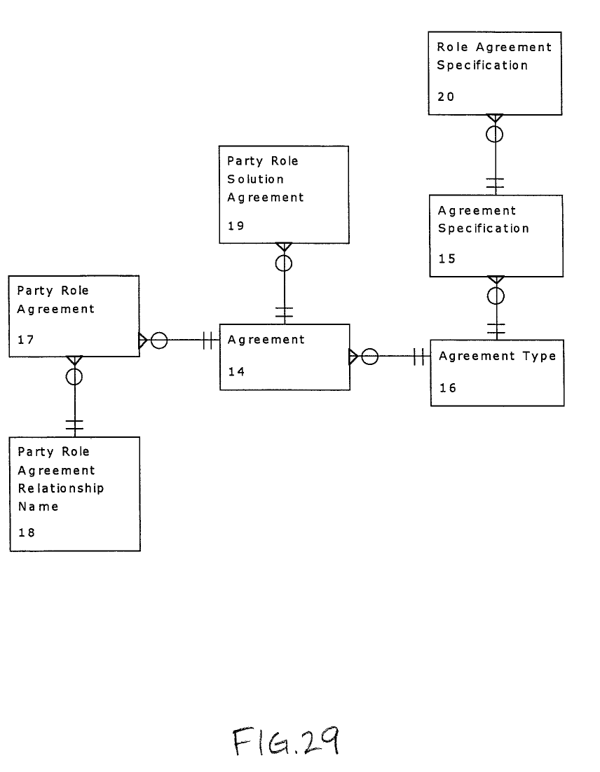

FIGS. 28 to 41 illustrate the BAN™ system logical data model as detailed below.

Referring to FIG. 28 the logical data model for Accounts and Financial Transactions is shown.

Account 1: A financial account used to track accounts payable and receivable (possibly by specific financial categories). These include “cash” accounts (that can be used for COD), credit card accounts and checking accounts. Also, network participants have an internal BVN settlement account established for them.

Relationships: Has posted Account Financial Transaction; Child of Account Relationship; Parent of Account Relationship; Categorized by Account Type; Associated with Party Role Account.

Account Financial Transaction 2: Account Financial Transaction represents the association of a financial transaction to an account. One typical use of this entity is to assign amounts due and paid by a Customer for a Solution to the Customer's “Settlement” Account—every Party involved in a BVN has a Settlement Account. Another use of this entity is to assign an amount paid by a Customer for a Solution to the specific Account used, such as a credit card or checking account.

Relationships: Is posted to Account; Specifies posting of Financial Transaction.

Account Relationship 3: Account Relationship relates to Account instances together.

Relationships: Child Account; Parent Account.

Account Type 4: Account Type represents a mutually exclusive categorization of Accounts.

Relationships: Categorizes Account.

Financial Transaction 5: Financial Transaction represents an amount owed by one Party to another Party within the context of a business value network. This amount may or may not be in relation to a specific Solution or Product within a Solution.

Relationships: Posted to Account Financial Transaction; The object of Financial Transaction Relationship; The subject of Financial Transaction Relationship; Associated with Party Role Financial Transaction; Generated for Product Financial Transaction; specifies amounts for Solution Financial Transaction; Reported on Statement Financial Transaction.

Financial Transaction Relationship 6: Financial Transaction Relationship represents the relationship between two Financial Transactions.

Relationships: Identifies as the object Financial Transaction; Identifies as the subject Financial Transaction.

Party Role Account 7: The association between a Party fulfilling a Role and an Account. The nature of the relationship is also specified.

Relationships: Identifies Party Role; Identifies Account.

Party Role Financial Transaction 8: Party Role Financial Transaction represents the relationship between a Party Role instance and a Financial Transaction instance. The nature of the participation in the relationship is also described. This entity relates participants in specific Solutions to the financial transactions they're involved in due to the Solution (at the Solution- or product within Solution-level). Another use of this entity is for Solution-independent refunds to Customers (from service variances (assess late fee) on prepaid Solutions). Also, fees such as yearly membership fees for network participants and Network Manager fees may be represented.

Relationships: Identifies Party Role; Identifies Financial Transaction.

Party Role Statement 9: Party Role Statement represents the association of a Party within a specific Role to a Statement.

Relationships: Reports financial activity for Party Role; Reports financial activity via Statement

Product Financial Transaction 10: Product Financial Transaction represents the association of a Product to a Financial Transaction to indicate the source of the transaction amount (when it's a product).

Relationships: Generated for Product; Specifies amount due via Financial Transaction.

Solution Financial Transaction 11: Solution Financial Transaction represents an amount of money owed in relation to a specific Solution. The parties involved in the transaction are derived via Party Role Solution.

Relationships: Specifies amounts for Solution; Has amounts specified via Financial Transaction.

Statement 12: Statement represents the debits and credits associated with a Party's participation in Solutions for a given time period or per Solution.

A negative balance indicates that the Party owes money to the Market Manager. A positive balance indicates that the Party is owed money by the Market Manager. Statements are produced for both Customers and internal network participants (e.g., Customer Referral Providers and Service Providers).

If a Party plays multiple Roles within the network, it is possible to consolidate all activity into a single Statement via the addition of a Party Statement entity (if desired) (or a Party “view” can be built from Party Role Statement instances).

Relationships: Reports financial activity for Party Role Statement; Consolidates Statement Financial Transaction.

Statement Financial Transaction 13: Statement Financial Transaction represents the association of a specific Financial Transaction to a Statement.

Relationships: Consolidates Financial Transaction; Reported on Statement.

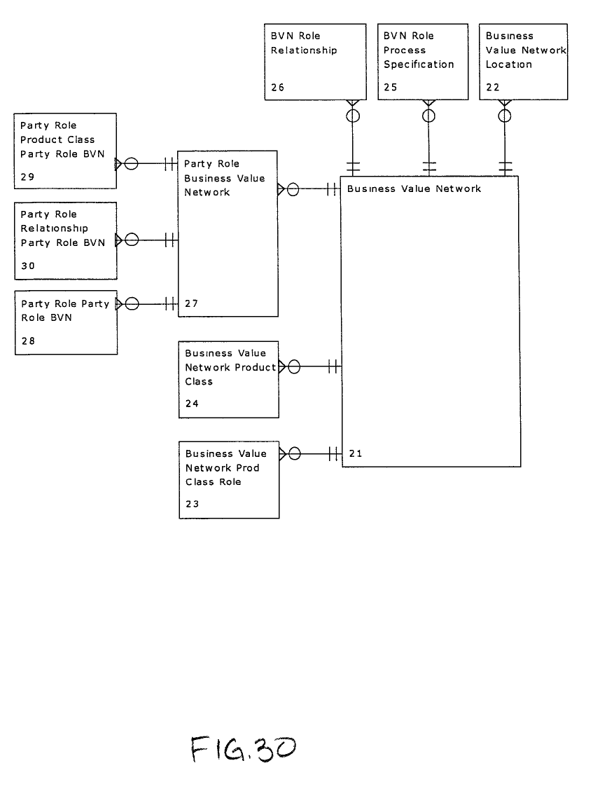

Referring to FIG. 29 the logical data model for Agreements is shown.

Agreement 14: Agreement represents a formal contract between two or more parties participating in a Business Value Network.

Agreement generically represents several types of contracts that may be required in running a Business Value Network.

Some types of contracts may be Service Provider contracts with Service Provider Managers (and possibly Market Managers), Solution Broker contracts with Customer Managers, Customer Referral Provider contracts with Customer Managers or Solution Brokers, Market Manager contracts with Network Manager and Customer contracts with Customer Managers.

It may also be possible to have “Solution-specific” Agreements, for example, between Service Provider and Customer, that override standard contract terms or provide additional “one-time only” terms.

If completely generic Agreement terms are used (i.e., no customization of verbiage), it may be possible to link Parties directly to “Agreement Specification” (template) instances to represent “execution” of an actual agreement.

Relationships: Is categorized by Agreement Type; Participated in by Party Role Agreement; Specifies terms via Party Role Solution Agreement.

Agreement Specification 15: Agreement Specification represents a “template” structure from which multiple actual Agreements can be created.

This entity is modeled at a high level. Additional “Terms and Conditions”-related entities might need to be added within an actual implementation to explicitly cite the terms of a contract between two parties.

If completely generic Agreement terms are used (i.e., no customization of verbiage), it may be possible to link Parties directly to “Agreement Specification” to represent “execution” of an actual agreement.

Relationships: Categorized by Agreement Type; Fulfilled by Role Agreement Specification.

Agreement Type 16: Agreement Type represents a mutually exclusive categorization of Agreements.

Relationships: Categorizes Agreement; Categorizes Agreement Specification.

Party Role Agreement 17: Party Role Agreement represents the association of a Party playing a specific Role to one of that Party's Agreements.

Relationships: Specifies participation of Party Role; Specifies participation in Agreement; Described by Party Role Agreement Relationship Name.

Party Role Agreement Relationship Name 18: Party Role Agreement Relationship Name lists the types of relationships that can exist between a Party within a Role (e.g., Customer) and an Agreement.

Relationships: Specifies terms for Party Role Solution; Has terms specified by Agreement; Describes Party Role Agreement.

Party Role Solution Agreement 19: Party Role Solution Agreement represents the association of a Party acting within a specific Role to a Solution-specific Agreement, which overrides the Party's standard Agreement.

Role Agreement Specification 20: Role Agreement Specification represents the relationship between a Role and an Agreement Specification. This entity allows standard agreement templates to be created for particular network roles and then instantiated for specific parties playing those roles within the network.

Relationships: Fulfilled by Role; Fulfills Agreement Specification.

Referring to FIG. 30 the logical data model for the Business Value Network™ system is shown.

Business Value Network 21: Business Value Network represents an industry-specific implementation of the BVN concept.

Relationships: Provides products and services in Business Value Network Location; Defines Business Value Network Prod Class Role; Offers products within Business Value Network Product Class; Utilizes BVN Role Process Specification; Utilizes BVN Role Relationship; Managed by Party Role Business Value Network.

Business Value Network Location 22: Business Value Network Location represents the definition of a BVN by geographic boundaries.

Relationships: Is serviced by Business Value Network; Provides products and services in Location.

Business Value Network Prod Class Role 23: Business Value Network Product Class Role represents the association of a Role to a Product Class within the scope of a Business Value Network. This relationship establishes the valid Roles that can be assumed when providing a Product, within a certain Product Class, within a Business Value Network.

Relationships: Defined by Business Value Network; Defines Product Class Role.

Business Value Network Product Class 24: Business Value Network Product Class represents the definition of a BVN by large-grained (“Super”) product classifications.

Relationships: Has products offered within Business Value Network; Offers products within Product Class.

BVN Role Process Specification 25: BVN Role Process Specification represents the association of a Role Process Specification combination to a Business Value Network. This entity allows a BVN to specify the Processes, within Roles, that are required in the delivery of products offered within the BVN.

Relationships: Utilized within Business Value Network; Utilizes Role Process Specification.

BVN Role Relationship 26: BVN Role Relationship represents the association of a relationship between two Roles to a Business Value Network. This relationship establishes the valid Role “configurations” that can be instantiated within a Business Value Network.

Relationships: Utilizes Role Relationship; Utilized within Business Value Network.

Party Role Business Value Network 27: Party Role Business Value Network represents the relationship of a Party Role instance to a Business Value Network instance.

Relationships: Managed by Party Role; Specifies management of Business Value Network; Has intra-BVN party relations specified Party Role Party Role BVN; Receives routing of Party Role Product Class Party Role BVN; Registration of Party Role Relationship Party Role BVN.

Party Role Party Role BVN 28: Party Role Party Role Business Value Network represents the relationship of a Party Role instance to a Party Role Business Value Network instance.

One use of this entity is to link a Party within the Role of Service Provider to a Party within the Role of Service Provider Manager within a Business Value Network. This supports Service Provider registration within a Market Manager's market. It is necessary to include BVN in the relationship because a Party may act as a Market Manager within multiple BVNs.

Another use of this entity is to link a Party within the Role of Market Manager to another Party within the Role of Market Manager within a Business Value Network. This supports Market Manager pre-selection of another Market Manager to be used for Solutions, which include non-core products (and thus the involvement of an inter-BVN communication).

Relationships: Specifies intra-BVN party relations for Party Role; Specifies intra-BVN party relations for Party Role Business Value Network.

Party Role Product Class Party Role BVN 29:

Party Role Product Class Party Role BVN represents the association between a Party Role Product Class instance and a Party Role Business Value Network instance.

One use of this entity is to relate a Market Manager linked to a “Non-Core” or externally traded “Core” Product Class (i.e., Relationship Name attribute value is “Both”), to another Market Manager linked to a BVN that is to have products (within the specified Product Class) routed to it for trading. Specifically, this is the vehicle for establishing inter-BVN product trading communications.

Relationships: Receives routing of Party Role Product Class; Routes to Party Role Business Value Network.

Party Role Relationship Party Role BVN 30: Party Role Relationship Party Role BVN represents the association of a pair of Parties acting within specific Roles to another Party within a Role that is linked to a particular Business Value Network.

This entity has several uses with respect to party registration within a BVN. For example, a party can register as a Customer (Party Role) within the context of a Customer Manager (another Party Role, constituting the “Party Role Relationship”), who has previously registered with a Market Manager (Party Role) within a specific BVN (constituting,the “Party Role BVN”). This entity is required if it is a requirement to allow party IDs to be shared across BVNs.

Relationships: Registration of Party Role Relationship; Registered within Party Role Business Value Network.

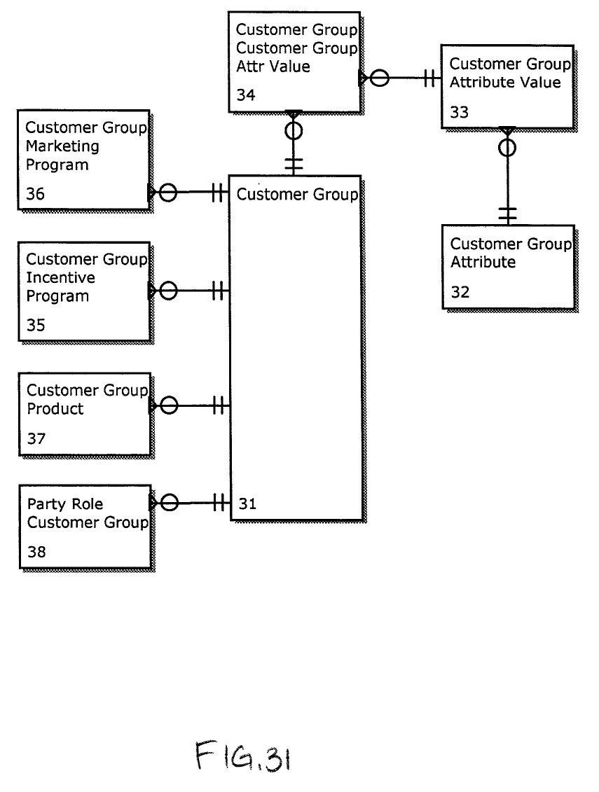

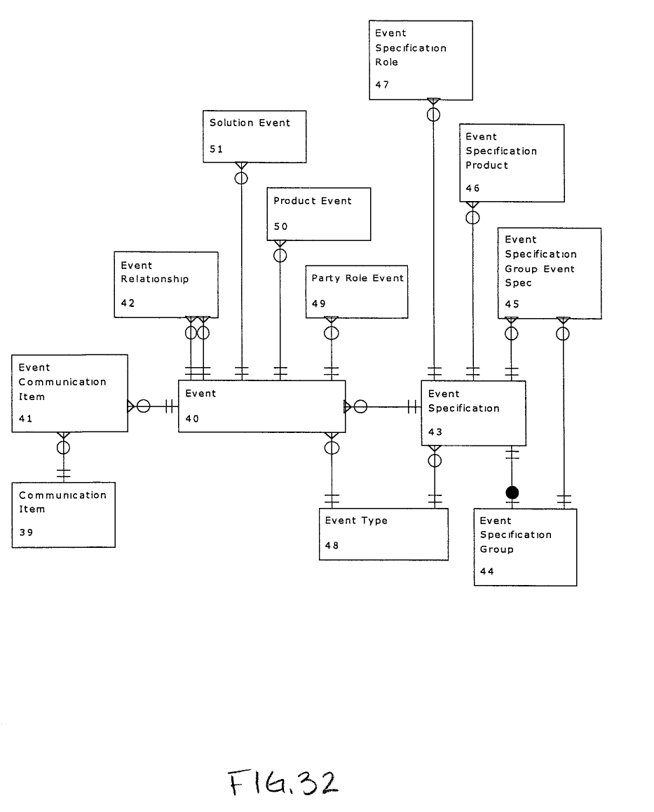

Referring to FIG. 31 the logical data model for Customer Groups is shown.

Customer Group 31: Customer Group represents a marketing-oriented category of Customers to facilitate mass marketing.

Relationships: Has attribute values specified via Customer Group Customer Group Attribute Value; Assigned to Customer Group Incentive Program; Offered Customer Group Marketing Program; Marketed to via Customer Group Product; Associated with Party Role Customer Group.

Customer Group Attribute 32: Customer Group Attribute represents a characteristic that is used to define a Customer Group.

Relationships: Has values specified via Customer Group Attribute Value.

Customer Group Attribute Value 33: Customer Group Attribute Value represents a value assigned to a Customer Group Attribute that serves as a mechanism for specifying the characteristics that define Customer Groups.

Relationships: Specifies values for Customer Group Attribute; Specifies attribute values for Customer Group Customer Group Attribute Value.

Customer Group Customer Group Attribute Value 34: Customer Group Customer Group Attribute Value represents the association between a Customer Group Attribute Value and a Customer Group. This entity allows Customer Group Attributes and their values to be shared across Customer Groups.

Relationships: Specifies attribute values for Customer Group; Has attribute values specified via Customer Group Attribute Value.

Customer Group Incentive Program 35: The relationship between a Customer Group and an Incentive Program.

Relationships: Described by Customer Group; Described by Incentive Program.

Customer Group Marketing Program 36: Customer Group Marketing Program represents the association between a Customer Group and the Marketing Programs that may be offered to that Customer Group.

Relationships: Offered to Customer Group; Offered Marketing Program.

Customer Group Product 37: Customer Group Product represents the association between an instance of Customer Group and an instance of Product for the purposes of defining the products that are targeted to a specific Customer Group.

Relationships: Marketed to Customer Group; Markets Product.

Party Role Customer Group 38: Party Role Customer Group represents the relationship between a Party acting within a Role and a Customer Group.

Relationships: Involves Party Role; Identifies Customer Group.

Referring to FIG. 32 the logical data model for Events is shown.

Communication Item 39: Communication Item represents any form of communication between two or more Parties which occurrence needs to be formally recorded.

There are several types of formal Communication Items tracked within the BVN environment to maintain open communications between network participants.

Relationships: Triggered by Event Communication Item.

Event 40: Events represent actual instances of messages that are “published” and “subscribed to” via Channels. Events can be published or subscribed to by Users (Parties acting within Roles) or Application Instances.

Also, an Event can either represent an Event Group (group of Events) or an atomic Event. An “Event Group” type of Event instance can be related to multiple “atomic” Event instances (via Event Relationship) based on the predefined composition of its associated Event Specification (i.e, an Event Specification for an Event Group will be related to the atomic Event Specification instances that comprise it).

All “actual” Events are created based on their corresponding Event Specification (i.e., “template” Events).

Event can represent: “Logical” triggers or results of Solution-specific Processes (“EBP Event”); User Management messages, e.g., User Logon/Logoff messages; Event Management messages, e.g., logging and retrieval of Events; General “Broadcast” messages; Role-specific “Broadcast” messages; and Internally-generated, time-based “Broadcast” or “EBP” messages.

In the case of EBP Events, when a Process is completed it triggers an Event, which may, in turn, trigger an Action (a type of Event) to initiate the next Process. Complex Process Event relationships may also exist in which multiple Events are triggered by a Process. Likewise, multiple Processes may need to be completed before a particular Event can be triggered.

Relationships: Triggers sending of Event Communication Item; Child Event Relationship; Parent Event Relationship; Created from Event Specification; Categorized by Event Type; Involves Party Role Event; Resulted from Product Event; Resulted from Solution Event.

Event Communication Item 41: Event Communication Item represents the relationship between an Event instance and a Communication Item instance that it caused the creation of.

Relationships: Triggers sending of Communication Item; Triggered by Event.

Event Relationship 42: Event Relationship represents an association between two instances of Event.

An Event Relationship can either relate: an “Event Group” type of Event to the “atomic” Events its “comprised of”; or an Event (which may actually be an “Event Group” or “atomic” Event) to another Event that it “triggers”.

Relationships: Child Event; Parent Event.

Event Specification 43: An Event Specification represents a “template” Event that can be used to create actual Event instances based on the template.

All Events must be created from their corresponding Event Specification.

Relationships: A template for Event; An instance of Event Specification Group; Member of Event Specification Group Event Spec; Causes offering of Event Specification Product; Applies to Event Specification Role; Categorized by Event Type.

Event Specification Group 44: An Event Specification Group represents a pattern of “template” Events that can be used to initiate Actions based on actual patterns of Events.

Relationships: Is an Event Specification; Specifies as a member Event Specification Group Event Spec.

Event Specification Group Event Spec 45: Event Specification Group Event Specification represents the association of an Event Specification Group instance to an Event Specification instance.

This entity establishes formal patterns of “template” Events that can initiate Actions when all Events within the pattern occur.

Relationships: Specifies as a member Event Specification; Specifies members of Event Specification Group.

Event Specification Product 46: Event Specification Product represents the association of an Event Specification to a Product.

One use of this entity is to link “major life” Event Specifications to Products that can be offered as a result of that event occurring in a Customer's life.

Relationships: Offered based on occurrence of Event Specification; Causes offering of Product.

Event Specification Role 47: Event Specification Role represents the association of a “template” Event (i.e., Event Specification) to the specific Role(s) it applies to.

Relationships: Specifies Role applicability of Event Specification; Applies to Role.

Event Type 48: Event Type represents a mutually exclusive categorization of an Event Specification or an actual Event.

Relationships: Categorizes Event; Categorizes Event Specification.

Party Role Event 49: Party Role Event represents the relationship between a Party acting within a Role and an Event.

The relationship of a Party Role to an Event is said to indicate that an Event has occurred within the “Party Role Domain,” which means independent of any particular Solution or Product within a Solution (i.e., the other 2 domains being the “Solution Domain” and “Product Domain”).

The capturing and intelligent usage of “Party Role Domain” Events are an important means to realizing the “total Customer lifecycle management” goal of the BVN concept. For example, if a Customer indicates that they are getting, or just got, married, a Customer Manager may be able to respond by offering specialized marketing programs to the Customer.

Relationships: Involves Party Role; Specifies participants in Event.

Product Event 50: Product Event represents the association between a Product instance and an Event instance.

This entity captures “Product-level” (a.k.a., product domain) links of actual Events to the actual (Customized Logical) Products that they impact the delivery of.

Relationships: Resulted from Product; Identifies Event.

Solution Event 51: Solution Event represents the association between a Solution instance and an Event instance.

This entity captures “Solution-level” (a.k.a., Solution domain) links of actual Events to the actual Solution that they impact the processing of.

Relationships: Resulted from Solution; Identifies Event.

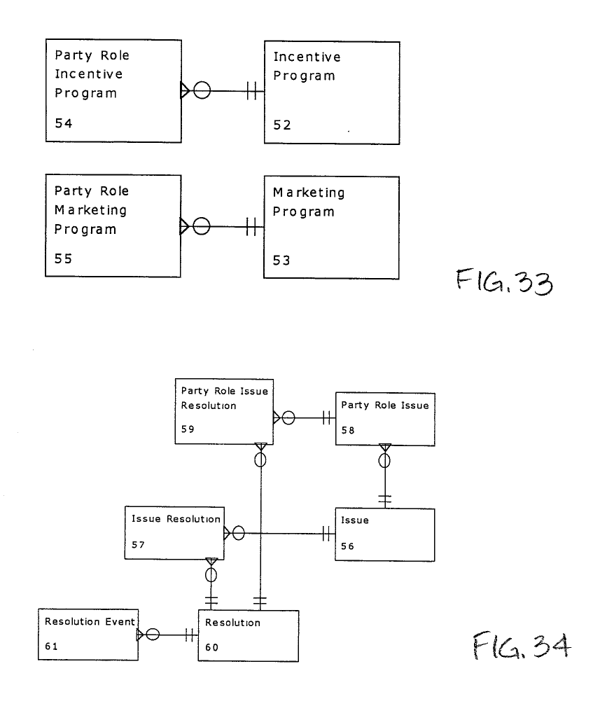

Referring to FIG. 33 the logical data model for Incentive and Marketing Programs is shown.

Incentive Program 52: Incentive Program represents a Customer Manager-specific campaign that is offered to Customers in an attempt to increase BVN Solution volumes.

Relationships: Associated with Party Role Incentive Program.

Marketing Program 53: Marketing Program represents a formal method of proactively marketing Products and Offerings to Customers at their request.

Relationships: Specified within Party Role Marketing Program.

Party Role Incentive Program 54: Party Role Incentive Program represents the association of a Party acting within a Role to an Incentive Program.

Relationships: Involves Party Role; Identifies Incentive Program.

Party Role Marketing Program 55: Party Role Marketing Program represents a relationship between a Party Role instance and a Marketing Program instance.

One use of this entity is to link the creator/administrator of a Marketing Program to that Marketing Program.

Another use of this entity is to link the user of a Marketing Program to that Marketing Program.

Relationships: Specifies as participant Party Role; Identifies Marketing Program.

Referring to FIG. 34 the logical data model for Issues and Resolutions is shown.

Issue 56: Issue represents a “template” of a problem that can arise during the provision of a Solution to a Customer, or independent of a particular Solution. Issues can be reported by Customers or network service providers.

The Issue entity does not have a corresponding “Specification” entity to serve as a “template” for the creation of actual Issues because they are not a part of the “core” BVN functionality. As such, Issue instances themselves are reused by linking them to Party Role instances (i.e., Party Role Issue) for non Solution-specific issues and Party Role Solution instances (i.e., Party Role Solution Issue) for Solution-specific issues. “Customized” Issue reporting is supported by linking the “Customized Issue” Issue instance to the appropriate Party Role instance (via Party Role Issue or Party Role Solution Issue) and providing a textual description of the non-standard issue.

Relationships: Resolved by Issue Resolution; Reported by or reports dispute with Party Role Issue.

Issue Resolution 57: Issue Resolution represents the relationship between a “template” Issue and a formalized “template” Resolution to that Issue.

This entity establishes standard “template” Issue to Resolution relationships. Actual Resolutions to actual Issues are captured within Party Role Issue Resolution (non-Solution-specific) and Party Role Solution Issue Resolution (Solution-specific).

Relationships: Resolves Issue; Specifies Resolution via Resolution.

Party Role Issue 58: Party Role Issue represents the relationship between a Party Role and an Issue, independent of a Solution.

There can be multiple reasons for linking a Party Role to an Issue. For example, an internal network participant can report an Issue that involves a Service Provider Manager. In this case, the internal network participant would be the Party Role that “reports” the issue and the Service Provider Manager would be the “reported” Party Role.

Relationships: Reported by or reports dispute with Party Role; Reports or is reported via Issue; Resolved by Party Role Issue Resolution.

Party Role Issue Resolution 59: Party Role Issue Resolution represents the provision of a Resolution to a non-Solution-specific Issue reported by a Party acting within a Role.

Relationships: Specifies Resolution of Party Role Issue; Resolved by Resolution.

Resolution 60: Resolution represents a discretely identified response to an Issue.

Relationships: Resolves Issue Resolution; Resolves Party Role Issue Resolution; Triggers Resolution Event.

Resolution Event 61: Resolution Event represents the relationship between a Resolution and an Event that it triggers.

Relationships: Is triggered by Resolution; Triggers Event.

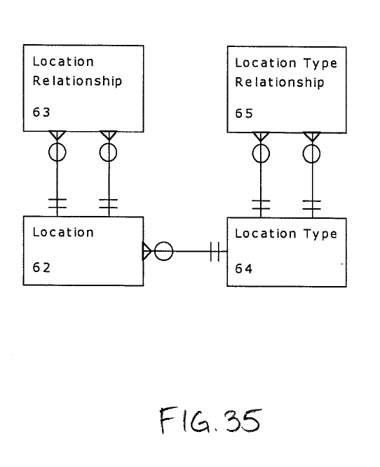

Referring to FIG. 35 the logical data model for Locations is shown.

Location 62: Location represents an internally or externally defined generic area, region, or zone of business interest to a Business Value Network. Also, Location includes identification of information necessary to communicate with someone, such as addresses, phone numbers and e-mail addresses. Locations can be assembled in a “building block” manner into higher-level Locations, if desired.

Relationships: Child Location Relationship; Parent Location Relationship; Categorized by Location Type.

Location Relationship 63: Location Relationship represents the relationship between two Locations. The nature of the relationship is also specified.

Relationships: Child Location; Parent Location.

Location Type 64: Location Type represents a categorization of geographic locations.

Relationships: Categorizes Location; Child Location Type Relationship; Parent Location Type Relationship.

Location Type Relationship 65: The geographic relationship between two Location Types. The nature of the relationship is also specified.

Relationships: Child Location Type; Parent Location Type.

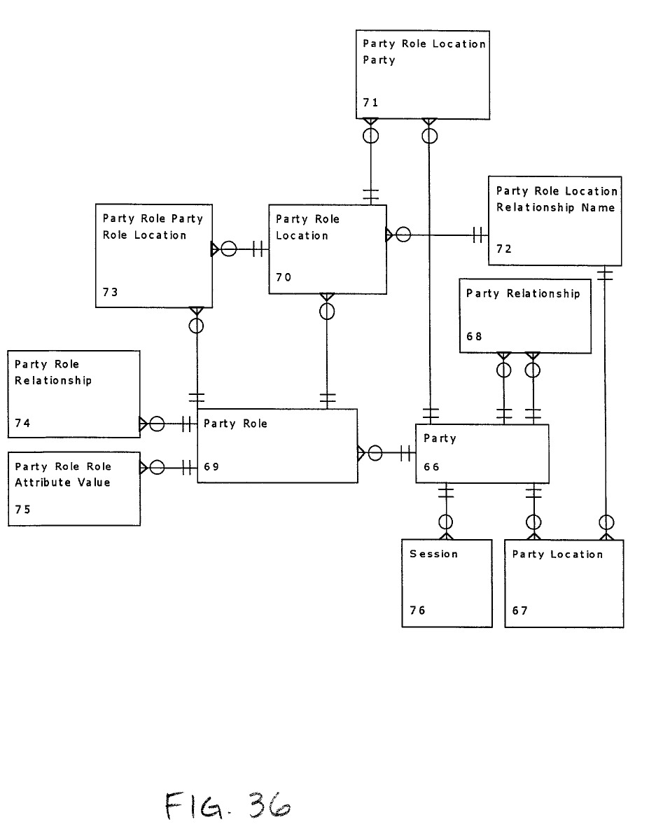

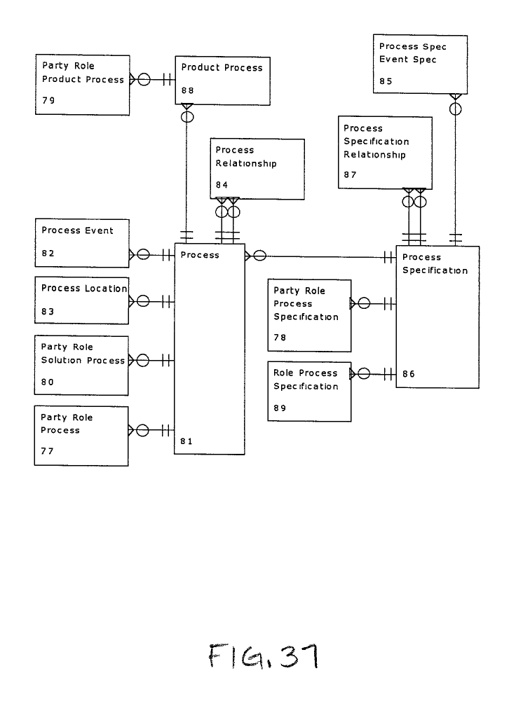

Referring to FIG. 36 the logical data model for Parties/Party Roles is shown.

Party 66: Party represents actual Individuals or Enterprises that are of importance to a Business Value Network. These parties may provide support or services to a BVN, use a BVN or establish and/or manage a BVN.

It is of critical importance to note that Parties exist independently of the Roles they may fulfill within a Business Value Network.

Relationships: Utilizes Party Location; Object in Party Relationship; Subject of Party Relationship; Fulfills Party Role; Associated with Party Role Location Party; Interacts with network via Session.

Party Location 67: Party Location represents the association of a Party to a Location. The nature of the relationship is also specified.

This entity is used to capture locations pertaining to parties that are relevant to a BVN outside of the context of specific Roles. For example, the email address or phone number of a “contact person” for a network participant can be captured using this entity.

Party Location can also be used to allow Network Participants to specify Location-related information independent of any Roles they may assume within a BVN. These Parties can then select from these “predefined” Locations to apply them within the context of specific Roles they fulfill.

Relationships: Is used by Party; References Location; Classified by Party Role Location Relationship Name.

Party Relationship 68: The relationship between two parties independent of any Roles the two parties may be playing within a BVN.

One use of this entity is to relate a contact person for a network participant (i.e., enterprise) to the network participant, outside of the context of any Roles.

Relationships: Specifying as object Party; Specifying as subject Party; Classified by Role Relationship Relationship Name.

Party Role 69: Party Role represents the assignment of a Party to a Role independently of any specific Solutions. This assignment serves as the “pre-enrollment” of Parties into the Roles they will be capable of fulfilling within a Business Value Network (e.g., during the configuration or delivery of Solutions).

Both internal providers of services and external users (e.g., Customers) of a BVN are assigned to Roles.

Relationships: Fulfilled by Party; Acting as Role; Located at Party Role Location; Associated with Party Role Party Role Location; Subject Party Role Relationship; Specified in Party Role Role Attribute Value.

Party Role Location 70: Party Role Location represents the assignment of a Party, acting within a specific Role, to a Location. The nature of the relationship is also specified.

Relationships: Locates Party Role; Associated with Party Role Location Party; Classified by Party Role Location Relationship Name; Used by Party Role Party Role Location.

Party Role Location Party 71: Party Role Location Party represents the relationship between a Party Role Location and a Party (independent of a Role).

One usage of this entity is to relate a “contact person” (Party) to a location of another party within the context of a specific Role (Party Role Location) played by that party.

As an example, an Enterprise in the Role of “Customer” may have a specific contact person for their “billing” location.

A constraint on the usage of this entity is that the associated Location must be of the “Postal Address” type.

Relationships: Identified by Party; Identified by Party Role Location.

Party Role Location Relationship Name 72: Party Role Location Relationship Name represents a classification of the relationship between a Party acting within a Role and a Location.

Relationships: Classifies Party Location; Classifies Party Role Location.

Party Role Party Role Location 73: Party Role Party Role Location represents the relationship between a Party acting within a Role (Party Role) and another Party acting within a Role in a relationship to one of their locations (Party Role Location).

Relationships: Referenced by Party Role; Uses Party Role Location.

Party Role Relationship 74

Party Role Relationship represents an association between two Parties within their respective Roles. The nature of the relationship is also specified (via the Party Role Relationship Re1 Name entity).

Party Role Relationships can be between two Individual parties (e.g., spouse), two Enterprise parties (e.g., some type of business relationship) or an Enterprise and Individual party (e.g., employer “employs” employee). (See the Party Role Relationship Re1 Name entity for details.) Relationships: Subject Party Role; Object Party Role; Classified by Role Relationship Relationship Name.

Party Role Role Attribute Value 75: Party Role Role Attribute Value represents the association between a Party acting within a Role and a characteristic that pertains to the party within that Role (i.e., via a “dynamic” Role Attribute Value).

Relationships: specification of characteristic for Party Role; Specification of a characteristic via Role Attribute Value.

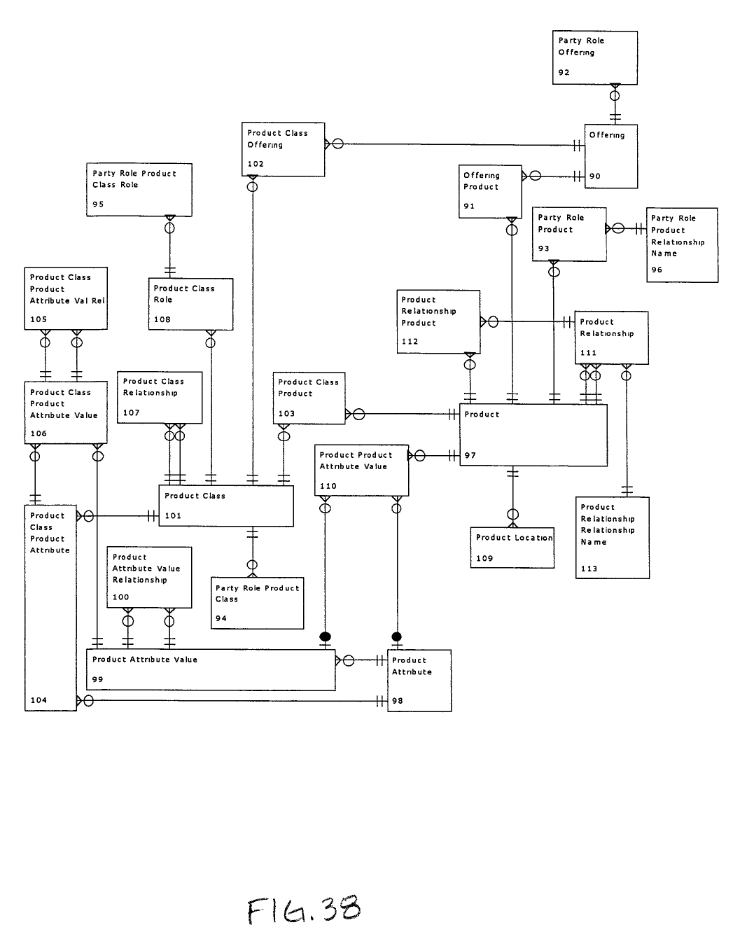

Referring to FIG. 37 the logical data model for Processes is shown.

Session 76: Session represents a User's active “online” interaction with a BVN through its user interface. Both Customers and internal network participant individuals can participate in Sessions.

Relationships: Tracks network interaction for Party.

Party Role Process 77: Party Role Process represents the association between an instance of a Party within a Role and a Process instance.

One use of this entity is to specify Processes that are required to be performed at a “Party Role-level” (a.k.a., within the Party Role “domain”, meaning independent of any Solution). This entity may also be used to relate a Party within a Role to those Processes they're responsible for within the context of delivering a Solution.

Relationships: Specifies performance by Party Role; Specifies performance of Process.

Party Role Process Specification 78: Party Role Process Specification represents the relationship between a Party acting within a Role and a Process Specification.

One use of this entity is to identify who is responsible for defining and maintaining a Process Specification or who uses a given Process Specification within the network.

Relationships: Used by Party Role; Usage of Process Specification.

Party Role Product Process 79: Party Role Product Process represents the association of a Party within a Role to a Process required for delivery of a Product.

One use of this entity is for the “reassignment” of a Process for a Customized Logical Product to a new Service Provider (which could be due to “defaulting” on the execution of a process or a proactive process reassignment).

Relationships: Performed by Party Role; Performs Product Process.

Party Role Solution Process 80: Party Role Solution Process represents the association of a Party within a specific Role to a “Solution-level” Process needing to be performed to deliver a Customer's Solution.

Relationships: Performed within the context of Party Role Solution; Specifies Solution-level performance of Process.

Process 81: Process represents the tasks requiring execution by Parties, acting within specific Roles, to provide a Solution to a Customer.

A Process can only be performed by one high-level Role (the Process can also be linked to other Roles as long as they are “Children” of the “Parent” high-level Role). This simple, and vitally important, rule inherently brings integrity and simplicity, while eliminating redundancy and ambiguity, to a Business Value Network. A Party can play multiple Roles, and thus perform many Processes, within a single Solution. This flexibility allows the BVN infrastructure (e.g., Role assignment, settlement and billing) to be established in a highly efficient and standardized manner, and easily adapt to new Role/Process requirements (i.e., new Roles/Processes can easily be added into the existing framework and Service Providers are simply registered into the new Roles as required).

Relationships: Performed by Party Role Process; Performed at Solution-level via Party Role Solution Process; Triggered by or triggers Process Event; Performed at Process Location; Child Process Relationship; Parent Process Relationship; Created from Process Specification; Delivers Product Process.

Process Event 82: Process Event represents the relationship between a Process instance and an Event instance that it generated.

Relationships: Triggered by or triggers Process; Triggered by or triggers Event.

Process Location 83: Process Location represents the association of a Process instance to a Location instance.

One use of this entity is to capture location-specific requirements (e.g., states, addresses, etc.) for the execution of certain processes in the delivery of a Product within a Solution.

Relationships: Specifies location to perform Process; Performed at Location.

Process Relationship 84: Process Relationship represents the relationship between two Processes, such as, a Parent process's decomposition into “sub-processes”.

Relationships: Identifies as the Child Process; Identifies as the Parent Process.

Process Specification Event Spec 85: Process Specification Event Specification represents the relationship between a Process Specification instance and an Event Specification instance that it can generate.

Relationships: Triggered by or triggers Process Specification; Triggered by or triggers Event Specification.

Process Specification 86: A Process Specification represents a “template” Process that can be used to create actual Process instances of that type.

Relationships: Used by Party Role Process Specification; A template for Process; Triggered by or triggers Process Spec Event Spec; Child Process Specification Relationship; Parent Process Specification Relationship; Performed by Role Process Specification.

Process Specification Relationship 87: Process Specification Relationship represents the relationship between two Process Specifications, such as a “Parent” process specification's decomposition into “subordinate” process specifications.

Relationships: Specifies as Child Process Specification; Specifies as Parent Process Specification.

Product Process 88: Product Process represents the association of a (Customized Logical) Product to the Processes required to be performed (by parties within roles) to deliver it.

This entity provides a Role-independent view of all Processes to be performed for a Product.

Relationships: Performed by Party Role Product Process; Delivers Product; Delivered by Process.

Role Process Specification 89: Role Process Specification represents the relationship between a Role instance and a Process Specification instance.

This entity establishes the “template” of Processes that must be performed by a Role at a “Solution-level” (e.g., by a Solution Broker) or at a “Product delivery-level” (i.e., by a Service Provider) within a Solution.

This table is also used by the BVN security function to establish BVN Command execution authority by Role.

Relationships: Is performed by Role; Specifies performer of Process Specification.

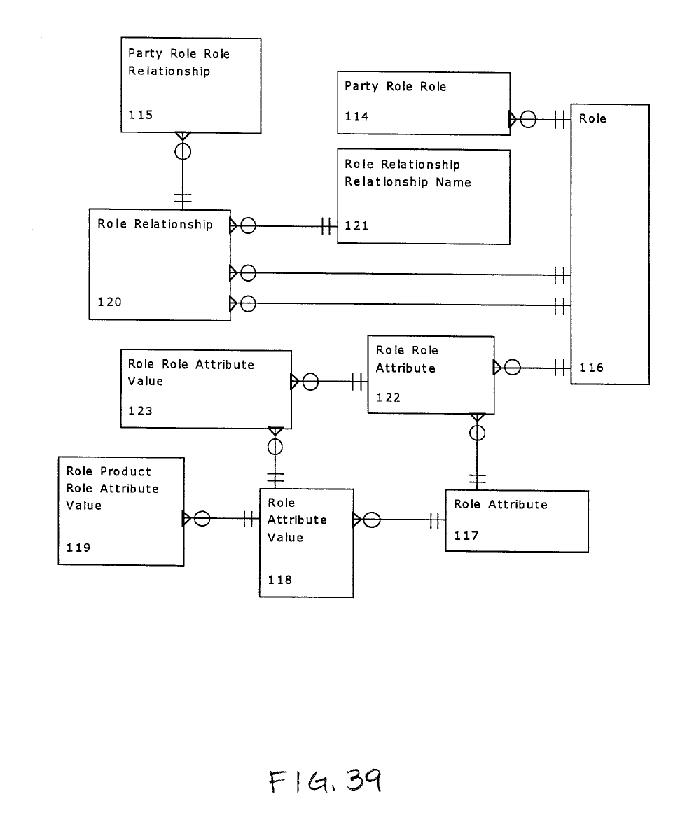

Referring to FIG. 38 the logical data model for Products is shown.

Offering 90: Offering represents a pre-defined package of one or more Products that can be used as a vehicle for conveniently selling multiple products to a Customer within a Business Value Network.

It should be noted that once an Offering is selected by a Customer, the Products within the Offering are individually submitted to the Trading Markets for trading (i.e., they are not traded as a product bundle”).

Relationships: Defined by Offering Product; Offered by Party Role Offering; Used in Product Class Offering.

Offering Product 91: Offering Product represents the relationship between an Offering and the Product(s) that are bundled (i.e., offered) within it.

Relationships: Defines Offering; Includes Product.

Party Role Offering 92: Party Role Offering represents the relationship between a Party within a Role and an Offering. One use of this entity is to identify the Party Role that created a given Offering.

Relationships: Specifies offering by Party Role; Specifies offering of Offering.

Party Role Product 93: Party Role Product represents the relationship between a Party within a Role and a Product.

Party Role Product has several uses

A “Customer Ongoing Product Need” links a Customer to a Predefined Logical Product to establish an “ongoing” need. This ongoing need will periodically (and automatically) trigger the creation of Solutions (containing Customized Logical Products based on these Predefined Logical Products) for the Customer.

A “Service Provider Product Offer” links a Service Provider to a Predefined Logical Product that they are “posting” to the Business Value Network to make it available directly to Customers or to Solution Brokers trying to satisfy their Customers' needs.

A “Service Provider Product Search Criteria” represents the association between a “Service Provider” Party Role instance and a (Predefined Logical) Product instance used to define the Service Provider's search criteria against Customer's (Customized) Logical Products that are posted to the “Posting” Trading market. A Service Provider may define several “search criteria” with varying characteristics.

A “Service Provider Product Negotiation” is used within the “Negotiation” Trading Market to “invite” a specific Service Provider to participate in a negotiation with a Customer for one of the Customer's (Customized) Logical Product needs. The Service Provider is initially linked to the Customer's Customized Logical Product in an “Invited” status.

A Party within a Role may also be linked to a Product offered or counteroffered during a trading session.

Relationships: Is classified by Party Role Product Relationship Name; Identifies Party Role; Assigns Product.

Party Role Product Class 94: Party Role Product Class represents the relationship of a Party acting within a Role to a Product Class instance.

One use of this entity is to link a Party within the Role of Market Manager to a Product Class for the purpose of defining the types of Products offered within that Market Manager's market.

Of special note is the fact that the Market Manager can specify a Product Class as “Core” (provided internally), “Non-Core” (provided by an external network) or “Both” (the class of products is provided both internally and externally by another network).

Another use is to link a Customer to the Product Classes they've purchased Products within to establish an ongoing marketing profile.

Relationships: Identifies Party Role; Specifies Product Class.

Party Role Product Class Role 95: Party Role Product Class Role represents the relationship between a Party acting within a Role and a pre-defined Product Class Role assignment.

One use of Party Role Product Class Role is to define, by Market Manager or Service Provider Manager (Party Role), standard charges to be assessed to (Service Provider) Roles when delays occur in delivering a Customer's Product (Product Class Role).

Relationships: Defined by Party Role; Defines Product Class Role.

Party Role Product Relationship Name 96: Party Role Product Relationship Name represents a classification of the relationship between a Party acting within a Role (Party Role) and a Product instance.

The types of Party Role Product relationships that are captured within this entity are: needs;

offers; accountable; invited to offer on; rejects to offer on; executes; retrades; reassigns; and routed to.

Relationships: Classifies Party Role Product.

Product 97: Product represents a singular product or service item that can be traded (within the Trading markets) and sold as part of a Solution to a Customer within a Business Value Network.

Product is subtyped into “Logical” and “Physical” products.

Logical Products are abstract representations of Physical Products or Services that can be created by a Customer to express their needs or a Service Provider to provide offers to Customer needs without knowing or specifying actual Physical Products or Physical Product attributes. This allows many Physical Products to be grouped under a common Logical Product, which improves a Solution Broker's ability to (as quickly as possible) assess a wide variety of options for meeting a Customer's needs via a customized Solution.

BVNs whose Products are actually “Services” will not utilize the notion of a “Physical” Product. Physical Products are used to represent true “commodities”, with attributes such as serial number, UPC Code, etc.

Logical Products may also need to be constructed in real-time by a Customer (or possibly a Solution Broker if requested by the Customer), based on a Customer's indicated attribute-level “logical” needs, for presentation to the Trading markets.

Product is subtyped as follows: Logical Product—abstract product definition; Predefined Logical Product—“canned”, reusable abstract product definitions that serve as “templates” for creation of Customized Logical Products; Customized Logical Product —Solution-specific instance of a Logical Product (can be based on a Predefined Logical Product or constructed in “real-time” from a collection of attributes); or Physical Product—an actual inventoried commodity with a serial number and/or UPC Code, etc.

Relationships: Included in Offering Product; Assigned to Party Role Product; Classified by Product Class Product; Delivered to Product Location; Described by Product Product Attr Value; Child Product Relationship; Parent Product Relationship; Included in Product Relationship Product.

Product Attribute 98: Product Attribute represents a characteristic, which is used to define the features of a Product (Logical or Physical). These characteristics are also assigned specific values (within Product Attr Value) to define, for example, a Customer's needs or Service Provider's offers.

Product Attributes can represent characteristics that are both generic in nature (apply to all products that are defined) and specific to a certain type of product (i.e., product class).

Examples of generic attributes are: standard price amount, timeframe unit description, timeframe quantity, actual price amount, original price amount and due date.

Relationships: Assigned Product Attr Value; Describes Product Class Product Attribute; Specified in Product Product Attr Value.

Product Attr Value 99: Product Attr Value (“Product Attr Value”) represents a value assigned to a Product Attribute that serves as a mechanism of specifying the characteristics of Products. It is the vehicle through which Customer Logical Product needs are mapped to Service Provider Products.

Relationships: Assigned to Product Attribute; Child Product Attr Value Relationship; Parent Product Attr Value Relationship; Specifies attribute values for Product Class Product Attr Value; Describes Product Product Attr Value.

Product Attr Value Relationship 100: Product Attr Value Relationship represents an association between two instances of Product Attr Value.

One usage of Product Attr Value Relationship is to allow a “Logical” Product Attr Value to be related to multiple “Physical” Product Attr Values. This provides a mechanism for isolating Customers from specific Physical Product characteristics that they may not be familiar with.

In specifying their needs, Customers will have the option of utilizing high-level attribute values (novice users) or very specific values (advanced users).

Relationships: Child Product Attr Value; Parent Product Attr Value.

Product Class 101: Product Class represents a general categorization of products or services, which serves as a vehicle for logically grouping product or service characteristics. Product Classes establish frameworks for the definition of individual products.

Product Classes can have relationships to other Product Classes in a hierarchical manner to facilitate “drilling down” within Product Classes.

Product Classes with characteristics (attributes) assigned to them must also have a “Service Provider” Role assigned to them that is responsible for providing actual Products defined via a given Product Class.

Relationships: Specified in Party Role Product Class; Used in Product Class Offering; Classifies Product Class Product; Described by Product Class Product Attribute; Child Product Class Relationship; Parent Product Class Relationship; Delivered by Product Class Role.

Product Class Offering 102: Product Class Offering represents the relationship between a Product Class and an Offering instance.

This entity's primary function is to define the Product Classes within which an Offering can be offered to a Customer.

Relationships: Uses Offering; Uses Product Class.

Product Class Product 103: Product Class Product represents the relationship between a Product Class and the Product(s) that are categorized within Relationships: Classifies Product; Classified by Product Class.

Product Class Product Attribute 104: Product Class Product Attribute represents the association of a Product Attribute to a Product Class it describes. Product Attributes are assigned to Product Classes to establish a “clearing house” of available attributes to Logical Products defined within that Product Class. Some of these attributes may be mandatory, i.e., they have to have a value assigned (via Product Attr Value) for each Logical Product defined within the Product Class. Some of these attributes may also be an “output” (i.e., produced as a result of delivery of the product (or service)), as opposed to “input”.

Relationships: Is described by Product Attribute; Describes Product Class; Has attribute values specified by Product Class Product Attr Value.

Product Class Product Attribute Val Re1 105: Product Class Product Attr Value Relationship represents the specification of valid attribute value combinations based on a pair of Product Classes being selected.

This entity establishes cross-Product Class, attribute value-level dependencies.

Relationships: Specifies as the object Product Class Product Attr Value; Specifies as the subject Product Class Product Attr Value.

Product Class Product Attr Value 106

Product Class Product Attr Value represents specific values of attributes that are available for a Product Class.

Relationships: Has attribute values specified by Product Attr Value; Specifies attribute values for Product Class Product Attribute; The object of Product Class Product Attribute Val Rel; The subject of Product Class Product Attribute Val Rel.

Product Class Relationship 107: Product Class Relationship represents an association between two instances of Product Class.

The three basic types of relationships between Product Classes are: “Parent,” “Prerequisite” and “Neighboring Need.” (“Neighboring Need” being when one Product Class has an affinity to another for potential marketing purposes.) Relationships: Child Product Class; Parent Product Class.

Product Class Role 108: Product Class Role represents a relationship between a Product Class and a Role.

One use of Product Class Role is the assignment of Roles to Product Classes to facilitate the offering of Customers' needs (via Customized Logical Products) to the Trading markets within a Business Value Network. Specifically, a Customer's Customized Logical Products are also cross-referenced to their Product Class, which allows Product Class to serve as a “logical bridge” between Roles and the Customer's product needs. The Solution Broker then offers the products to the appropriate BVN Service Provider Roles within the Trading markets.

Relationships: Defined by Party Role Product Class Role; Delivers Product Class; Delivered by Role.

Product Location 109: Product Location represents the association of a Location instance with a Product instance.

One use of this entity may be the association of a delivery or “service execution” address with a specific Customized Logical Product. This provides the capability of specifying a different Location for each Product within a Solution.

Relationships: Specifies location to deliver Product; References Location.

Product Product Attr Value 110: Product Product Attr Value represents the association between a Product Attribute or a Product Attr Value instance and a Product instance.

If a Product Attr Value was “selected”, the foreign key to Product Attr Value applies. If a Product Attr Value was “entered”, the foreign key to Product Attribute applies.

The Products tied to Product Attr Values can be Logical or Physical, and they can share Product Attr Values as well. For example, an advanced user may want to specify “physically-oriented” attributes in the definition of his “logical” product to ensure his requirements will be met precisely.

The “selected” value for a Product Attribute will be stored on the Product Product Attr Value table.

Relationships: Describes Product; Specifies Product Attribute; Is described by Product Attr Value.

Product Relationship 111: Product Relationship represents an association between two instances of Product. The nature of the relationship is also specified.

Examples of product relationships are the creation of Customized Logical Products from their “template” Predefined Logical Products; the linking of Customized Logical Products with delivery dependencies (i.e., one Product must be delivered before another); and the mapping of Physical Products to Customized Logical Products. (See the “Product Relationship Relationship Name” entity for a complete set of product relationships).

An optional foreign key relationship to the “Role Product Trading Session” entity exists, which applies to Product Relationship instances that represent a counteroffer (i.e., “is a counteroffer on” relationship name) on a previous offer within a trading session.

Relationships: Child Product; Parent Product; Includes Product Relationship Product; Classified by Product Relationship Relationship Name.

Product Relationship Product 112: Product Relationship Product represents the association of a pair of Product instances to another Product instance.

One use of this entity is to represent the offering or counter-offering of an “additional” Product by a Service Provider or Customer within a trading session.

Relationships: Includes Product; Included in Product Relationship.

Product Relationship Relationship Name 113: Product Relationship Relationship Name represents a classification of the relationship between two Product instances.

The valid classifications are: is created from; maps to; sold via; offers on; Customer needs marketing link to; provides current info for, is prerequisite of; and, is counteroffer of.

Relationships: Classifies Product Relationship.

Referring to FIG. 39 the logical data model for Roles is shown.

Party Role Role 114: Party Role Role represents the relationship between a Party within the context of a Role and another Role.

One use of this entity is to allow Market Managers (Party Role) to establish their standard usage of Roles defined within a given BVN (as well as standard Product and/or Solution-level commissions for those Roles).

Relationships: Utilized by Party Role; Utilizes Role.

Party Role Role Relationship 115: Party Role Role Relationship represents the relationship between a Party, acting within a Role, and a pair of Roles (i.e., Role Relationship instance).

One use of this entity is to capture Market Manager-specific Role relationship (configuration) customizations within a BVN.

Relationships: Used by Party Role; Uses Role Relationship.

Role 116: Role represents “classifications” that encompass a discrete set of responsibilities (processes), behaviors, and characteristics, which can be assumed by parties within a Business Value Network. This allows the more complex processes to be analyzed and then “chunked up” into meaningful Roles. Work can then be allocated at the “Role-level,” rather than process-level.

A key aspect of the Business Value Network concept is the separation of Parties from the Roles that they can fulfill within a BVN. This provides a high degree of flexibility and integrity to a BVN implementation because a Party can easily be enrolled to play new Roles (flexibility) without duplicating information that is independent of any specific Role (integrity).

Even more important, however, is the capability that Role provides in defining sets of Processes at a “logical,” rather than “physical” level. Processes associated with a core competency are assigned to a Role (logical), which role is played by many Parties. This is in contrast to the less flexible (and maintainable) option of assigning Processes directly to actual Parties (physical).

The primary “generic” Roles within a Business Value Network are: Customer, Customer Referral Provider, Solution Broker, Service Provider, Customer Manager, Service Provider Manager, Market Manager and BVN Manager.

Other generic Roles include Consumer (user of a product) and Bill Payer.

Each of these Roles may be decomposed into “Sub-Roles” with their own “lower-level” responsibilities. The Service Provider Role, in particular, will be the focal point of decomposition into sub-roles as they represent the value-added “core competencies” within a given industry.

Relationships: Utilized by Party Role Role; Object Role Relationship; Subject Role Relationship; Characterized by Role Role Attribute.

Role Attribute 117: Role Attribute represents user-defined characteristics.

Relationships: Has values specified via Role Attribute Value; Characteristic in Role Role Attribute.

Role Attribute Value 118: Role Attribute Value represents a specific discrete value that can be assigned to a Role Attribute, independent of any specific Role that may utilize the Role Attribute.

Relationships: Specifies values for Role Attribute; Specifies service provider criteria for Role Product Role Attribute Value; Specifies criteria for Role Role Attribute Value.

Role Product Role Attribute Value 119: Role Product Role Attribute Value represents the association of a Role Product instance to a Role Attribute Value instance.

One use of this entity is for a Customer to specify criteria for Service Providers that are candidates for providing a Customer's Logical Product within the Trading Markets.

Relationships: Specifies service provider criteria for Role Product; Has service provider criteria specified Role Attribute Value.

Role Relationship 120: Role Relationship represents the relationship between two Roles. The nature of the relationship is also specified (see the “Relationship Name” attribute description for a list of valid relationship types).

Relationships: Used by Party Role Role Relationship; Object Role; Subject Role; Classified by Role Relationship Relationship Name.

Role Relationship Relationship Name 121: Role Relationship Relationship Name represents a classification of the relationship between two instances of Role and/or Party Role.

Party Role Relationships can be between two Individual parties (e.g., spouse), two Enterprise parties (e.g., some type of business relationship), or an Enterprise and Individual party (e.g., employer “employs” employee).

Relationships: Classifies Role Relationship.

Role Role Attribute 122: Role Role Attribute presents the association between a Role and the Role Attributes that are available to characterize it.

Relationships: Characterization of Role; Characterization using Role Attribute; Has values specified via Role Role Attribute Value.

Role Role Attribute Value 123: Role Role Attribute Value represents the association between a Role Attribute Value and a Role.

Relationships: Has criteria specified via Role Attribute Value; Value specification for Role Role Attribute.

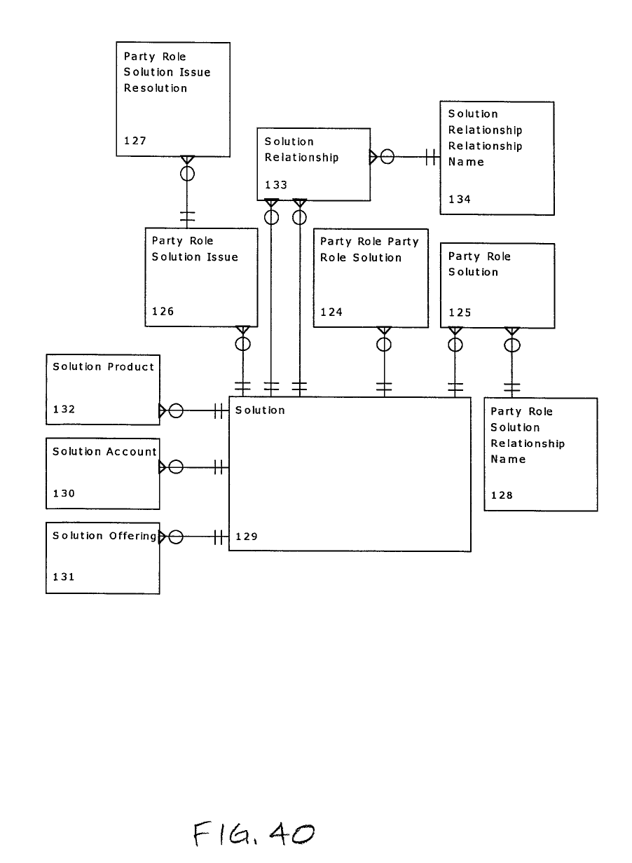

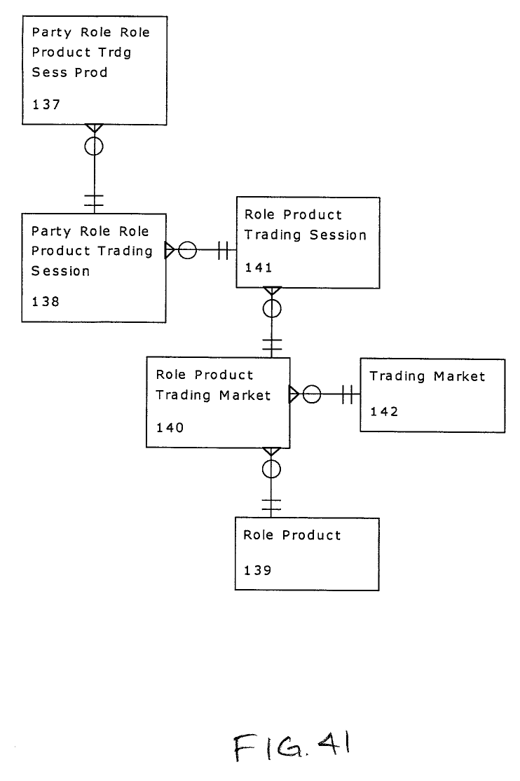

Referring to FIG. 40 the logical data model for Solutions is shown.

Party Role Party Role Solution 124: Party Role Party Role Solution represents the association between two instances of Party Role (i.e., two parties acting within roles) and a Solution.

One usage of Party Role Party Role Solution is the reporting of Customer and Service Provider satisfaction with (other) Service Providers involved in the delivery of a Solution to a Customer.

Relationships: Created by Party Role; Identifies as the subject Party Role; Identifies Solution.

Party Role Solution 125: Party Role Solution represents the association of a Party within a specific Role to a Solution. The nature of the relationship is also specified (see the Party Role Solution Relationship Name entity for details).

Relationships: Classified by Party Role Solution; Relationship Name; Involves Party Role; Identifies participants in Solution.

Party Role Solution Issue 126: Party Role Solution Issue represents the reporting of a Solution-specific Issue by a Party, acting within a Role, which was related to the Solution in some manner.

It may be necessary to explicitly provide Issue reporting at a Product within Solution level.

Relationships: Resolved by Party Role Solution Issue Resolution; Captured for Party Role; Captures issues for Solution; Captures Issue.

Party Role Solution Issue Resolution 127: Party Role Solution Issue Resolution represents the provision of a Resolution to a Solution-specific Issue reported by a Party acting within a Role.

Relationships: Specifies Resolution of Party Role Solution Issue; Resolved by Resolution.

Party Role Solution Relationship Name 128: Party Role Solution Relationship Name represents a classification of the relationship between a Party, acting within a Role, and a specific Solution instance.

Relationships: Classifies Party Role Solution.

Solution 129: Solution represents a collection point for one or more (Customized Logical) Products. There are three different types of Solutions that can be created within a Business Value Network: 1) Customer Needs Solution—created by a Customer to represent their logical product needs to the network; 2) Service Provider Proposal Solution—created by a Service Provider to bundle two or more products into a composite offer to a Customer based on their needs; 3) Solution Option Solution—created by a Solution Broker to assemble traded products into feasible Solution options for the Customer. The Solution options can include products from several different service providers.

Relationships: Associated with Party Role Party Role Solution; Involves Party Role Solution; Has issues captured via Party Role Solution Issue; Paid for via Solution Account; Built from Solution Offering; Bundles Solution Product; Child Solution Relationship; Parent Solution Relationship.

Solution Account 130: Solution Account represents the usage of a specific Account(s) to pay for the products provided within a Solution.

Relationships: Specifies payment method for Solution; Specifies payment via Account.

Solution Offering 131: Solution Offering represents the relationship between a specific Customer's Solution and an Offering(s) that was used in constructing it.

Relationships: Built from Offering; Builds Solution.

Solution Product 132: Solution Product represents the linking of Customized Logical Products to a Solution. Thus a Solution serves as a “product bundle” for the purposes of product trading, post-trading product assembly, and delivery.

Relationships: Sold within Solution; Bundles Product.

Solution Relationship 133: Solution Relationship represents the association between two instances of Solution. The nature of the relationship is also specified (see the “Solution Relationship Relationship Name” entity for details).

Relationships: Child Solution; Parent Solution; Classified by Solution Relationship Relationship Name.

Solution Relationship Relationship Name 134: Solution Relationship Relationship Name represents a classification of the relationship between two Solution instances.

The types of Solution relationships that are captured within this entity are: “is part of,” “offer for” and “option for.”

Relationships: Classifies Solution Relationship.

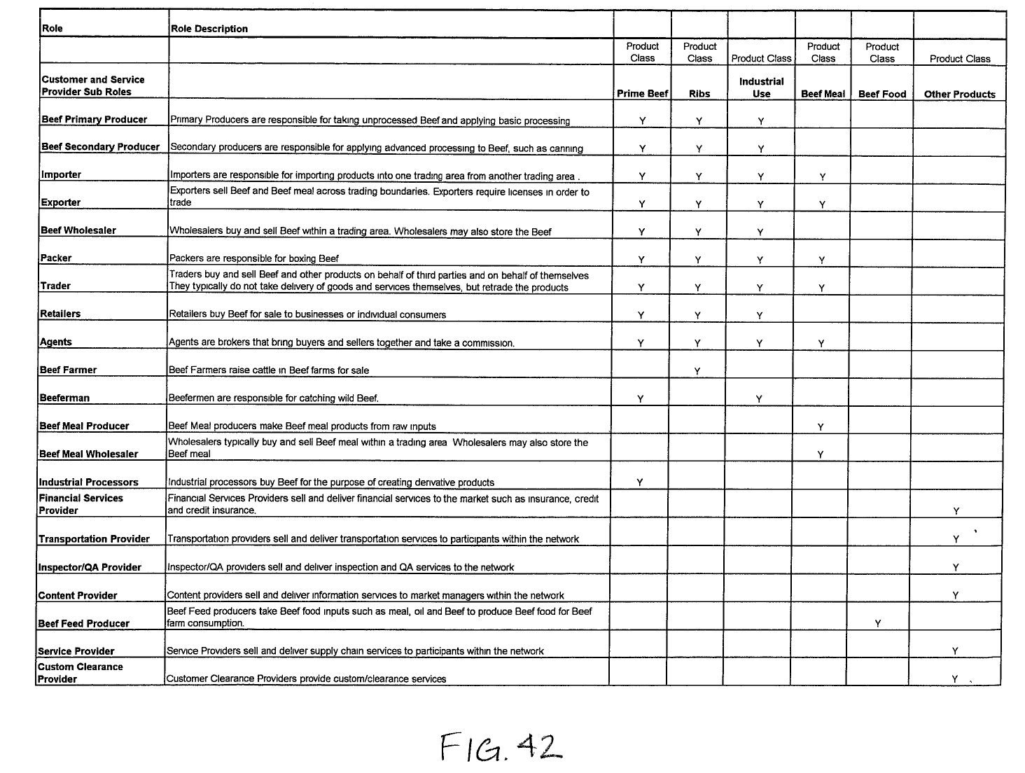

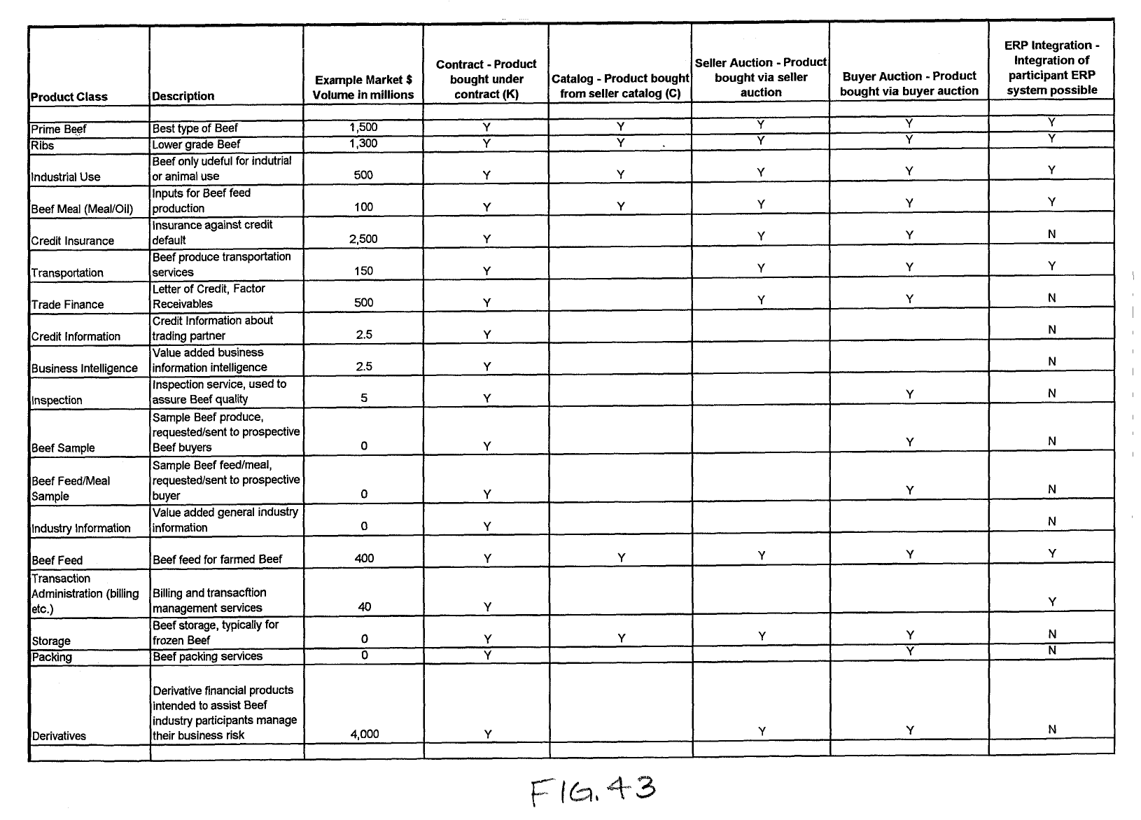

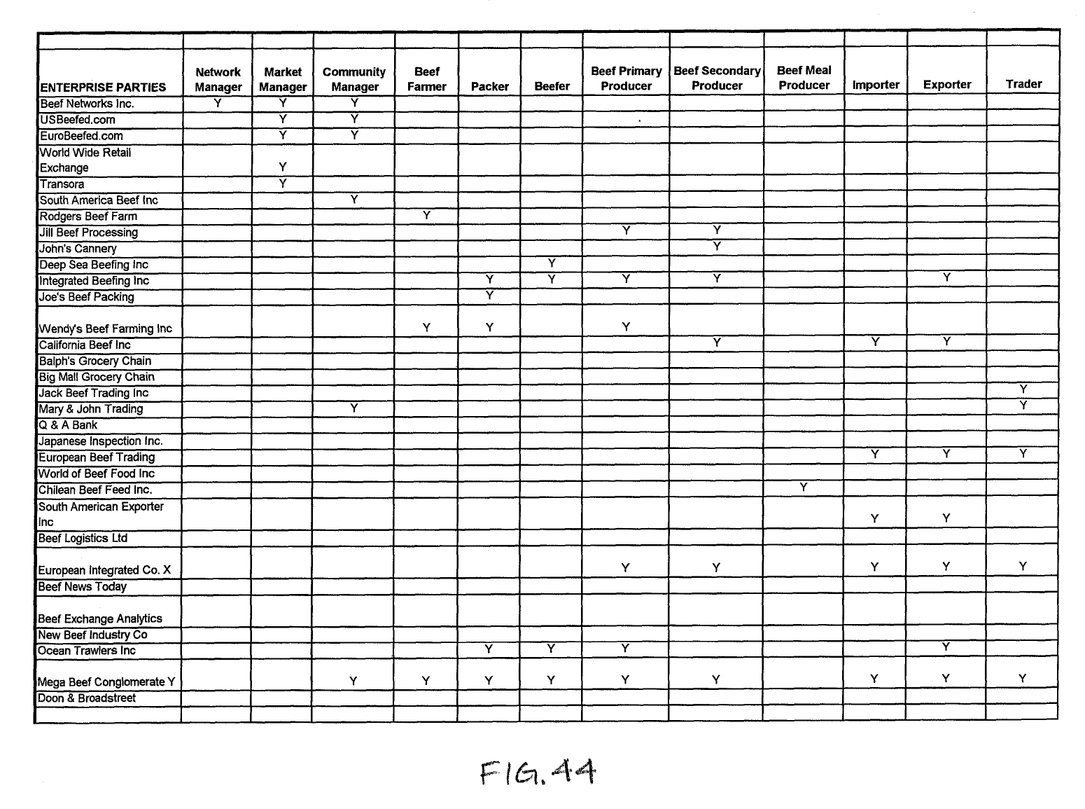

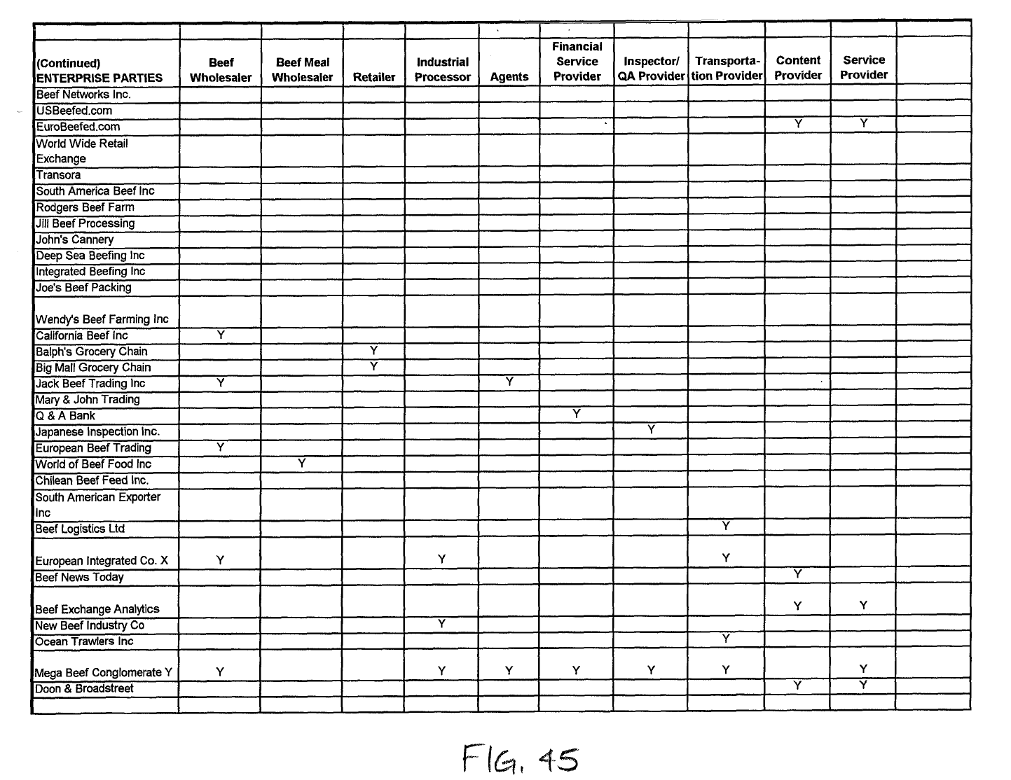

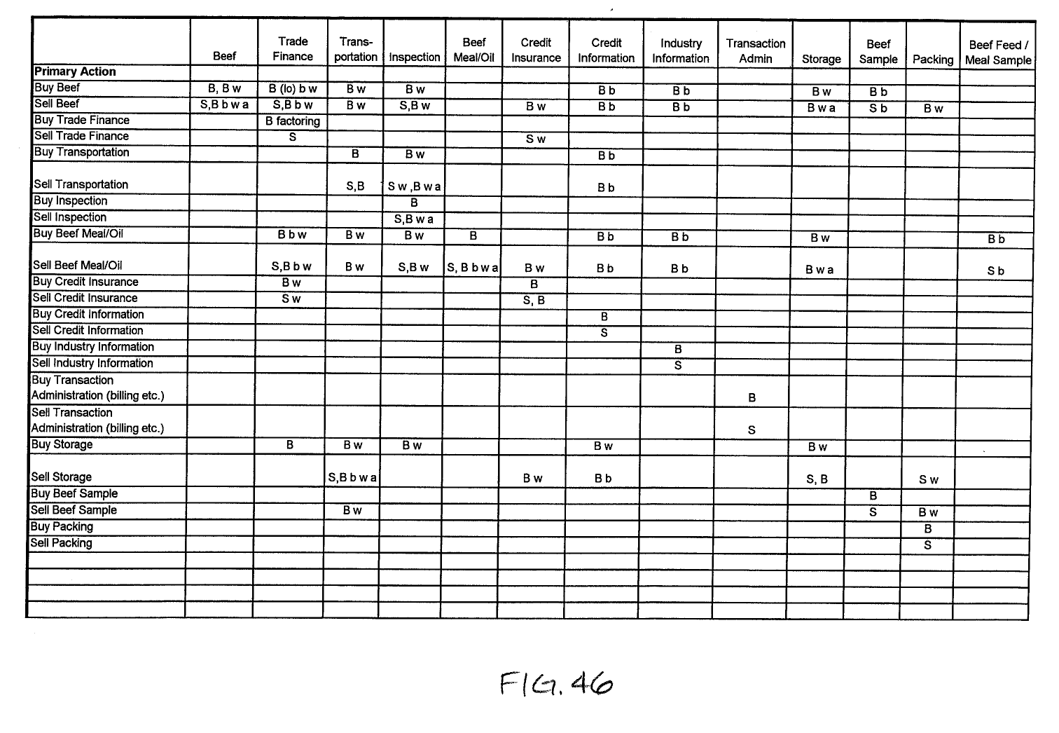

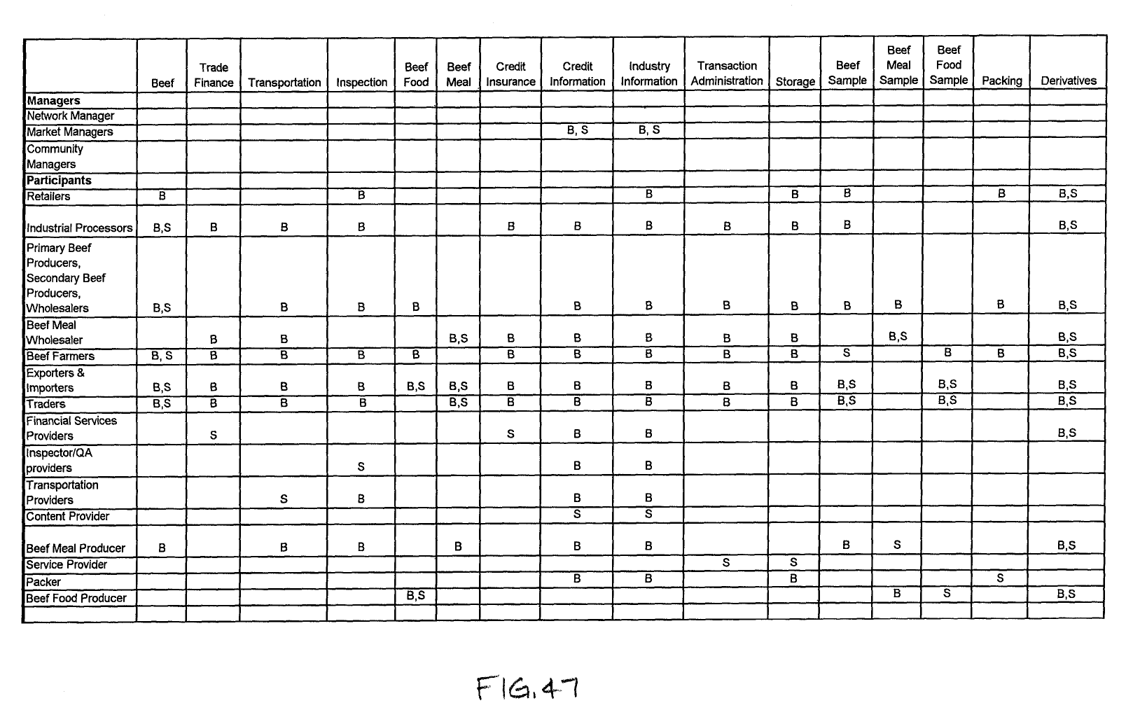

Referring to FIG. 41 the logical data model for Trading Markets is shown.

Party Role Role Product Trading Session 137: Party Role Role Product Trading Session represents the involvement of a Party, acting within a Service Provider Role, in a trading session to make offers on a Customer's logical product need. The Customer is also linked to the trading session.

Relationships: Has counteroffer specified via Party Role Role Product Trdg Sess Prod; Participated in by Party Role; Participates in Role Product Trading Session.

Party Role Role Product Trdg Sess Prod 138: Party Role Role Product Trading Session Product represents the offering or counteroffering of an additional Product by a Service Provider to a Customer within a trading session.

The “additional” product (as opposed to the one that is matched against a Customer's product need) allows offering/counteroffering with products, rather than solely based on price or product characterisitcs.

Relationships: Specifies counteroffer for Party Role Role Product Trading Session; Specifies as a counteroffer Product.

Role Product 139: Role Product represents the relationship between a Role and a Product.

One use of Role Product is the linking of a Customer's Customized Logical Product to the (Service Provider) Role that is responsible for accepting/offering on it (during Trading) and providing it (during Solution Delivery).

Relationships: Traded within context of Role; Provides context for trading of Product; Has service provider criteria specified Role Product Role Attribute Value; Traded within Role Product Trading Market.

Role Product Trading Market 140: Role Product Trading Market represents the association between an instance of Role Product and an instance of Trading Market.

One use of Role Product Trading Market is to allow a Customer to choose the Trading Markets that he/she wishes their (Customized) Logical Product(s), by Role, to be “traded” within (any combination of markets can be selected).

The Vision BVN Architecture supports the concept of sophisticated Customers being able to “decompose” a “Primary” Role into sub-Roles (stored within the “Role Relationship” entity). This allows a Customer to “keep” responsibility for certain sub-Roles, while trading other sub-Roles within the Trading Markets.

Relationships: Specifies trading of Role Product; Has offers made via Role Product Trading Session; Is traded via Trading Market.

Role Product Trading Session 141: Role Product Trading Session represents the establishment of a facility to track offers and counteroffers between a Customer and Service Provider regarding the trading of a specific Role/Product combination within a specific Trading Market.

A trading session is always between a single Customer and Service Provider.

Multiple counteroffers to a single Customer product need can be made at the same time to the same version of the Customer's product need. As a simplified example, if a Customer posts a product need with a price of $100, a Service Provider can respond immediately with two offers-one for $100 with matching product characteristics as specified by the Customer, and another for $110 with additional product features added.

Unlimited chaining of “offer/counteroffers” between Customer and Service Provider pertaining to an originating Customer Customized Logical Product need is also supported.

These features are supported through a relationship to “Product Relationship” instances with a “is counteroffer on” type of relationship (see Product Relationship for details).

Relationships: Participated in by Party Role Role Product Trading Session; Captures offers for Role Product Trading Market.

Trading Market 142: Trading Market represents a facility for matching Customer “Logical Product” needs with available Service Provider Products.

Relationships: The trading vehicle for Role Product Trading Market.

What is claimed is:

1. An electronic commerce network comprising:
a wide area network;
a plurality of business systems coupled to one another on the wide area network, each one of the business systems defining a business service or business need;
a clearinghouse coupled to the wide area network and each one of the plurality of business systems; and
the clearinghouse programmed to identify and broker a solution wherein a business service of a first one of said plurality of business systems is supplied to a business need of a second one of the plurality of business systems.

2. The system of claim 1 further comprising:
an interface programmed to record how business systems are referred to the electronic commerce network.

3. The system of claim 1 further comprising:
an interface programmed to record the history of a business system's payments for said business services and, based on said history, to determine future methods of payment available to said business system.

4. The system of claim 1 further comprising:
an interface programmed to identify the business needs of a business system, and based on said needs, configure a solution of business services to supply to said business system.

5. The system of claim 1 further comprising:
an interface programmed to record the history of the business needs of and business services provided to a second one of said plurality of business systems and, based on said history, to identify business services to market to a second one of said plurality of business systems.

6. The system of claim 1 further comprising:
an interface programmed to post the business service of a first one of said plurality of business systems and a business need of a second one of said plurality of business systems; and
wherein said clearinghouse is further programmed to facilitate the negotiation of terms of said solution between a first one of said plurality of business systems and a second one of said plurality of business systems.

7. The system of claim 1 further comprising:
an interface programmed to record performance criteria of said electronic commerce network.

8. The system of claim 1 further comprising:
an interface programmed to record disputes and facilitate resolution of disputes between a first one of said plurality of business systems and a second one of said plurality of business systems.

9. The system of claim 1 further comprising:
an interface programmed to determine and assemble components of said solution.

10. The system of claim 1 further comprising:
the interface is further programmed to coordinate delivery of said solution from a first of one said plurality of business systems to a second one of said plurality of business systems.

11. The system of claim 1:
wherein said brokering includes determining the cost of said solution and facilitating payment for said solution.

12. An electronic commerce network comprising:
a wide area network;
a plurality of business systems coupled to one another on the wide area network, each one of the business systems defining a business service or business need;
a clearinghouse coupled to the wide area network and each one of the plurality of business systems;
the clearinghouse programmed to identify and broker a solution wherein a business service of a first one of said plurality of business systems is supplied to a business need of a second one of the plurality of business systems; and
an interface programmed to register business systems on the electronic commerce network and define the role the business system plays within the electronic commerce network.

13. The system of claim 12 wherein:
the interface is further programmed to communicate with business systems that are not registered with the network.

14. The system of claim 12 wherein:
the interface is further programmed to record how business systems are referred to the electronic commerce network.

15. The system of claim 12 wherein:
the interface is further programmed to record the history of a business system's payments for said business services and, based on said history, to determine future methods of payment available to said business system.

16. The system of claim 12 wherein:
the interface is further programmed to identify the business needs of a business system, and based on said needs, configure a solution of business services to supply to said business system.

17. The system of claim 12 wherein:
the interface is further programmed to record the history of the business needs of and business services provided to a second one of said plurality of business systems and, based on said history, to identify business services to market to a second one of said plurality of business systems.

18. The system of claim 12 wherein:
the interface is further programmed to post the business service of a first one of said plurality of business systems and a business need of a second one of said plurality of business systems; and
wherein said clearinghouse is further programmed to facilitate the negotiation of terms of said solution between a first one of said plurality of business systems and a second one of said plurality of business systems.

19. The system of claim 12 wherein:
the interface is further programmed to record performance criteria of said electronic commerce network.

20. The system of claim 12 wherein:
the interface is further programmed to record disputes and facilitate resolution of disputes between a first one of said plurality of business systems and a second one of said plurality of business systems.

21. The system of claim 12 wherein:
the interface is further programmed to determine and assemble components of said solution.

22. The system of claim 12 wherein:
the interface is further is further programmed to coordinate delivery of said solution from a first one of said plurality of business systems to a second one of said plurality of business systems.

23. The system of claim 12 wherein:
said brokering includes determining the cost of said solution and facilitating payment for said solution.

24. An architecture for a clearinghouse for an electronic commerce network, wherein the architecture for the clearinghouse comprises:
a message bus and an event channel providing asynchronous messaging services; and
a connector that is a configurable information gateway that provides a single point of communication between business systems.

25. A method of conducting electronic commerce involving the exchange of goods or services amongst a plurality of network registrants, the method comprising:
accepting from at least a first one of said plurality of network registrants a request for a business good or service;
accepting from at least a second one of said plurality of network registrants an offer to supply the business good or service;
defining a solution based upon the request of first one of said plurality of network registrants and the offer of at least a second one of said plurality of network registrants; and
brokering a trade of the solution between at least a first one of said plurality of network registrants and at least a second one of said plurality of network registrants.

26. The method of claim 25 further comprising:
identifying a plurality of network registrants.

27. The method of claim 25 further comprising:
registering a plurality of network registrants.

28. The method of claim 25 further comprising:
tracking how said registrants are referred to said network.

29. The method of claim 25 further comprising:
tracking a history of payment corresponding to the trade and based on said history, determining future methods of payment available to said business system.

30. The method of claim 25 further comprising:
identifying the business needs at least a first one of said network registrants, and based on said needs, configuring a solution of business services to supply to at least a first one of said network registrants.

31. The method of claim 25 further comprising:
recording the history of the business needs of and business services provided to at least a first one of said plurality of network registrants and, based on said history, to identify business services to market to at least a first one of said plurality of network registrants.

32. The method of claim 25 further comprising:
posting the business service of at least a second one of said plurality of network participants and a business need of at least a first one of said plurality of network participants; and
facilitating the negotiation of terms of said solution between at least a first one of said plurality of network participants and at least a second one of said plurality of network participants.

33. The method of claim 25 further comprising:
recording performance criteria of said method of conducting electronic commerce involving the exchange of goods or services amongst a plurality of network registrants.

34. The method of claim 25 further comprising:
recording disputes and facilitating resolution of said disputes between at least a first one of said plurality of network participants and at least a second one of said plurality of network participants.

35. The method of claim 25 further comprising:
determining and assembling components of said solution.

36. The method of claim 25 further comprising:
coordinating delivery of said solution from at least a second one of said plurality of network participants to at least a first one of said plurality of network participants.

37. The method of claim 25 further comprising:
determining the cost of said solution and facilitating payment for said solution.

38. The method of claim 25 further comprising:
assigning at least one role to each of said plurality of network registrants;
determining tasks associated with delivery of said business good or service;
pairing said tasks with at least one of said roles;
determining, based upon said assigned role, which of said plurality of network registrants can perform tasks associated with delivery of said business good or service; and
identifying and brokering a trade of said good or service between at least a first one of the plurality of network registrants and at least a second one of the plurality of network registrants.

39. The method of claim 38 wherein brokering a trade of the business good or service between at least a first one of said plurality of network registrants and at least a second one of said plurality of network registrants comprises:
a third one of said plurality of network registrants in the role of service provider performing all tasks associated with delivery of the business good or service.

40. The method of claim 38 wherein brokering a trade of the business good or service between at least a first one of said plurality of network registrants and at least a second one of said plurality of network registrants comprises:
a third one of said plurality of network registrants in the role of service provider performing at least one task associated with delivery of the business good or service and assigning at least one said task to at least a fourth one of said network registrants; and
a fourth one of said plurality of network registrants performing at least one task associated with the delivery of the business good or service.
